(19) United States
(12) Patent Application Publication
(10) Pub. No.: US 2026/0328326 A1
(43) Pub. Date: Oct. 22, 2026

(54) Flow-Conditioning Multi-Pattern Structural Interface Adapter for Fluid System Components

(71) Applicant: Robert Eyler, JR., Mont Belvieu, TX (US)

(72) Inventor: Robert Eyler, JR., Mont Belvieu, TX (US)

(73) Assignee: Robert Lynn Eyler, JR., Baytown, TX, TX (US)

(21) Appl. No.: 19/674,476

(22) Filed: May 12, 2026

(51) Int. Cl. F16L 47/14; F16L 47/24; F16L 58/04

(52) U.S. Cl. CPC F16L 47/14; F16L 47/24; F16L 58/04

(57) ABSTRACT

A unitary interface adapter connecting thick-wall thermoplastic pressure pipe to metallic fluid system components is disclosed. The adapter comprises a single plate body having a central bore and two independent structural connection patterns. The central bore matches the internal bore diameter of the connected metallic component, eliminating sediment accumulation at the transition face. Eccentric bore alignment maintains invert continuity between connected components of differing inside diameter. The two connection patterns are angularly displaced such that substantially no bolt preload stress field of either pattern overlaps any stress field of the other pattern per ASME PCC-1, preserving structural ligament regions and independent load paths through the plate body. A multifunctional external lug serves as cathodic protection bonding conductor attachment, lifting point, and eccentric bore orientation reference. Compatible pipe materials include HDPE, PVC, PVCO, and PE4710. A fluid system assembly, matched interface kit, and upgrade method are also disclosed.

### STATEMENT REGARDING FEDERALLY SPONSORED RESEARCH OR DEVELOPMENT

Not applicable.

### FIELD OF THE INVENTION

The present invention relates to structural interface adapters for fluid transport systems. More particularly, the invention relates to a unitary, flow-conditioning adapter configured to connect thick-wall high-density polyethylene piping to metallic fluid system components while achieving bore-matched hydraulic continuity, minimizing leak paths, reducing sediment accumulation, and providing a fully restrained mechanical joint suitable for long-service fire water, industrial, and municipal piping applications. As used herein, thick-wall high-density polyethylene piping refers to HDPE pipe having a standard dimension ratio of outside diameter to minimum wall thickness of 17 or lower, designated SDR 17 or lower, including SDR 11, SDR 13.5, and SDR 9 and SDR 7 pressure classes, conforming to AWWA C906 or ASTM F714 for the applicable pressure class and pipe size, or in international applications to EN 12201 (Polyethylene piping systems for water supply and for drainage and sewerage under pressure) for the applicable SDR and pressure rating.

### BACKGROUND OF THE INVENTION

Fluid transport systems, including fire water distribution systems, industrial piping networks, and municipal water systems, frequently require interconnection of components having differing flange standards, internal diameters, materials, or connection types. Fire water distribution systems are governed by NFPA 24 (Standard for the Installation of Private Fire Service Mains and Their Appurtenances) for underground and yard piping, NFPA 13 (Standard for the Installation of Sprinkler Systems) for sprinkler system supply piping, NFPA 20 (Standard for the Installation of Stationary Pumps for Fire Protection) for pump installations, and NFPA 25 (Standard for the Inspection, Testing, and Maintenance of Water-Based Fire Protection Systems) for ongoing inspection and maintenance—each of which establishes materials, pressure ratings, joint integrity, and system reliability requirements applicable to the connections addressed by the present invention. Thick-wall high-density polyethylene piping—including pipe conforming to SDR 11, SDR 13.5, SDR 9, and SDR 7 per AWWA C906 and ASTM F714, with SDR 11 being the most common pressure class for fire water and high-pressure municipal service—has emerged as the preferred material for buried piping replacement in fire water, water distribution, and industrial service due to its corrosion resistance, long service life, and elimination of the cathodic protection requirements associated with metallic piping. However, connecting SDR 11 HDPE piping to the installed base of steel valves, pumps, instruments, and other metallic system components presents engineering challenges that existing adapter and transition products have not adequately resolved. SDR 11 HDPE pipe is manufactured to either IPS (Iron Pipe Size) or DIPS (Ductile Iron Pipe Size) outside diameter standards. IPS-dimensioned HDPE pipe has the same outside diameter as steel pipe of the same nominal size; DIPS-dimensioned HDPE pipe has the same outside diameter as ductile iron pipe of the same nominal size. In both cases, the thick wall of SDR 11 pipe results in a smaller inside diameter than nominally equivalent steel or ductile iron pipe. This dimensional mismatch, combined with the absence of any conventional large-diameter HDPE-to-steel transition product that avoids modification of existing steel piping, creates six distinct and unresolved deficiencies in conventional connection practice. A further consequence of the thick HDPE wall is that the inside diameter of a given nominal size SDR 11 HDPE pipe closely approximates the inside diameter of the next smaller nominal size steel valve or fitting—for example, 16-inch SDR 11 HDPE pipe (inside diameter approximately 14.24 inches) is closely matched to a 14-inch steel valve (bore approximately 14.00 inches), and 20-inch SDR 11 HDPE pipe (inside diameter approximately 16.36 inches) is closely matched to a 16-inch steel valve (bore approximately 16.00 inches). This dimensional relationship—in which the HDPE pipe outside diameter exceeds the outside diameter of steel pipe of the same nominal size while the HDPE inside diameter is smaller than the steel pipe inside diameter—applies across all SDR ratings of HDPE pressure pipe, with the bore differential varying in proportion to wall thickness. SDR 11 is used throughout as the primary example because it represents the most commonly specified pressure class for fire water and high-pressure municipal water service; however, the interface adapter 10 is configured for HDPE pipe of any SDR rating conforming to AWWA C906 or ASTM F714. First, conventional adapters create geometric discontinuities within the internal flow path. When the adapter bore diameter differs from the internal bore of the connected valve or component, an annular step or recess is formed at the upstream face of the valve, creating a sediment accumulation zone, a recirculation region, and a turbulent flow condition that accelerates valve wear, impairs valve actuation under emergency conditions, and promotes biological and particulate accumulation in the flow path. In fire water systems, sediment accumulation in these dead zones represents a critical reliability risk during emergency demand events. Specifying an oversized valve to avoid bore mismatch imposes unnecessary cost and may not be feasible within existing system configurations. Conventional approaches to connecting thick-wall HDPE piping to existing steel components have included stepped or multi-diameter HDPE transition fittings that present one or more abrupt bore steps within the fitting body, each step producing a recirculation zone and sediment trap, and compression-style reducers that introduce an abrupt bore contraction at the transition face; neither approach eliminates the sediment accumulation zone at the upstream valve face. Second, conventional dual-pattern and transition adapter configurations create structural deficiencies by positioning fastener openings of two patterns in close proximity or in overlapping radial alignment. When the bolt preload stress fields—the zones of significant bolt preload influence extending approximately 1.5 fastener diameters from each fastener centerline—of adjacent openings from different patterns overlap, the plate body material between those openings is subjected to competing stress concentrations, reducing structural ligament integrity and load-carrying continuity under combined service loads including bolt preload, internal pressure, piping reaction loads, and transient pressure surge. This structural deficiency is not known to be adequately addressed by conventional adapter configurations and is not captured in conventional flange design practice, which addresses stress fields within a single bolt circle but does not account for cross-pattern stress field interaction. Third, compression-based and multi-component transition assemblies introduce multiple sealing interfaces, increasing leak risk and complicating installation and long-term maintenance. Compression fittings used at HDPE-to-steel transitions do not provide a true mechanical joint—they depend on the compression of a sealing element and friction of a gripping ring or set screw against the HDPE pipe exterior to resist axial separation forces. These grip-based assemblies have demonstrated failure risk in buried service under pressure surge, soil movement, and water hammer conditions, creating safety hazards for personnel in excavation environments. The thin-wall fabricated steel bodies of conventional compression fittings are subject to both internal and external corrosion in buried service. External corrosion is commonly managed through butyl rubber wrapping, polyethylene encasement, and inclusion in the cathodic protection circuit—measures that address the exterior surface but provide no protection to interior pipe surfaces. Internal corrosion—including microbiologically influenced corrosion in fire water service—is the more serious and less manageable long-term integrity risk, as neither the cathodic protection circuit nor external wrapping reaches interior pipe walls, leaving the internal surface unprotected against MIC-driven wall loss. Thin-wall fabricated steel fittings subject to internal MIC attack may become structurally compromised within five years in aggressive service conditions—representing the structural weak link in piping systems designed for service lives of fifty years or more. In addition, compression fittings and mechanical couplings used in systems with cement mortar-lined steel pipe require external butyl rubber wrapping or polyethylene encasement for corrosion protection and significantly more engineering effort for thrust block placement to prevent movement that could separate the joints, adding installation cost and maintenance burden that is entirely eliminated when HDPE replacement piping is connected using the present invention. Fourth, conventional connection approaches fail to address the alignment requirements of retrofit applications. Mismatches between the invert elevation of the HDPE pipe and the invert of the connected steel component arise from two distinct sources: (1) the thicker wall of HDPE pressure pipe—whether SDR 11, SDR 13.5, SDR 9, or other pressure classes—relative to steel pipe of the same nominal size, which causes the HDPE to steel bore differences with common centerlines to introduce a significant step at the interface, causing flow disturbances and possible sediment traps at the downstream face of the connection. No conventional adapter provides an eccentric bore configuration specifically designed to maintain invert continuity through the transition. Additionally, no conventional adapter provides a multifunctional external attachment feature that simultaneously serves as a cathodic protection bonding conductor attachment point, a lifting lug for installation handling, and a rotational orientation reference for setting the eccentric bore in the correct position during field installation. Fifth, grooved mechanical coupling connections to existing steel pipe and fittings require the field-cutting or cold-forming of a circumferential groove into the end of the existing metallic pipe. Cut grooving—the only method applicable to cement-mortar-lined steel pipe, since roll grooving crushes and detaches the lining—removes 0.100 to 0.177 inches of wall material from the pipe end on standard wall piping, consuming the corrosion service allowance of the existing pipe, reducing the pressure rating at the groove section and a higher probability of corrosion failure, and cutting through the protective coating system—cement mortar lining, fusion-bonded epoxy, zinc coating, or polyethylene encasement—that provides the long-term corrosion resistance of the original installation. The exposed bare steel at the groove bottom becomes a corrosion initiation point requiring field-applied corrosion protection with service life limited compared to the factory-applied system. No conventional grooved coupling adapter addresses HDPE-to-steel transitions at large diameters—the leading mechanical grooved coupling product for HDPE-to-steel transitions is limited to 14-inch IPS nominal pipe size—leaving large-diameter transmission main applications without a grooved mechanical solution. The present invention requires no modification, grooving, or coating removal from any existing steel component: the flanged plate body adapter connects directly to the existing flange face of the installed steel valve or fitting, preserving full pipe wall thickness, intact protective coatings, original pressure rating, and uninterrupted corrosion protection at every connection point. This characteristic is particularly significant for large-diameter transmission main rehabilitation—where the majority of buried steel water pipe in service in North America is cement-mortar-lined—and for installations where the authority having jurisdiction requires that no modification be made to existing pressure-rated steel components. Sixth, conventional connection practice does not address the operational hazard that arises during maintenance isolation and return-to-service operations in fire water distribution systems with deteriorated steel pipe. When a header section is depressurized for repair and subsequently refilled, residual air trapped in the pipe crown cannot be fully evacuated through conventional hydrant venting. When the isolation valve is opened to restore service, flow demand exceeds jockey pump capacity, header pressure drops below the main fire pump start threshold, and the main pumps come online at full rated output. Full pump pressure is then applied instantaneously to the advancing water slug, which decelerates when it reaches the compressed air column—producing a water hammer pressure spike and associated thrust loads. In deteriorated steel pipe where MIC has reduced wall thickness at discrete pit locations, this pressure spike initiates failure at the compromised wall section during the very operation intended to restore system integrity. This startup pressure event and deteriorated pipe failure interaction is a system-level operational risk in aging fire water infrastructure that is not addressed by any conventional connection hardware or pipe transition fitting. The interface adapter of the present invention, when configured as a flush branch assembly at the terminal end of a header section with a full line size post indicator valve and a concave crown eccentric bore adapter, addresses this sixth deficiency by enabling controlled refilling at fill rates within jockey pump capacity—preventing automatic main pump start—while actively evacuating residual crown air through the flush branch before and during the fill operation. The interface adapter of the present invention is a planned permanent retrofit component requiring scheduled installation including pipe cutting and welded flange preparation, appropriate for locations where the tie-in point can be selected, the pipe wall inspected at the cut face, and the connection designed as a permanent structural element of the system. Installation of the interface adapter occurs in two distinct scenarios that differ in whether field welding is required. In planned phased replacement—where a deteriorated steel piping segment is identified in advance, excavated, and removed as part of a coordinated rehabilitation program —the connection is made to an existing flanged valve or flanged fitting at the boundary of the replacement segment, eliminating field welding entirely. This is the preferred approach: the excavation is driven by the failing pipe being replaced, and a well-planned effort removes the suspect piping rather than leaving it in service. The adapter bolts directly to the existing flange face of the in-service valve or fitting at each end of the replaced segment. This connection provides a service life exceeding fifty years, with bore-matched continuity maintaining system flow capacity and eliminating sediment accumulation at the transition faces for the life of the installation. In maintenance and emergency repair scenarios—where a failed or failing section must be cut out and replaced—slip-on or weld-neck flanges are field-welded to the existing pipe ends at each side of the excavation, and the interface adapter plate body is bolted to those flanges, with a section of HDPE pipe completing the replacement span. In both scenarios, the bolted flange connection provides positive mechanical thrust restraint—the bolt preload resists axial separation forces regardless of adjacent excavation geometry, space constraints, or supplemental restraint hardware availability. Certain prior art adapters have addressed portions of these deficiencies individually without providing the complete combination of the present invention. Curtis (U.S. Pat. No. 5,437,482) discloses an adapter plate having two concentric bolt circle patterns at different radii. However, Curtis does not disclose, teach, or suggest a stress field non-overlap criterion between the two patterns, a minimum center-to-center distance of three times the nominal fastener diameter, a bore profile configured to match the internal bore diameter of a connected valve, application to thick-wall HDPE piping, or a multifunctional lug serving as a cathodic protection bonding conductor attachment point, lifting attachment, and installation orientation reference. International Publication WO 2006/002239 discloses a tapered bore adapter for flow meter applications intended to condition flow entering a measurement device. However, WO 2006/002239 employs a single bolt pattern, does not address the structural ligament optimization problem arising from dual-pattern adapters, does not address thick-wall HDPE piping, and does not provide bore matching to the internal diameter of connected valves for sediment elimination. WO 2006/002239 is directed specifically to small-bore instrument connections for flow measurement—its tapered bore geometry is designed to condition velocity profiles for measurement accuracy, not to eliminate sediment accumulation at a water distribution valve face, and its connections are metallic-to-metallic threaded or bolted flanged joints that present none of the viscoelastic bolt relaxation, bore differential, or eccentric invert alignment challenges addressed by the present invention. The combination of Curtis and WO 2006/002239 does not teach or suggest the present invention because neither reference, alone or in combination, discloses the quantified stress field non-overlap criterion applied to a dual-pattern adapter simultaneously providing a valve bore matched flow-conditioning bore within a single unitary plate body configured for thick-wall HDPE piping, with an integrated multifunctional lug. Bain et al. (U.S. Pat. No. 9,470,348) discloses a circular plate with bolt holes on one surface and elongated slots on the other surface for connecting piping appurtenances, with the slots providing rotational alignment adjustment rather than constituting an independent structural connection pattern. Bain has a through-bore, but the through-bore of Bain is not configured to match the internal bore diameter of the connected downstream valve or fluid system component and does not provide the bore-matched flow-conditioning geometry of the present invention. The bore-matched central bore of the present invention—sized to the internal bore of the connected valve to eliminate the sediment accumulation zone at the upstream valve face—is neither disclosed nor suggested by Bain. Bain does not disclose a cross-pattern stress field non-overlap criterion, application to HDPE piping, an eccentric bore, or a multifunctional lug. Stenner et al. (U.S. Patent Application Publication No. 2004/0037641) discloses stress relief holes positioned between bolt holes in a single bolt circle to reduce stress concentration at adjacent bolt holes within one connection pattern. The present invention's non-overlap criterion governs cross-pattern stress field interaction between two independent connection patterns—a structurally distinct problem from the single-pattern stress concentration that Stenner addresses. Stenner does not disclose two independent connection patterns, a bore matched to the connected component internal diameter, application to HDPE piping, an eccentric bore, or a multifunctional lug. The combination of Curtis and Bain (U.S. Pat. No. 9,470,348) does not teach or suggest the present invention for independent reasons. Curtis provides two concentric bolt circles but no bore-matched central bore and no stress field non-overlap criterion. Bain provides a plate with bolt holes and elongated slots but the slots are rotational alignment features—not an independent structural connection pattern—and the through-bore of Bain is not configured as a bore-matched flow-conditioning bore of any kind. Combining the bolt circle geometry of Curtis with the slot geometry of Bain does not produce a plate body having two independent structural connection patterns with cross-pattern stress field non-overlap and a bore-matched central bore sized to the internal diameter of a connected valve. The absence of any bore-matched flow-conditioning bore in Bain means that the bore-matched central bore—which eliminates the sediment accumulation zone at the upstream valve face and is the second inseparable inventive concept of the present invention—cannot be derived from Curtis combined with Bain. Neither reference alone nor in combination provides motivation or teaching to arrive at both inventive concepts simultaneously within a single unitary plate body configured for thick-wall HDPE piping. Small-bore instrument adapter flanges are known in process piping and instrumentation applications for connecting instrument connections, pressure taps, and small-bore process connections of differing flange standards using a unitary adapter plate. Such devices do not teach a structural large-bore flange transition body having independent structural load paths between two dissimilar-material connection patterns, a bore matched to the internal diameter of a connected valve to eliminate a sediment accumulation zone, or a hydraulically conditioned bore for dissimilar piping systems. The structural and hydraulic requirements of large-bore thermoplastic-to-metallic piping transitions—including the viscoelastic bolt load relaxation problem, the bore differential between thick-wall thermoplastic pipe and metallic valve bores, the eccentric invert alignment requirement, and the cathodic protection bonding function—are not present in and are not suggested by small-bore instrument adapter flange practice. Double-studded adapter flanges (DSA/DSAF) are known in the oilfield and wellhead equipment industry for connecting flanges of different nominal sizes, pressure ratings, and configurations using a unitary body having two independent flange interfaces and a through-bore. DSAFs are manufactured to API 16A for wellhead and drilling equipment service, available in pressure classes from 2,000 PSI to 15,000 PSI, and connect metallic wellhead components of different nominal bore and pressure class within drill string equipment stacks—for example, connecting an 11-inch 15M component to an 18¾-inch 15M component. This prior art is acknowledged. DSAFs do not, however, disclose, teach, or suggest the present invention for the following four independent reasons, any one of which is independently sufficient to distinguish the present invention from DSAF and from any combination of DSAF with the other references cited herein. (i) Cross-pattern ligament preservation based on stress-field separation. DSAF bolt patterns are rigid metallic-to-metallic connections in which both faces typically employ the same bolt circle standard—for example, both faces conforming to API 16A two-hole patterns—with the bolt preload stress fields from both patterns overlapping throughout the plate body. DSAF does not employ, require, or suggest a stress field non-overlap criterion between the two patterns, nor does the rigid all-metallic DSAF construction provide any mechanism by which the angular positions of the two bolt patterns could be independently optimized. The bolt patterns specifically use a “two Hole” industry bolt orientation to match equipment for which the adapter is design for in high pressure oil field equipment. The stress field non-overlap criterion of the present invention is enabled by the lap joint flange arrangement on the HDPE side: the lap joint backing ring floats and rotates freely around the pipe outside diameter independently of the plate body, allowing the HDPE-side bolt pattern to be angularly offset from the steel-side blind tapped holes to achieve non-overlapping stress fields between the two patterns. This enabling mechanism does not exist in DSAF and is structurally incompatible with DSAF construction. DSAF connects metallic wellhead components through weld neck flanges joined by full-penetration butt welds on both sides—connections that are permanently fixed in angular position at the time of fabrication and cannot be rotated or adjusted after welding. Both DSAF faces use the two-hole standard orientation set at weld-up, locked by the weld into a fixed angular relationship that cannot be changed in the field or at installation. Because both DSAF connection faces are rigidly fixed by welding, there is no rotational degree of freedom on either side that could be used to angularly offset one pattern relative to the other to achieve stress field non-overlap. The lap joint backing ring of the present invention—which provides the rotational independence that makes the non-overlap criterion achievable—is inherently incompatible with the high-pressure butt-welded weld neck flange construction of DSAF, which is designed for pressure classes up to 15,000 PSI where the structural integrity of the welded joint is itself a primary safety requirement and no rotatable or floating connection element is permissible. The angular offset that satisfies the stress field non-overlap criterion is therefore not merely absent from DSAF—it is a geometric impossibility in any rigid all-metallic body where both faces are permanently fixed in angular alignment by welding. The stress field non-overlap criterion of the present invention is further required by the dissimilar material connection: HDPE and other thermoplastic pressure pipe transmit bolt load through a viscoelastic polymer subject to sustained preload relaxation under long-term compressive stress, while steel transmits bolt load elastically without relaxation, requiring independent structural load paths to prevent thermoplastic-side bolt relaxation from reducing metallic-component-side bolt preload and compromising sealing integrity over the service life of the installation. This dissimilar material structural problem does not exist in a DSAF connecting two metallic wellhead components of equivalent elastic modulus, providing no motivation in DSAF practice to seek independent load paths between the two connection patterns. (ii) Bore matched to connected valve ID to eliminate sediment accumulation zones. DSAF does not include a bore profile configured to match the internal bore diameter of the connected downstream component in order to eliminate a sediment accumulation zone at the upstream face of that component. The DSAF through-bore provides full bore passage for drill string operations—its hydraulic function is drill string passage and well control, not velocity profile conditioning or sediment zone elimination at a water distribution valve face. Bore matching to eliminate sediment accumulation at a water valve face is irrelevant in wellhead service, where connected components are pressure vessels for well control rather than long-service water distribution valves subject to particulate settling over decades of operation. (iii) Thick-wall thermoplastic retrofit geometry. DSAF has no application to thick-wall thermoplastic pressure pipe of any kind. DSAF does not address the dimensional relationships between thick-wall SDR-rated thermoplastic pipe and metallic fluid system components, the bore differential that arises from thermoplastic wall thickness, the material property differences between viscoelastic thermoplastic and elastic steel at bolted flange connections, the cathodic protection bridging requirement across non-conducting thermoplastic pipe segments, or the retrofit context of connecting replacement thermoplastic piping to existing installed metallic valves and appurtenances at their original locations without modification. (iv) Combined structural-hydraulic transition body for dissimilar piping systems. DSAF is not and does not function as a combined structural-hydraulic transition body for dissimilar piping systems. The present invention simultaneously addresses the structural load path separation problem arising from the viscoelastic-to-elastic material transition (by the stress field non-overlap criterion) and the hydraulic bore discontinuity problem arising from the nominal size and wall thickness differential between thermoplastic pipe and metallic valve bore (by the bore-matched central bore). These two inventive concepts are inseparable within the unitary plate body of the present invention and arise from the same dissimilar material geometry that DSAF does not address in any respect. No combination of DSAF with Curtis (U.S. Pat. No. 5,437,482), Bain (U.S. Pat. No. 9,470,348), Stenner (U.S. 2004/0037641), or WO 2006/002239 produces a unitary plate body simultaneously providing cross-pattern stress field non-overlap, a bore matched to the connected valve internal diameter, thick-wall thermoplastic retrofit geometry, and a multifunctional lug for cathodic protection bonding, lifting, and eccentric bore orientation reference. The four distinctions identified above are each independently present in the present invention and independently absent from DSAF and from every combination of the cited references. Thermoplastic mechanical joint outlet adapters—fittings in which a mechanical joint bell socket or mechanical joint follower gland geometry is integrally formed in or fused to a thermoplastic outlet body that is heat-fused directly to the end of a thermoplastic pressure pipe—are available from several manufacturers for connecting HDPE and PVC pressure pipe to ductile iron mechanical joint fittings, valves, and appurtenances. These fittings eliminate the need for a separate stub end, lap joint backing ring, and bolted plate adapter at mechanical joint connections, and provide a fused direct connection from the thermoplastic pipe body to the mechanical joint interface. Thermoplastic MJ outlet adapters do not disclose, teach, or suggest the present invention for two independent reasons. First, they are single-component fused fittings with no plate body, no dual independent bolt patterns, and no structural ligament geometry—the stress field non-overlap criterion and all structural innovations of the present invention are absent. Second, the internal bore is determined by the thermoplastic pipe inside diameter and the MJ fitting bore without any bore transition geometry to match the connected component internal diameter or eliminate the sediment accumulation ledge at the MJ fitting face. For a 20-inch SDR 11 HDPE main connecting to a 16-inch MJ valve, the 1.67-inch bore differential produces a sediment accumulation ledge that the MJ outlet adapter does not address. The present invention provides bore-matching, eccentric invert alignment, flow conditioning, and the multifunctional lug within the unitary plate body—none of which is present in or suggested by thermoplastic MJ outlet adapters. Existing HDPE transition hardware—including flanged stub end assemblies, mechanical joint outlet adapters, compression-style reducing couplings, and grooved transition couplings—provides mechanical connection between thermoplastic piping and metallic piping systems but does not preserve internal flow continuity across dissimilar wall systems. Each of these existing connection methods accepts the bore discontinuity at the transition face as an inherent consequence of connecting thermoplastic pipe to metallic components, relying on the downstream valve or fitting to function despite the sediment accumulation zone, bore step, recirculation region, and invert ledge that the connection creates at the metallic component face. None provides the combination of bore-matched central bore, eccentric invert alignment, stress field non-overlapping dual connection patterns, and fully restrained single-body mechanical joint that the present invention delivers simultaneously in a single unitary plate body. Accordingly, there exists a need for a unitary, single-body adapter that eliminates flow discontinuities at the transition face through valve bore matching and eccentric invert alignment, preserves structural ligament integrity through optimized fastener pattern positioning with non-overlapping stress fields, minimizes leak paths through single-body construction with only two gasketed faces, and provides a fully restrained mechanical joint that eliminates compression fitting failure modes, thrust block requirements, and external corrosion protection wrapping—while maintaining original system component sizes without requiring replacement of existing valves, pumps, instruments, or other metallic system components. The combination of bore-matched central bore, eccentric invert alignment, stress field non-overlapping dual connection patterns, and unitary plate body construction provides a complete solution to the six deficiencies identified above in a single manufactured component suitable for large-diameter underground water system installations—evaluated over extended service periods, including post-installation inspection following multi-year buried service—confirming that the six deficiencies identified above are simultaneously addressed by the present invention in actual field service.

### SUMMARY OF THE INVENTION

The present invention provides a unitary interface adapter—a single-piece flanged plate body—configured to connect thick-wall high-density polyethylene piping to existing metallic fluid system components while maintaining the original internal pipe size at those components, minimizing potential leak paths, and reducing sediment accumulation at the transition interface. The following aspects describe the invention. In one aspect, the adapter comprises a unitary plate body having a central bore extending through the plate body and a first and second connection pattern each formed in the plate body. The connection patterns are positioned such that substantially no bolt preload stress field, defined as a circular zone of approximately 1.5 to 2 times the nominal fastener diameter centered on each fastener opening, associated with any opening of the first connection pattern overlaps any bolt preload stress field associated with any opening of the second connection pattern. This substantially non-overlapping criterion preserves structural ligament regions of continuous plate body material capable of transmitting independent structural loads between the two connection patterns, ensuring the adapter is not the structural weak link in the assembled piping system. In another aspect, the central bore is configured with a profile selected to condition fluid flow through the transition. The bore profile may be a straight cylindrical bore sized to match the internal bore diameter of the connected metallic component—the valve bore matched configuration—eliminating the sediment accumulation zone formed at the upstream valve face when adapter bore diameter exceeds valve bore diameter. The bore profile may alternatively include a tapered section, a radiused inlet, an eccentric alignment, or a computationally optimized contour, selected based on the flow velocity, fluid type, downstream component geometry, and sediment or cavitation risk of the specific installation. In another aspect, the bore may be configured as an eccentric bore in which the centerline of the bore is offset from the centerline of the plate body to maintain invert continuity between the connected high-density polyethylene pipe and the connected metallic component. This configuration eliminates the internal ledge that would otherwise form at a concentric bore transition between components of differing inside diameter, preventing sediment accumulation at the transition face and facilitating drainage and cleaning of the piping system. In another aspect, the adapter integrates a multifunctional external lug positioned on the plate body and configured to serve simultaneously as a cathodic protection bonding conductor attachment point for maintaining the cathodic protection grid across HDPE-to-steel transitions, a lifting attachment for handling and installation, and a rotational orientation reference for positioning the eccentric bore in the correct angular orientation during field installation. No prior art adapter known to the inventors integrates all three of these functions in a single external feature. In another aspect, the adapter includes one or more structural attachment lugs 98—the number not being limited to two and selectable based on installation load requirements—positioned on the outer diameter of the plate body at designated lateral positions, configured to provide load transfer surfaces for thrust restraint, thermal installation load management, valve maintenance, and supplemental axial restraint hardware where required by installation geometry. The structural attachment lugs 98 are distinct in function from the multifunctional external lug 60 and serve mechanical load transfer functions including tie-rod, all-thread rod, clamp, anchor bolt, and bracket attachment under full design loads in both permanent restraint and temporary installation load management applications of the flanged connection. In another aspect, the adapter is configured for installation between existing metallic system components—including gate valves, butterfly valves, post indicator valves, check valves, detector check assemblies, pressure gauges, flow meters, pumps, compressors, and other process equipment components—without requiring replacement, upsizing, or repositioning of those components. The adapter accommodates the dimensional difference between thick-wall HDPE pressure piping (SDR 17 or lower, including SDR 13.5 and SDR 11) and standard steel pipe connections within the adapter plate body, allowing complete system conversion from steel to HDPE piping on a segment-by-segment basis while retaining all installed metallic components at their original locations, sizes, and flange configurations. In another aspect, the single unitary plate body construction of the adapter minimizes potential leak paths by consolidating the complete transition function within a single body with only one gasketed face on each side, eliminating the multiple interfaces and potential leak points of multi-component compression-style or spool-type transition assemblies. These and other aspects of the invention will become apparent from the following detailed description and the accompanying drawings.

### BRIEF DESCRIPTION OF THE DRAWINGS

In the drawings, solid lines depict the claimed adapter assembly and associated fasteners forming part of the invention. Phantom lines indicate environmental structure, including valve bodies and existing piping infrastructure, that provides installation context but does not form part of the claimed invention. Dashed lines indicate hidden features of the claimed adapter. The label PRIOR ART designates prior art connections shown for comparison purposes. A dividing notation at the adapter flange face denotes the boundary between the claimed assembly and existing infrastructure. Crosshatching is applied to all sectioned components regardless of line type. Text labels are used in place of reference numbers on all phantom and prior art elements.

FIG. 1(a) is a perspective isometric view of the interface adapter assembly installed to a valve.

FIG. 1(b) is an exploded isometric view of the interface adapter 10 showing all adapter components in the disassembled position, including the HDPE-side connection 40, plate body 12, fastener set 46, and offset ring gasket 88 as the assembly bolts to an existing valve 42.

FIG. 1(c) is a plan view of the interface adapter 10 showing the plate body 12, central bore 14, first connection pattern 18, second connection pattern 16, fastener openings 20, cathodic protection lug 60, and structural attachment lugs 98.

FIG. 2(a) is a master reference isometric view of the interface adapter 10 with complete reference number callouts for all primary features.

FIG. 2(b) is an annotated plan view showing the angular separation of bolt preload stress fields between the first connection pattern 18 and second connection pattern 16 bolt circles 22, structural ligament region 24, minimum material width 25, and angular offset 26 demonstrating the non-overlapping stress field distribution, with the stress field radius.

FIG. 2(c) is a plan view showing the stress field radius geometry 29, the independent load path region 28, and the minimum center-to-center distance requirement between the two connection patterns with annotation referencing ASME PCC-1 Guidelines for Pressure Boundary Bolted flange joint assembly.

FIG. 3 is a schematic longitudinal cross-section showing the opposing bolt load systems and Rotscher pressure cones 29a and 29b propagating through the plate body 12 thickness from the first connection pattern 18 and second connection pattern 16 respectively, confirming non-intersection within the structural ligament region 24 per ASME PCC-1 Section 4, with the minimum breakout prevention dimension and fastener set 46 identified.

FIG. 4(a) is an isometric view of the HDPE mounting side of the eccentric bore adapter 10 showing the cathodic protection lug 60 and structural attachment lugs 98.

FIG. 4(b) is a plan view of the steel-side connection face of the eccentric bore adapter showing the eccentric bore offset 36.

FIG. 4(c) is a plan view of the HDPE-side face of the eccentric bore adapter showing the bore opening, boundary groove 84, first connection pattern geometry 18, and 125 RMS phonographic spiral finish.

FIG. 4(d) is an isometric view of the steel mounting side of the eccentric bore adapter showing the blind tapped holes of the second connection pattern 16, second locating groove 86, and 125 RMS phonographic spiral finish.

FIG. 4(e) is a detail view of the gasket face alignment grooves showing the boundary groove 84 and second locating groove 86.

FIG. 4(f) is a cross-section of the eccentric bore adapter showing the eccentric bore offset 36, bore profile, plate body 12 thickness, and gasket grooves 84 and 86 in section.

FIG. 5(a) is a cross-section showing the straight bore flanged adapter 126 connected to a valve 42 and flanged steel pipe 125, illustrating bore matching at the adapter-to-valve interface with the radiused bore transition 30 and HDPE-side connection 40.

FIG. 5(b) is a cross-section showing the concave bore flanged adapter 127 connected to a valve 42 and flanged steel pipe 125 illustrating bore flow transition and the concave bore profile.

FIG. 5(c) is a cross-section showing the eccentric bore adapter 37 with eccentric bore alignment 36 connected to a valve 42 and flanged steel pipe 125 illustrating bottom-of-pipe invert matching 129 with a continuous invert reference line.

FIG. 5(d) is a cross-section showing the prior art configuration of line-size thick-wall pipe connected to a valve 42 and slip fit connection 47, with the sediment accumulation zone 123 shown at the thick-wall pipe to existing valve connection.

FIG. 5(e) is a cross-section showing the prior art configuration of line-size thick-wall pipe 40 connected to a valve 42 and line-size thick-wall pipe 40, illustrating the sediment accumulation zone 123, legacy bore step 122, and recirculation zone 124 at the valve-to-pipe interface.

FIG. 6(a) through 6(d) illustrate the straight bore configuration 126—plan view, steel side isometric view, HDPE side isometric view, and bore profile cross-section.

FIG. 6(e) through 6(h) illustrate the tapered bore configuration with tapered bore section 32—plan view, steel side isometric view, HDPE side isometric view, and bore profile cross-section.

FIG. 6(i) through 6(l) illustrate the concave bore configuration 127—plan view, steel side isometric view, HDPE side isometric view, and bore profile cross-section.

FIG. 7(a) through 7(d) illustrate the convex bore configuration 128—plan view, steel side isometric view, HDPE side isometric view, and bore profile cross-section.

FIG. 7(e) through 7(h) illustrate the eccentric bore flanged adapter 37 with eccentric bore alignment 36—plan view, steel side isometric view, HDPE side isometric view, and bore profile cross-section.

FIG. 7(i) through 7(l) illustrate the eccentric bore mechanical joint adapter 130 with eccentric bore alignment 36—plan view, steel side isometric view, HDPE side isometric view, and bore profile cross-section.

FIG. 8(a) through 8(d) illustrate the eccentric bore slip joint adapter 131—plan view, steel side isometric view, HDPE side isometric view, and bore profile cross-section.

FIG. 8(e) through 8(h) illustrate the eccentric bore hydrant adapter 132—plan view, steel side isometric view, HDPE side isometric view, and bore profile cross-section.

FIG. 8(i) through 8(l) illustrate the eccentric bore grooved joint adapter 130—plan view, steel side isometric view, HDPE side isometric view, and bore profile cross-section.

FIG. 9(a) is an isometric view of the eccentric bore adapter 37 on the steel mounting side.

FIG. 9(b) is an isometric view of the eccentric bore adapter 37 on the HDPE mounting side.

FIG. 9(c) is a cross-section showing the bore breakthrough prevention geometry at the minimum wall section, with bolt holes projected into the section plane for clarity, showing the bore breakthrough position where a bolt hole would intersect the bore wall at the invert without angular displacement, with the minimum wall dimension of 0.5 inches and the eccentric offset 36 identified.

FIG. 10(a) through 10(d) show a prior art dual bolt pattern adapter 140. FIG. 10(a) is an isometric view. FIG. 10(b) is a plan view showing the two-hole bolt alignment pattern on one side. FIG. 10(c) is an opposite-side plan view showing the two-hole alignment pattern on the opposite side. FIG. 10(d) is a cross-section. All views are labeled PRIOR ART.

FIG. 11(a) through 11(c) show a prior art HDPE stub end to mechanical joint valve adapter 110. FIG. 11(a) is an isometric view. FIG. 11(b) is a cross-section showing the prior art adapter 110 with flange clamp 141, existing valve 42, and sediment accumulation zone 123 at the bore mismatch. FIG. 11(c) is an exploded view. All views are labeled PRIOR ART.

FIG. 12(a) through 12(c) show SDR 11 HDPE pipe connected through the straight bore flanged adapter 126 to existing valve 42 and downstream pipe 47 shown in phantom lines, in isometric, cross-section, and exploded views. The HDPE-side connection 40 and fastener set 46 are identified.

FIG. 13(a) through 13(c) show SDR 11 HDPE pipe connected through the concave bore flanged adapter 127 to existing valve 42 and downstream pipe 125 shown in phantom lines, in isometric, cross-section, and exploded views. The HDPE-side connection 40 and fastener set 46 are identified.

FIG. 14(a) through 14(c) show SDR 11 HDPE pipe connected through the eccentric bore flanged adapter 37 with eccentric bore alignment 36 and offset ring gasket 88 to existing valve 42 and downstream pipe 125 shown in phantom lines, in isometric, cross-section, and exploded views. The HDPE-side connection 40 and fastener set 46 are identified.

FIG. 15(a) through 15(c) show SDR 11 HDPE pipe connected through the mechanical joint adapter 130 to existing valve 42 and downstream cement mortar-lined ductile iron pipe 47 shown in phantom lines, in isometric, cross-section, and exploded views. The HDPE-side connection 40, fastener set 46, and flange clamp 141 on the existing pipe are identified.

FIG. 16(a) through 16(c) show SDR 11 HDPE pipe connected through the mechanical joint adapter 130 with offset ring gasket 88 to existing valve 42 and downstream HDPE pipe 38 shown in phantom lines, in isometric, cross-section, and exploded views, showing legacy bore step 122 and sediment accumulation zone 123 on the prior art side. The HDPE-side connection 40, fastener set 46, MJ stub end adapter 110 and flange clamp 141 on the existing pipe are identified.

FIG. 17(a) through 17(c) show SDR 11 HDPE pipe connected through the mechanical joint adapter 130 to an existing mechanical joint valve 42 with existing downstream HDPE pipe 38 shown in phantom lines, in isometric, cross-section, and exploded views, showing legacy bore step 122 and sediment accumulation zone 123 on the prior art side. The HDPE-side connection 40, fastener set 46, MJ stub end 110 and flange clamp 141 on the existing pipe are identified.

FIG. 18(a) through 18(c) show SDR 11 HDPE pipe connected through the eccentric bore flanged adapter 37 with eccentric bore alignment 36 and offset ring gasket 88 to existing valve 42 and downstream compression flange adapter 134 and cement mortar-lined ductile iron pipe 47 shown in phantom lines, in isometric, cross-section, and exploded views, with legacy bore step 122 shown on the prior art side. The HDPE-side connection 40 and fastener set 46 are identified.

FIG. 19(a) through 19(c) show a prior art compression fitting to flanged adapter 134 to existing valve 42 to slip fit cement mortar-lined ductile iron pipe 47 assembly with legacy bore step 122 and sediment accumulation zone 123 identified. All views are labeled PRIOR ART.

FIG. 20(a) through 20(c) show SDR 11 HDPE pipe connected through the straight bore flanged adapter 126 to an existing flanged valve 42 to existing slip fit cement mortar-lined ductile iron pipe 47, in isometric, cross-section, and exploded views. The existing valve and downstream pipe are shown in phantom lines. The HDPE-side connection 40 and fastener set 46 are identified.

FIG. 21(a) through 21(c) show prior art line-size SDR 11 HDPE flanged pipe 40 with fastener set 46 to an existing valve 42 to slip fit cement mortar-lined ductile iron pipe 47 shown in phantom lines, showing legacy bore step 122 and sediment accumulation zone 123, in isometric, cross-section, and exploded views. All views are labeled PRIOR ART.

FIG. 22(a) through 22(c) show SDR 11 HDPE pipe connected through the straight bore flanged adapter 126 to an existing flanged-by-grooved valve 42 connected through grooved adapter 133 and grooved pipe coupler 143 to existing grooved steel pipe 150, in isometric, cross-section, and exploded views. The HDPE-side connection 40 and fastener set 46 are identified on both sides of the valve. The grooved pipe coupler 143 is also shown.

FIG. 23(a) through 23(c) show SDR 11 HDPE pipe connected through the straight bore flanged adapter 126 to an existing flanged ball valve 42 to the convex bore flanged adapter 128 to SDR 11 HDPE pipe, in isometric, cross-section, and exploded views. The HDPE-side connections 40 and fastener sets 46 are identified.

FIG. 24(a) through 24(c) show SDR 11 HDPE pipe connected through the hydrant adapter 132 with eccentric bore alignment 36 to an existing fire hydrant 42, in isometric, cross-section, and exploded views. The fire hydrant body is shown in phantom lines. The HDPE-side connection 40 and fastener set 46 are identified.

FIG. 25(a) through 25(c) show a multi-adapter above-grade riser installation with SDR 11 HDPE pipe connected through eccentric bore flanged adapters 37 with eccentric bore alignment 36 at buried horizontal connections and a concave bore adapter 127 at the riser branch, in isometric, cross-section, and exploded views. The HDPE-side connections 40 and fastener sets 46 are identified.

FIG. 26(a) through 26(c) show line-size SDR 11 HDPE pipe connected to an existing line-size flanged valve 42 to line-size SDR 11 HDPE pipe 40, showing legacy bore step 122 and sediment accumulation zone 123, in isometric, cross-section, and exploded views. The HDPE-side connections 40 and fastener sets 46 are identified. All views are labeled PRIOR ART.

FIG. 27(a) through 27(c) show SDR 11 HDPE pipe connected through the straight bore flanged adapter 126 to an existing flanged valve 42 to existing steel pipe 47 to a compression fitting connection 144 to existing steel pipe 47, in isometric, cross-section, and exploded views. The HDPE-side connection 40 and fastener set 46 are identified.

FIG. 28 is a full system isometric view of the complete fire water retrofit installation showing the interface adapter 10 at each connection point in the underground fire water piping system, with cathodic protection lugs 60 at the crown of each adapter, the underground HDPE fire water pipeline 90, and existing steel piping 125 transitioning to HDPE underground. Also identified are the continuation of the existing non replaced piping headers 125 and 47, 125 and 150.

FIG. 29 is a plan view of the complete fire water retrofit installation showing the system layout including new SDR 11 HDPE pipe 90, existing steel pipe 125, main header size branch grooved steel pipe 150 transition, main header size slip connection cement mortar-lined ductile iron pipe 47, HDPE to existing fire hydrant branch, HDPE to riser branch, and HDPE to existing steel line size branch connections, with section cut lines A-A through F-F identifying the locations of the detail cross-sections of FIGS. 30 through 32.

FIG. 30(a) is a cross-section through the main fire water header centerline at section A-A shown in FIG. 29, showing bottom of pipe reference line 129, grade plane 148, cathodic grid connections 149, and straight bore adapters 126 at the existing PIV flange connections transitioning from steel pipe to the HDPE retrofit system and back to existing cement mortar-lined ductile iron pipe. Existing piping 125 and 47 are identified as is the new HDPE piping 90.

FIG. 30(b) is a cross-section through the main fire water header centerline in the opposite direction at section B-B shown in FIG. 29, showing bottom of pipe reference line 129, grade plane 148, cathodic grid connections 149, and the adapters from section A-A.

FIG. 31(a) is a cross-section through the hydrant branch connection at section C-C shown in FIG. 29, showing bottom of pipe reference line 129, grade plane 148, and eccentric fire hydrant adapter 132 at the existing hydrant connection. HDPE piping 90 and the existing hydrant are also shown.

FIG. 31(b) is a cross-section through the smaller bore branch connection at section D-D shown in FIG. 29, showing the bottom of pipe reference line 129, grade plane 148, and straight bore adapter at the existing PIV flange transitioning back to the existing steel line size at the valve.

FIG. 32(a) is a cross-section through the line-size branch connection at section E-E shown in FIG. 29, showing the bottom of pipe reference line 129, grade plane 148, and straight bore adapter 126 at the existing PIV flange transitioning back to the existing grooved steel piping system.

FIG. 32(b) is a cross-section through the riser branch connection at section F-F, showing the bottom of pipe reference line 129, grade plane 148, eccentric bore adapters 37 transitioning from thick-wall HDPE to a line-size flanged valve and back to thick-wall HDPE, and concave bore adapter 127 transitioning back to existing above-ground steel pipe.

### DETAILED DESCRIPTION OF THE INVENTION

### I. Reference Numerals

The following reference numerals are used throughout the drawings and this specification:
10—interface adapter—complete assembly
12—plate body
14—central bore
18—first fastener pattern—HDPE-side through-tapped holes
16—second fastener pattern—steel-side blind tapped holes
20—fastener opening
22—bolt circle
24—structural ligament region
25—minimum material width
26—angular offset between connection patterns
28—independent load path region
29—bolt preload stress field
29a—first connection pattern pressure cone—Rotscher model
29b—second connection pattern pressure cone—Rotscher model
30—radiused bore transition—at HDPE face bore entry
32—tapered bore section
36—eccentric bore alignment
37—eccentric bore adapter
126—straight bore adapter
127—concave bore adapter
128—convex bore adapter
129—bottom of pipe alignment reference line
130—mechanical joint adapter—MJ bell on steel side
131—slip joint adapter—plain spigot end on steel side
132—hydrant adapter—MJ bell configured for fire hydrant connection
133—grooved adapter—grooved end on steel side
134—Flange to compression adapter
38—HDPE pipe—SDR 11 or other SDR-rated thermoplastic pressure pipe
40—HDPE flange or HDPE-side connection
42—steel valve or steel-side component
46—fastener set—studs, bolts, and nuts
47—cement mortar lining of existing ductile iron or steel pipe
125—existing steel pipe—downstream plain steel pipe
60—cathodic protection lug—multifunctional external lug at crown
84—boundary groove—gasket locating groove
86—second locating groove—full-face gasket locating groove
88—offset ring gasket—eccentric bore offset ring gasket
90—underground fire water pipeline—buried HDPE header
98—structural attachment lugs—lateral side ears at 3 and 9 o'clock positions; thrust restraint, valve maintenance, thermal installation load management; distinct from lug 60
110—HDPE to MJ stub end
122—legacy bore step at existing valve-to-steel-pipe interface
123—sediment accumulation zone
124—recirculation zone—at valve-to-pipe bore step interface
140—high pressure dual bolt pattern adapter
141—flange clamp
143—grooved pipe coupler
144—compression coupler
145—potential leak interface—gasketed sealing face at each bolted connection
146—axial movement permitted—slip joint and compression coupling connections permitting axial displacement
147—rigid fixed joint—no axial movement—fully restrained bolted flange connection
148—grade plane reference line
149—cathodic protection grid
150—existing grooved steel pipe

### II. Overview

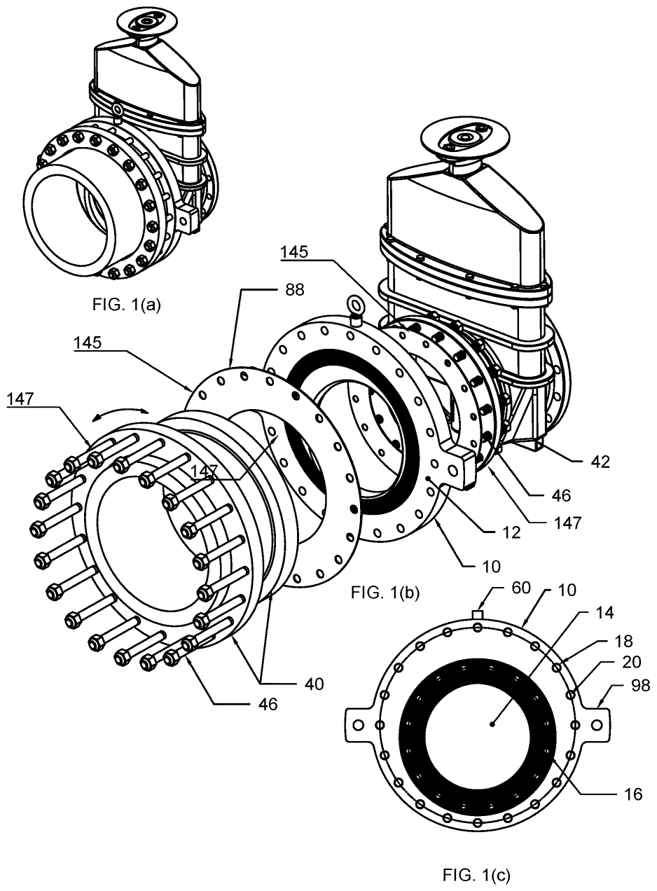

Referring generally to FIGS. 1 through 9, and in particular to FIG. 1(a) and FIG. 1(b), the interface adapter 10 includes a plate body 12 having a central bore 14 extending through the plate body 12. The plate body 12 includes a first fastener pattern 18 configured to mate with a first fluid system component and a second fastener pattern 16 configured to mate with a second fluid system component. Although the interface adapter 10 is described primarily with reference to piping systems, the interface adapter 10 may also be used to connect other fluid system components including pumps, valves 42, manifolds, pressure vessels, heat exchangers, and other process equipment. The interface adapter 10 integrates two distinct functional features within a single component body: (1) purposeful structural ligament preservation between dual fastener patterns to maintain independent load paths and reduce stress field interaction, and (2) flow-conditioning bore geometry to improve hydraulic performance at the interface transition. The combination of these features within a single unitary body distinguishes the interface adapter 10 from conventional spacer plates, spool pieces, and mechanical coupling devices that address structural and hydraulic function separately or not at all. The hydraulic performance improvement achieved by the bore-matched central bore 14 arises as a direct consequence of the bore-matching geometric criterion rather than from an independently designed flow conditioning element, and is inseparable from the sediment elimination function of the bore-matched configuration.

### III. Structural Ligament Regions and Load-path Preservation

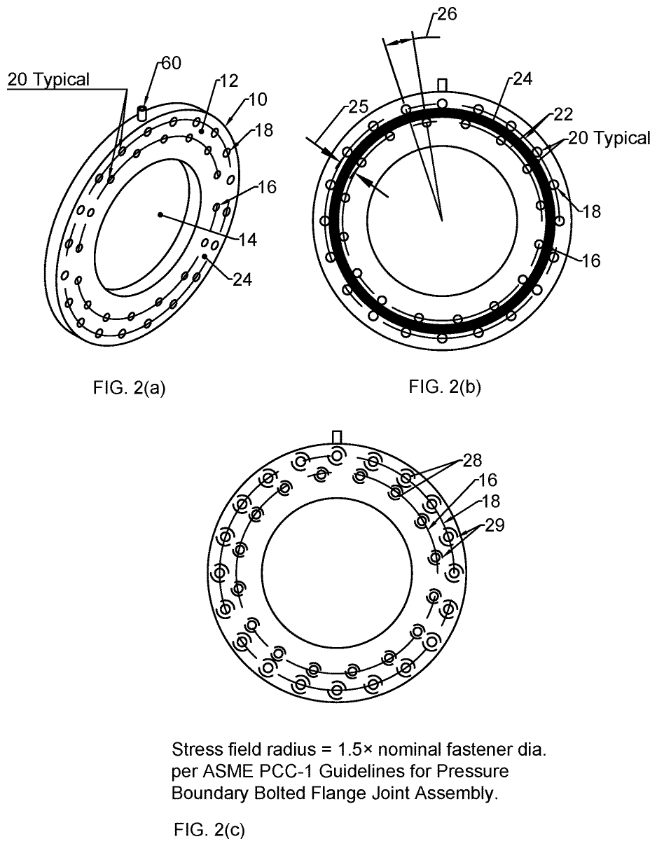

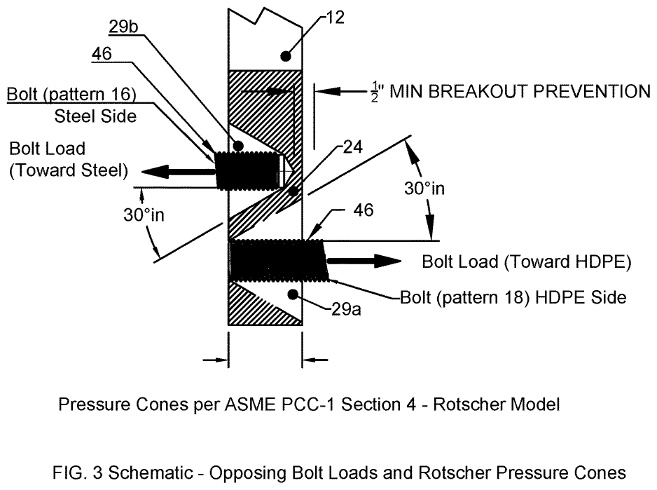

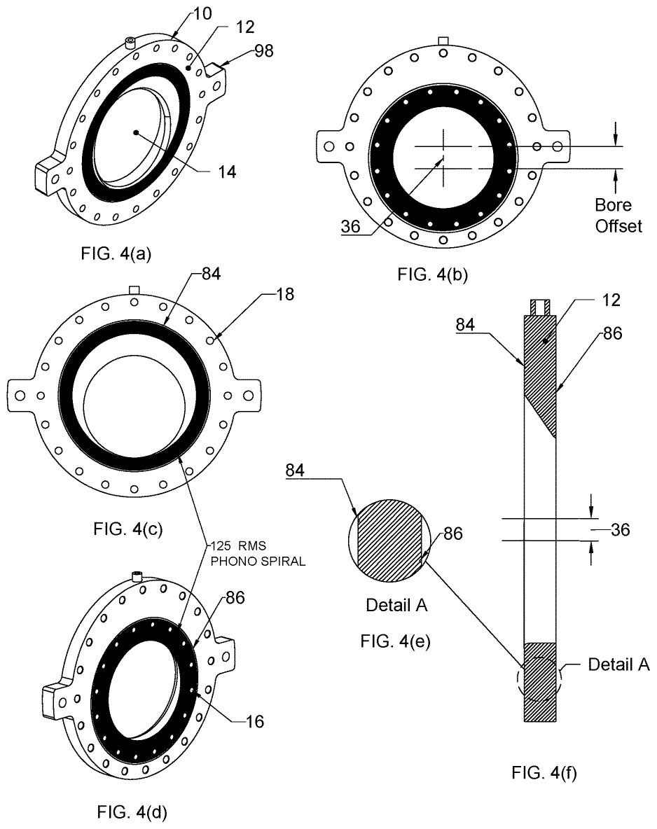

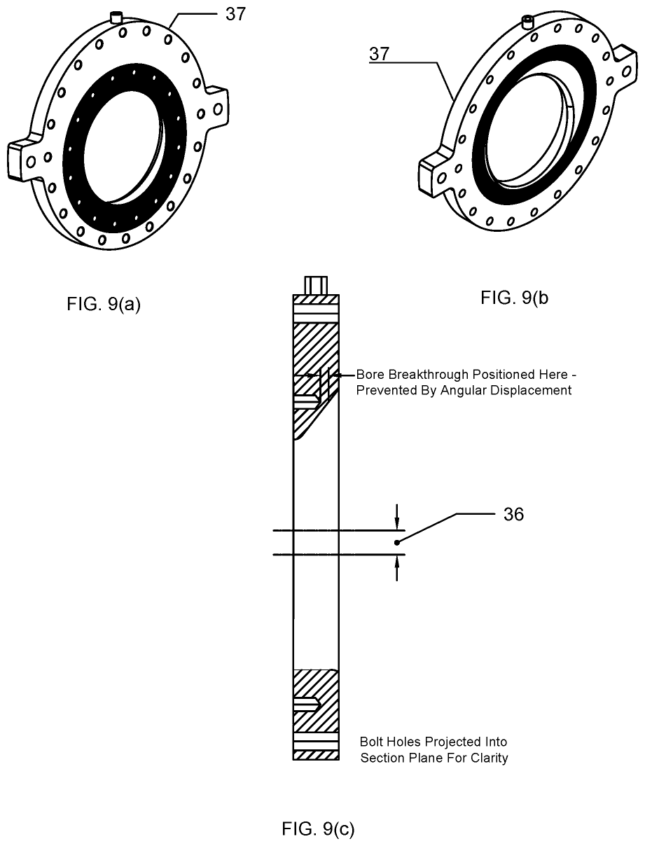

Referring to FIG. 2(a), 2(b), and 2(c), the first fastener pattern 18 and the second fastener pattern 16 may be positioned relative to one another such that structural ligament regions 24 remain between adjacent fastener openings 20. As used herein, a structural ligament region 24 refers to a continuous region of plate body material between neighboring fastener openings 20 that is sufficiently wide to transmit structural loads without yielding or fracture under design service loads, including bolt preload, internal pressure, piping reaction loads, thermal loads, vibration, and transient pressure loads. Referring to FIG. 3, the plate body 12 is subject to two opposing axial bolt load systems acting simultaneously through its thickness. The first connection pattern 18 fasteners bear against the HDPE-side face of the plate body 12 and impose axial compressive preload into the plate body in the direction of the steel-side component. The second connection pattern 16 fasteners bear against the steel-side face of the plate body 12 and impose axial compressive preload into the plate body in the direction of the HDPE-side component. These two bolt load systems act in opposing axial directions simultaneously—the first connection pattern fasteners pulling the HDPE stub end flange toward the plate body while the second connection pattern fasteners pull the steel component flange toward the plate body—placing the plate body material between the two connection patterns in equilibrium between opposing compressive demands. Each bolt preload propagates through the plate body thickness as a three-dimensional pressure cone consistent with the Rotscher pressure cone model, designated pressure cone 29a for the first connection pattern and pressure cone 29b for the second connection pattern as shown in FIG. 3. Per the pressure cone methodology of ASME PCC-1 Guidelines for Pressure Boundary Bolted Flange Joint Assembly Section 4, the zone of significant bolt preload influence extends approximately 1.5 fastener diameters from the fastener centerline, and the pressure cone for each fastener projects through the plate body thickness at a half-angle consistent with that radius at the plate face. FIG. 3 confirms that pressure cones 29a and 29b do not intersect within the structural ligament region 24 of the plate body 12—the cones from the two opposing bolt systems remain separated by continuous plate body material throughout the full plate thickness. This non-intersection of opposing pressure cones within the structural ligament region 24 is the physical basis for the stress field non-overlap criterion: when the cones do not intersect, each bolt load system transmits through its own independent region of plate material without competing with the opposing load system, preserving load-carrying continuity and preventing the structural compromise that arises when opposing stress fields interact within the same material region. The minimum breakout prevention dimension—the minimum distance from the bottom of the blind tapped holes of the second connection pattern 16 to the first face of the plate body—is identified in FIG. 3 and confirmed to be sufficient to prevent hole breakthrough to the opposite face at the governing plate thickness. The structural attachment lugs 98, positioned on the outer diameter of the plate body 12 at the lateral side positions—nominally at the 3 o'clock and 9 o'clock positions relative to the pipe centerline—as shown in FIG. 4(a), provide supplemental thrust restraint surfaces for axial load transfer to external restraint hardware where required by installation geometry, and are distinct in function from the cathodic protection lug 60 which serves the three functions described herein. Finite element analysis performed on a 20-inch by 16-inch nominal straight bore flanged adapter 126 confirmed non-intersection of the first and second connection pattern pressure cones 29a and 29b within the structural ligament region 24 at the governing plate thickness under combined bolt preload, internal pressure, and thermal service loads, consistent with the Rotscher pressure cone model and the ASME PCC-1 Section 4 non-overlap criterion described herein and illustrated in FIG. 3. In certain embodiments, the minimum material width 25 between any opening of the first fastener pattern 18 and the nearest opening of the second fastener pattern 16 is at least 0.5 times the diameter of the larger of the two neighboring openings. The primary design criterion governing the positional relationship between the two connection patterns is the substantial non-overlap of bolt preload stress fields: substantially no bolt preload stress field associated with any opening of the first connection pattern 18 shall overlap any bolt preload stress field associated with any opening of the second connection pattern 16. For purposes of this criterion, the bolt preload stress field associated with each fastener opening is defined as a circular zone of radius equal to approximately 1.5 to 2 times the nominal diameter of the fastener received by that opening, centered on the centerpoint of the opening, with the exact value depending on material properties, plate thickness, and preload conditions. The 1.5 times nominal fastener diameter stress field boundary represents a conservative baseline consistent with recognized bolted flange design practice, including ASME PCC-1 Guidelines for Pressure Boundary Bolted Flange Joint Assembly, in which the zone of significant bolt preload influence extends approximately 1.5 fastener diameters from the fastener centerline. The bolt preload stress field propagates through the plate body thickness as a three-dimensional pressure cone, consistent with the Rotscher pressure cone model and the pressure cone methodology of Section 4 of ASME PCC-1 Guidelines for Pressure Boundary Bolted Flange Joint Assembly, with the 1.5 times nominal fastener diameter radius representing the projection of that cone at the plate face and shown in FIG. 2(b). In the dual-pattern adapter configuration, the two connection patterns impose opposing axial bolt load systems on the plate body: the first connection pattern fasteners bear against the plate body in the direction of the first fluid system component, and the second connection pattern fasteners bear against the plate body in the direction of the second fluid system component. The plate body is in equilibrium between these opposing load systems, and the structural ligament material between the two patterns is subject to simultaneous opposing axial tensile demands from both bolt systems. The non-overlap criterion ensures that the stress cones of the two opposing bolt systems do not intersect within the plate body, preserving continuous plate material capable of independently transmitting each load system without interference from the other. When the stress fields of the two connection patterns do not overlap, the plate body material in the structural ligament region 24 between the patterns is subjected to the preload influence of one pattern at a time rather than to the simultaneous competing influence of both patterns, preserving the structural integrity and load-carrying continuity of the ligament material. The non-overlap condition requires that the center-to-center distance between any opening of the first connection pattern and the nearest opening of the second connection pattern be at least three times the nominal fastener diameter, which for typical clearance holes corresponds to an edge-to-edge distance of approximately 1.9 times the nominal fastener diameter. The angular displacement between the patterns shown in FIG. 2(b) is a consequence of optimizing the hole positions to satisfy this stress field non-overlap criterion across both connection patterns simultaneously, not an independent design parameter. The angular displacement that satisfies the stress field non-overlap criterion is achievable in the present invention solely because the HDPE-side connection is made through a lap joint flange assembly comprising a stub end heat-fused to the HDPE pipe end and a loose backing ring that rotates freely around the pipe outside diameter. The second connection pattern 16—the steel-side blind tapped hole pattern—is fixed in angular position by the flange standard of the connected metallic component and by industry convention: the two-hole standard orients two bolt holes straddling the vertical centerline of the flange such that neither the 12 o'clock nor the 6 o'clock position falls on a bolt hole, and this orientation is set at the time of adapter plate manufacture and does not change in the field. The first connection pattern 18—the HDPE-side bolt hole pattern carried by the lap joint backing ring—is angularly independent of the adapter plate body because the backing ring rotates freely around the pipe exterior. This rotational independence means that the HDPE-side backing ring can be positioned to any angular orientation relative to the adapter plate without affecting the adapter plate orientation or the steel-side bolt hole positions, allowing the stress field non-overlap criterion to be satisfied at the adapter plate level while the backing ring is independently rotated to the two-hole standard orientation required for the HDPE stub end flange connection. Without the lap joint flange configuration on the HDPE side, the HDPE-side bolt holes would be fixed relative to the pipe and could not be independently positioned to satisfy the non-overlap criterion—the adapter plate angular position required for stress field separation would conflict with the bolt hole orientation required for the two-hole standard, making it impossible to satisfy both requirements simultaneously with a fixed-flange HDPE connection. The lap joint backing ring is therefore not merely a connection convenience—it is the structural enabler that makes the stress field non-overlap criterion achievable in a dual-pattern adapter connecting dissimilar materials, and is the reason this adapter configuration is possible. The structural significance of the stress field non-overlap criterion is demonstrated by the dimensional proximity of bolt circles from different standards for the same nominal pipe size. For a 16-inch nominal connection, the AWWA C207 steel pipe flange bolt circle has a diameter of approximately 18.50 inches while the ASME B16.5 Class 150 flange bolt circle has a diameter of approximately 18.75 inches—a radial separation of only 0.125 inches. For M20 fasteners (nominal diameter 20 mm), the bolt preload stress field radius defined by the present invention is 1.5 times 20 mm, or 30 mm (approximately 1.18 inches). Since the radial separation between the two 16-inch bolt circles (0.125 inches) is less than the stress field radius (1.18 inches), a conventional adapter connecting 16-inch HDPE to a 16-inch steel component using concentric bolt circles from these two standards would have every bolt hole on one pattern within the stress field of the nearest bolt hole on the other pattern, producing the structural ligament failure mode described herein. The stress field non-overlap criterion of the present invention requires the adapter designer to separate and angularly displace the two patterns to satisfy the 1.5-times criterion—a non-obvious design requirement that is not disclosed or suggested by any prior art adapter for HDPE-to-steel connections known to the inventors. A further and physically decisive consequence of the stress field non-overlap criterion arises specifically in eccentric bore adapter configurations—those required for invert continuity in bore-matched reducing connections. An eccentric bore adapter has a bore centerline that is offset from the plate body centerline, producing a plate body that is thinner on the invert side (where the bore is closest to the plate outer edge) and thicker on the crown side. For a 20-inch IPS SDR 11 HDPE main connecting to a 16-inch steel valve through an eccentric bore adapter, the bore centerline is offset approximately 0.18 inches above the plate body centerline, placing the bore edge at the invert position approximately 7.818 inches from the plate center. The second connection pattern bolt circle for the 16-inch steel valve is approximately 9.25 inches in radius. The second connection pattern at the 16-inch valve face receives 1.00-inch diameter bolts, requiring clearance holes of approximately 1.063 inches diameter. For the valve connection (bore radius 8.000 inches, eccentric offset 0.182 inches), the bore bottom is at 7.818 inches from the plate center, while the steel bolt hole inner edge is at 8.719 inches. The gap between the bore wall and the bolt hole at the invert is 0.901 inches—which is less than the 2-inch minimum plate thickness required by the 1.5 times largest-bolt criterion. The plate must therefore be angularly displaced so that no bolt hole falls within the angular zone of minimum wall thickness at the invert position. For the steel pipe connection configuration (bore radius 7.625 inches, eccentric offset 0.557 inches), the bore bottom is at 7.068 inches from the plate center, and the gap is 1.651 inches—also less than the 2-inch minimum, confirming that angular displacement is essential in both configurations. If the second connection pattern bolt hole is positioned at the invert angular position of the plate, it physically intersects the central bore: the tapped hole breaks through the bore wall into the fluid flow path, rendering the adapter unmanufacturable and unusable. This breakthrough condition is not a stress concentration or fatigue concern—it is a geometric manufacturing impossibility that arises whenever bolt holes from either connection pattern are positioned at the angular location of the minimum wall thickness on an eccentric bore adapter plate. The stress field non-overlap criterion of the present invention prevents this breakthrough as a direct physical consequence of its angular displacement requirement: by requiring that substantially no bolt preload stress field of either pattern overlaps any stress field of the other pattern, the criterion ensures that bolt holes from the two patterns are angularly displaced from one another and from the minimum-wall-thickness invert position, maintaining minimum material continuity between the bore wall and every bolt hole in both connection patterns throughout the full circumference of the plate body. No conventional adapter for HDPE-to-steel transitions with eccentric bores is known to address this breakthrough constraint, and no conventional adapter standard specifies the angular displacement criterion necessary to prevent it. As a first non-limiting dimensional example, for a 6 inch nominal diameter adapter configured to connect a first component having four 0.875 inch diameter bolt holes at a 7.25 inch bolt circle and a second component having eight 0.75 inch diameter bolt holes at a 8.25 inch bolt circle, the first fastener pattern 18 and second fastener pattern 16 may be radially separated and angularly offset such that no opening of one pattern is within less than 0.875 inches of any opening of the other pattern, preserving structural ligament regions 24 of at least this width throughout the plate body 12. As a second non-limiting dimensional example, for a 12 inch nominal diameter adapter connecting a first component having eight 1 inch diameter bolt holes at a 13 inch bolt circle and a second component having twelve 0.875 inch diameter bolt holes at a 14.25 inch bolt circle, the patterns may be radially separated and angularly offset such that the minimum material width between any opening of the first pattern and the nearest opening of the second pattern is at least 1 inch, maintaining the same proportional spacing relationship at the larger diameter. These examples illustrate the scale-invariant nature of the spacing relationship described in the claims—the same proportional relationship between minimum material width and opening diameter is maintained regardless of adapter nominal size, allowing the structural benefits of the design to be preserved across the full range of pipe and valve sizes. In certain embodiments, the first fastener pattern 18 and the second fastener pattern 16 are radially separated and angularly displaced relative to one another, as shown in FIG. 2(b) and 2(c). In certain embodiments, the patterns are rotationally offset relative to one another such that openings of one pattern are not directly radially aligned with openings of the other pattern. These arrangements preserve independent structural load path regions 28 within the plate body 12, as illustrated in FIG. 2(c), and reduce overlap of bolt preload stress fields 29 generated by fasteners 46. Referring to FIG. 9(a), in certain embodiments the relative spacing relationship between the fastener patterns is maintained proportionally across adapters of different overall diameters such that structural ligament regions 24 and independent structural load paths 28 are preserved regardless of adapter size, with the stress field non-overlap criterion satisfied at all nominal sizes. The scale-invariant nature of the stress field non-overlap criterion, combined with the geometric bore-matching principle, enables the interface adapter 10 to be applied across the full range of pipe sizes from 4-inch through 60-inch and larger. In each application, the HDPE pipe size is selected on the basis of bore compatibility with the existing steel component: the SDR 11 HDPE nominal size whose inside diameter most closely approximates the inside diameter of the existing steel valve, fitting, or pipe is selected for the replacement installation, and the interface adapter 10 accommodates the residual bore differential—which may range from near zero to several inches depending on the specific HDPE size and steel component combination—within the bore profile of the adapter plate body. In certain configurations, an optimal bore match is achievable with very small differential: for example, the 20-inch IPS SDR 11 HDPE to 16-inch steel valve configuration (bore differential approximately 0.364 inches)—with the adapter bore profile accommodating the larger differential through a slight eccentric offset, as the 0.364-inch bore differential exceeds the 0.25-inch straight-bore threshold set forth in this document. The selection of HDPE nominal size is therefore a design decision based on hydraulic capacity requirements, available pipe sizes, and bore compatibility with the existing steel components, and the interface adapter 10 is configured to accommodate any bore differential that results from that selection. Representative bore-matching configurations at large diameters include: 24-inch IPS SDR 11 HDPE (bore approximately 19.63 inches) connecting to a 20-inch steel component with an inside diameter of 19.25 inches; 30-inch IPS SDR 11 HDPE (bore approximately 24.5 inches) connecting to a 24-inch steel component with an inside diameter of 23.75 inches; 36-inch IPS SDR 11 HDPE (bore approximately 29.45 inches) connecting to a 30-inch steel component with an inside diameter of 29.25 inches; and 60-inch IPS SDR 11 HDPE (bore approximately 49.1 inches) connecting to a 50-inch steel component with an inside diameter of 49.25 inches. AWWA C207 flanged connections are available for all pipe sizes through 60 inches and larger, and the minimum plate thickness criterion scales with bolt size—for 60-inch AWWA C207 adapters using 1.75-inch diameter HDPE-side fasteners, the minimum plate thickness is 1.5 times the largest fastener diameter plus 0.25 inches, giving 2.875 inches rounded up to 3.00 inches minimum thickness. At large diameters the bolt circles of the two connection patterns are separated by 6 to 7 inches or more in diameter, providing inherently greater structural ligament material between patterns while the angular displacement criterion continues to govern bolt hole positioning at the minimum wall thickness section of eccentric bore configurations. Although the embodiments described herein refer to high-density polyethylene (HDPE) pipe conforming to AWWA C906 or ASTM F714 as the primary example, the interface adapter 10 is not limited to HDPE pipe. The bore-matching principle, stress field non-overlap criterion, unitary plate body construction, and structural ligament geometry of the present invention apply equally to any polymeric pressure pipe —including polyvinyl chloride (PVC) pipe conforming to AWWA C900 or C905, chlorinated polyvinyl chloride (CPVC), polypropylene (PP-R or PP-RCT), polyvinylidene fluoride (PVDF), polyethylene of raised temperature resistance (PE-RT), and glass-reinforced epoxy (GRE or GRP) pipe—that presents an inside bore diameter differing from the inside bore diameter of the connected metallic fluid system component by reason of wall thickness, material properties, or dimensional standard. The geometric conditions that create overlapping stress fields between dual fastener patterns—and the breakthrough risk at minimum wall thickness that necessitates angular displacement—arise from the relative diameters of the two flange bolt circles and the bore diameter, and are independent of the pipe material. Similarly, the bore-matched central bore that eliminates the sediment accumulation ledge at the metallic component face is applicable to any pipe material whose inside bore diameter differs from the inside bore of the connected steel component. Embodiments of the interface adapter 10 configured for polymeric pipe other than HDPE, and for all SDR and DR pressure classes of HDPE pipe including SDR 13.5 (160 psi), SDR 17 (125 psi), SDR 9 (250 psi), and SDR 7 (335 psi), are within the scope of the present invention. A significant and growing application of the interface adapter 10 is in new municipal water distribution system construction and rehabilitation where the distribution main is a bell-and-spigot thermoplastic pipe—including PVC pressure pipe conforming to AWWA C900 or C905, oriented PVC pipe (PVCO) conforming to AWWA C909, or PE4710 HDPE pipe conforming to AWWA C906—and the valves, fire hydrant branches, service connections, and system appurtenances are flanged or mechanical joint ductile iron components conforming to AWWA C110, AWWA C153, or ASME B16.1 Class 125. In these new construction applications, the thermoplastic distribution main is not a retrofit of existing steel pipe but rather the primary pipe material selected for its corrosion resistance, pressure capacity, flow characteristics, and installed cost advantages. The interface adapter 10 provides the bore-matched, fully restrained flanged connection between the thermoplastic main and the metallic valve or appurtenance at each connection point, serving the identical structural and hydraulic function as in a retrofit application but in a new installation context. The bore differential between a PVC C900 or PVCO C909 main and its connected ductile iron valve arises from the same dimensional relationships as in HDPE systems: the thick wall of pressure-rated plastic pipe per the applicable DR or SDR rating produces a bore diameter smaller than the nominal bore of the connected ductile iron valve, and the interface adapter 10 accommodates this differential within the adapter bore profile without requiring an oversized valve. For example, a 16-inch C900 PVC pipe (DR 18, wall thickness approximately 0.89 inches, inside diameter approximately 14.22 inches) connecting to a 14-inch full-port ductile iron gate valve (bore approximately 14.00 inches) presents a bore differential of approximately 0.22 inches, which falls within the straight bore threshold and permits a concentric straight bore adapter. A 20-inch C900 PVC pipe (DR 18, wall thickness approximately 1.11 inches, inside diameter approximately 17.78 inches) connecting to an 18-inch full-port ductile iron gate valve (bore approximately 18.00 inches) presents a bore differential of approximately 0.22 inches, which falls within the straight-bore threshold and permits a concentric straight bore adapter. The interface adapter 10 in these PVC and PVCO applications uses a stub end and lap joint backing ring compatible with the applicable plastic pipe flange standard on the first face, and a ductile iron compatible full-face flat flange gasket conforming to AWWA C111 and ASME B16.1 Class 125 on the second face, with phonographic face finish and gasket locating grooves as described herein providing the same sealing and alignment functions as in HDPE applications. The three-function external lug 60 serves the same cathodic protection bonding conductor attachment, lifting, and eccentric bore orientation reference functions in PVC and PVCO applications as in HDPE applications, because the ductile iron valves and appurtenances in new municipal construction retain the same cathodic protection and bonding requirements as in retrofit systems. The structural lugs may also be used for these applications depending on thrust requirements and type of connection the adapter may be connected. The interface adapter 10 is therefore applicable across the full range of current thermoplastic pressure pipe materials and standards used in municipal water and fire water distribution construction, providing a single adapter architecture that bridges the dimensional gap between any thick-wall plastic pressure pipe and the metallic valve and appurtenance infrastructure that controls and distributes the flow at each system connection point. The fastener openings of the connection pattern 18 comprise tapped holes extending completely through the plate body thickness, configured to receive threaded fasteners of the first connection pattern engaging the plate body threads along the full plate thickness from the first face. The through-tapped configuration of the first connection pattern provides thread engagement along the full plate body thickness, which equals or exceeds 1.5 times the nominal diameter of the first connection pattern fastener at all standard plate thicknesses, and eliminates any constraint on plate body thickness from the first connection pattern. The fastener engagement depth of the first connection pattern fasteners shall not exceed the plate body thickness, as protrusion of a fastener tip beyond the second face of the plate body would interfere with seating of the metallic component flange against the second face and compromise gasket compression at the second face sealing surface. The fastener openings of the second connection pattern 16 comprise blind tapped holes formed in the plate body from the second face, having a depth of not less than 1.5 times the nominal diameter of the second connection pattern fastener, comprising 1.25 times the nominal fastener diameter of minimum thread engagement depth and 0.25 times the nominal fastener diameter of drill tip allowance permitting fabrication with standard twist drill tooling without requiring flat-bottom end mill preparation. Not less than ½ inch of solid plate body material remains between the bottom of each blind tapped hole and the first face of the plate body, preventing hole breakthrough to the first face and providing clearance between the blind hole bottom and the through-tapped first connection pattern holes at their respective angular positions. The minimum plate body thickness is governed by the first connection pattern fastener size and is not less than 1.5 times the nominal diameter of the first connection pattern fastener plus ¼ inch. For a first connection pattern fastener of 1⅛ inch nominal diameter, the minimum plate body thickness is 1.9375 inches, rounded up to 2.00 inches. For a first connection pattern fastener of 1 inch nominal diameter, the minimum plate body thickness is 1.75 inches. The angular displacement of the second connection pattern required by the stress field non-overlap condition additionally ensures that no blind tapped hole of the second connection pattern is positioned at the same angular location as any through-tapped hole of the first connection pattern, preventing communication between the two hole sets through the plate body at any plate body thickness. In eccentric bore embodiments, the plate body thickness is increased as required above the concentric bore minimum so that the blind tapped holes of the second connection pattern, at every angular position including the minimum wall thickness section at the invert of the eccentric bore, maintain not less than ½ inch of plate body material between the blind hole bottom and the bore wall. In an alternative embodiment, the fastener openings of the first connection pattern 18 may also comprise blind tapped holes rather than through-tapped holes, terminating within the plate body at a depth of not less than 1.5 times the nominal diameter of the first connection pattern fastener from the first face, with not less than ½ inch of plate body material remaining between the blind hole bottom and the second face of the plate body. In this dual blind tapped configuration, both the first connection pattern fastener openings and the second connection pattern fastener openings comprise blind tapped holes formed from their respective faces, and neither set penetrates to the opposite face. The minimum plate body thickness in the dual blind tapped configuration is governed by the requirement that each set of blind tapped holes maintain not less than ½ inch of plate body material to the opposite face, with the angular displacement required by the stress field non-overlap condition preventing any blind tapped hole of the first connection pattern from being positioned at the same angular location as any blind tapped hole of the second connection pattern, thereby preventing intersection between the two sets of blind tapped holes through the plate body regardless of plate thickness. The dual blind tapped configuration produces shorter fasteners on both connection pattern faces compared to through-tapped configurations, which may be preferred in larger diameter adapters where fastener length and cost are significant considerations.

### IV. Hydraulic Flow-Conditioning Bore

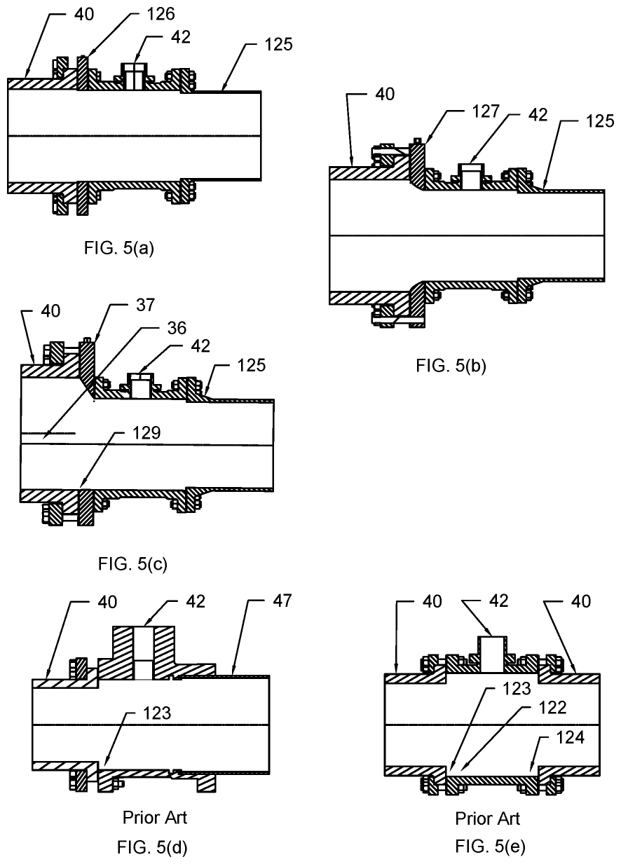

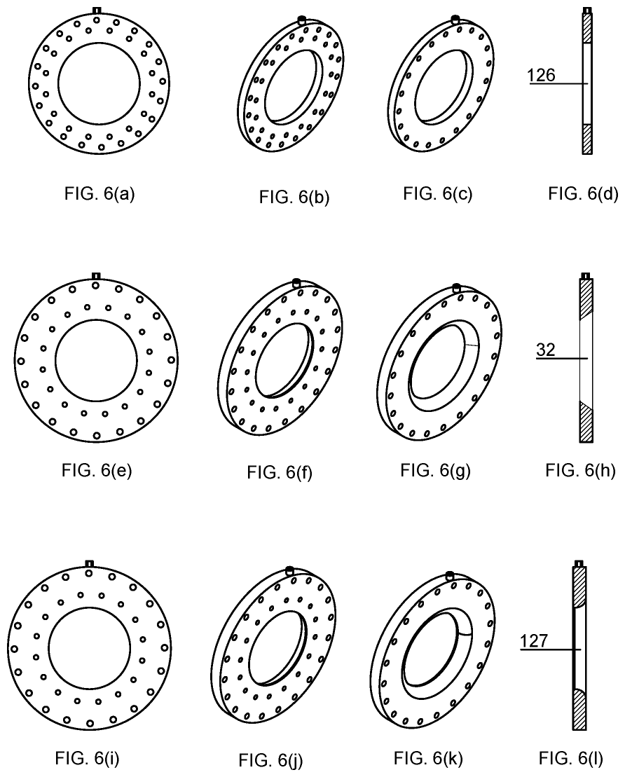

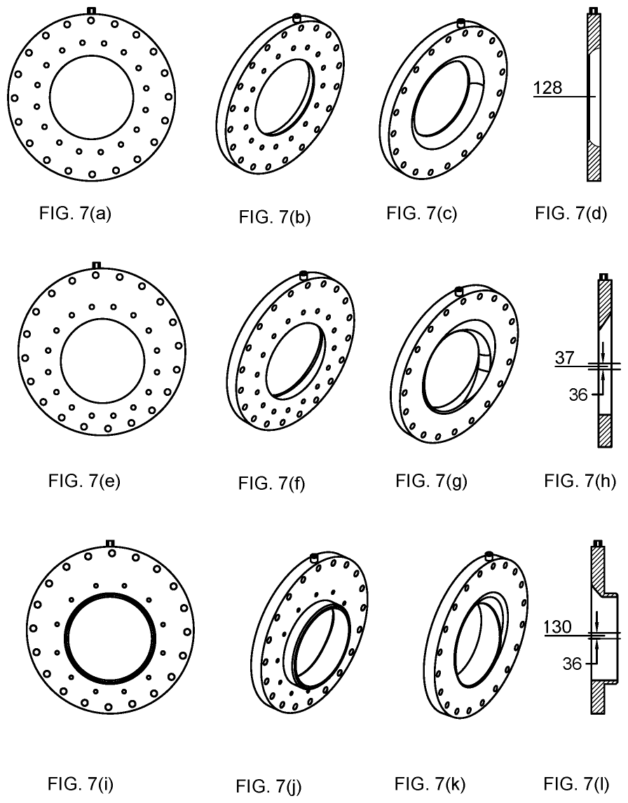

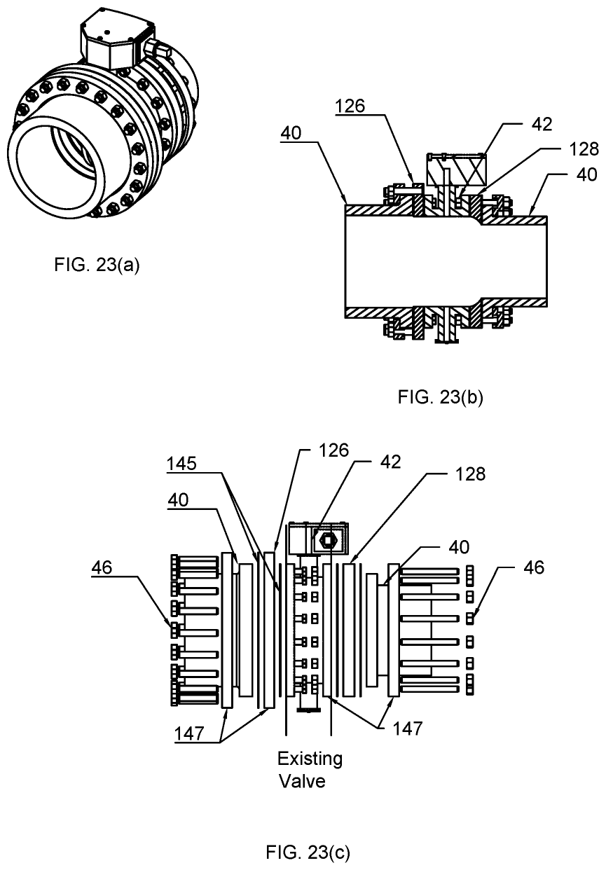

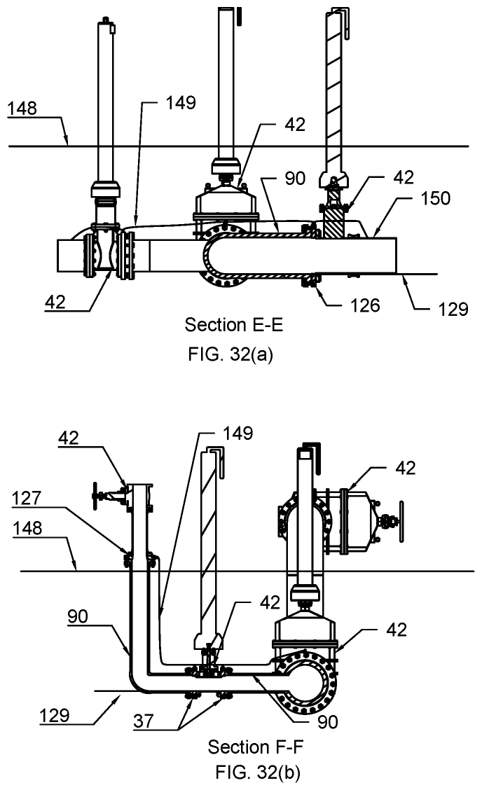

Referring to FIG. 5(a), 5(b), and 5(c), the central bore 14 may be sized and configured to match the internal bore diameter of a connected valve 42 or other process component, maintaining hydraulic continuity through the interface adapter 10 and eliminating the sediment accumulation zones and flow discontinuities that arise when the adapter bore diameter differs from the valve internal diameter. As used herein, a valve bore matched configuration refers to a central bore 14 having an inside diameter selected to be substantially equal to the internal bore diameter of a directly connected valve 42 such that no annular step, recess, or enlargement exists at the upstream face of the valve body through which fluid must pass before entering the valve bore. In a valve bore matched configuration, the velocity distribution entering the valve 42 is substantially continuous with the velocity distribution exiting the adapter bore 14, minimizing the recirculation zone and sediment accumulation that would otherwise form at the upstream valve face. For butterfly valves and other partial-obstruction valve types, the valve bore matched configuration also provides appropriate clearance for the valve disc or closure element without requiring additional bore enlargement that would reintroduce the sediment trap condition. In retrofit installations, the existing steel piping system may include bore steps 122 at the downstream face of existing valves where valve bore diameter exceeds the internal bore of the connected steel pipe —a pre-existing condition in the legacy system that the interface adapter 10 does not create or worsen. Existing solutions include connection of line-size thick wall plastic piping to the line size valve or piping component creating a significant bore mismatch and sediment trap at the most critical point in the system, the valve seating area. Examples of these two scenarios are shown in FIG. 5(d) and FIG. 5(e). In certain retrofit applications, sizing the central bore 14 to match the valve 42 internal diameter—rather than the nominal pipe inside diameter of the connected HDPE piping 38—allows the use of a standard-size valve at the existing location without requiring an oversized valve body, reducing cost and eliminating the sediment trap condition that would otherwise form at the upstream valve face. As a non-limiting dimensional example of the valve bore matching principle, a 16-inch IPS SDR 11 HDPE pipe has an inside diameter of approximately 13.1 inches. A 14-inch IPS SDR 11 HDPE pipe has an inside diameter of approximately 11.45 inches. In this example, an eccentric adapter from the 16 inch SDR 11 pipe to the 14″ valve would be used to match bottom inside pipe elevation. The step at the steel pipe side would be dealt with when the steel piping is replaced with the HDPE pipe and the eccentric adapter. The interface adapter 10 is configured for two distinct bore-matching scenarios depending on the nature of the connected metallic fluid system component. In the first scenario—connection to a valve—the connected metallic fluid system component is a full-port gate valve, butterfly valve, ball valve, check valve, or similar valve whose internal bore diameter approximates the valve nominal size. A 16-inch full-port gate valve, for example, has an internal bore diameter of approximately 16.00 inches. When a 20-inch IPS SDR 11 HDPE main (inside diameter approximately 16.36 inches) connects to such a valve through the interface adapter 10, the central bore 14 reduces from the 16.36-inch HDPE bore to match the 16.00-inch valve bore, with an eccentric offset of approximately 0.84 inches to maintain invert continuity. This valve-specific configuration directly eliminates the sediment accumulation zone at the upstream face of the valve that would otherwise form from the 1.67-inch bore differential, preserving full valve actuation travel, preventing debris accumulation on valve seats, and maintaining original system hydraulic capacity. In the second scenario—connection to a steel pipe component—the connected metallic fluid system component is a steel pipe, steel fitting, or steel appurtenance whose internal bore diameter is determined by its wall thickness and is typically smaller than the pipe nominal size. A 16-inch Class 150 steel pipe, for example, has an internal bore diameter of approximately 15.25 inches—smaller than both the valve bore and the nominal pipe size. When a 20-inch IPS SDR 11 HDPE main connects to such a steel pipe component, the central bore 14 reduces from 16.36 inches to match the 15.25-inch steel pipe bore, with an eccentric offset of approximately 0.18 inches for invert continuity. In both scenarios, the interface adapter 10 eliminates the bore discontinuity that would otherwise create a sediment accumulation ledge, cavitation zone, or flow impingement point at the transition face, regardless of whether the source of the bore differential is valve design, steel pipe wall thickness, nominal size differential, or any combination thereof. As required or specified, the bore offset could be designed for bore mismatch related to connection of piping with similar internal diameters. In addition to valve bore matching, the central bore 14 may include flow-conditioning geometry configured to further improve hydraulic performance within the fluid system. As used herein, the term condition fluid flow refers to the modification of the velocity distribution of fluid passing through the interface adapter by the bore profile geometry, including reducing turbulence, redistributing velocity non-uniformity, redirecting adverse impingement angles, reducing recirculation zone extent, or combinations thereof. Such geometry may include a radiused bore transition 30, a tapered bore section 32, an eccentric bore alignment 36, a flow-conditioning region, or combinations thereof. In certain embodiments, the central bore 14 includes a profile that varies in diameter or cross-sectional geometry between a first end and a second end, as shown in FIG. 6(a) through 8(l)). The flow-conditioning effect of the central bore 14 is a consequence of the bore-matched geometry rather than an independently designed hydraulic feature. Because the bore diameter is selected to match the internal bore diameter of the connected metallic fluid system component, the velocity distribution entering the connected component is substantially continuous with the velocity distribution within the adapter bore—there is no abrupt bore expansion, annular recess, or step at the component face into which the flow must decelerate, separate, and recirculate. The elimination of bore discontinuity at the component face inherently modifies the velocity distribution relative to a conventional adapter having an oversized or stepped bore. No separate hydraulic design of the bore profile is required to achieve this flow-conditioning effect in the valve bore matched configuration—it arises directly from the bore-matching geometric criterion. This distinguishes the present invention from flow conditioning devices designed for hydraulic performance as a primary objective, such as flow straighteners, perforated plate conditioners, and tapered meter inlet adapters, which are configured to modify velocity distribution independently of any bore-matching function. In the present invention, the bore-matching function and the flow-conditioning effect are inseparable consequences of the same geometric criterion: sizing the adapter bore to match the connected component bore. In certain embodiments, particularly for fire water distribution system retrofit applications connecting SDR 11 HDPE piping to existing installed steel valves, the central bore 14 is a straight cylindrical bore of substantially constant diameter throughout the axial length of the plate body 12. In this straight bore configuration, the bore diameter is selected to match the internal bore diameter of the connected valve 42, achieving the valve bore matched condition described herein without requiring a tapered or radiused transition profile. The straight bore configuration is suitable for retrofit applications where the diameter difference between the HDPE piping internal diameter and the valve internal bore is modest, where the adapter axial length is short relative to the bore diameter, or where manufacturing simplicity and dimensional consistency across multiple adapter sizes are primary design objectives. The straight bore configuration satisfies the claim requirement that the central bore have a profile that varies in diameter or cross-sectional geometry between a first end and a second end because the bore diameter at the HDPE-side first end and the bore diameter at the valve-side second end differ when the connected pipe and valve internal diameters differ, with the diameter transition occurring at the bore inlet face rather than through a shaped internal profile. FIG. 6(a) through 6(d) illustrate the straight bore configuration 126 and tapered bore configuration 32 as alternative bore profile configurations of the central bore 14. As a non-limiting example, the central bore 14 may include a tapered inlet section having a half-angle of between approximately 5 degrees and 20 degrees, and in certain embodiments approximately 10 degrees, over a length of between approximately 0.5 and 2.0 times the smaller connected internal diameter, transitioning into a downstream cylindrical section matched to the larger connected internal diameter. The inlet taper may be preceded by a radiused entry having a radius of between approximately 0.1 and 0.5 times the smaller connected diameter to reduce inlet separation. FIG. 5(a) through 5(e) illustrate bore matching and prior art bore mismatch configurations for comparison. The tapered and radiused bore configurations are optional enhancements applicable where hydraulic performance optimization is a design objective, and are not required for the valve bore matched function of the interface adapter 10. As shown in FIG. 5(c) and 7(e) through 7(h), in certain embodiments the central bore 14 is positioned eccentrically relative to the plate body 12. The eccentricity of the central bore 36 may be selected to improve top-of-pipe continuity, bottom-of-pipe continuity, invert continuity, drainage characteristics, solids handling, or flow entry conditions for downstream equipment. For example, an eccentric bore 36 positioned to maintain invert continuity may reduce sediment accumulation in buried or horizontal installations, while an eccentric bore 36 positioned to maintain crown continuity may improve air release behavior in pressurized systems. In reducing adapter configurations where the interface adapter 10 connects high-density polyethylene piping of one nominal size to a metallic fluid system component of a smaller nominal size, the eccentric bore offset corrects for both the wall-thickness differential and the nominal size differential simultaneously. For example, in a 20-inch IPS SDR 11 HDPE pipe (inside diameter approximately 16.36 inches) connecting to a 16-inch metallic component (internal bore approximately 15.25 inches), the eccentric bore offset required for invert continuity is approximately 0.182 inches—corresponding to a bore differential of 0.364 inches between the 16.364-inch HDPE bore and the 16.000-inch valve bore. In a 14-inch IPS SDR 11 HDPE pipe (inside diameter approximately 11.46 inches) connecting to a 12-inch metallic component (internal bore approximately 11.63 inches), the eccentric offset required is approximately 0.27 inches. In each case, positioning the bore centerline above the plate body centerline by the required eccentric offset aligns the bottom of the bore with the bottom of both the HDPE pipe and the connected metallic component, eliminating the invert ledge that would otherwise form at the transition face. The triple-function external lug 60 serves as the installation orientation reference for setting this eccentric offset in the correct rotational position during field installation, ensuring the bore low point is at the system invert regardless of the magnitude of the eccentric offset required. The high-density polyethylene piping connection to the interface adapter 10 is made through a lap joint flange assembly comprising a stub end heat-fused to the HDPE pipe end and a loose backing ring that rotates freely around the pipe outside diameter. The backing ring carries the first connection pattern 18 bolt holes. This lap joint configuration is the enabling mechanism of the dual-pattern adapter: the second connection pattern 16 blind tapped holes on the steel-side face are fixed in angular position at the time of manufacture, set to the two-hole standard orientation of the connected metallic component flange standard, and do not change in the field. The first connection pattern 18 backing ring rotates independently of the adapter plate body, allowing the HDPE-side bolt hole orientation to be set separately from—and without disturbing—the fixed steel-side pattern orientation. This rotational independence is what makes it possible to simultaneously satisfy the stress field non-overlap criterion at the adapter plate level and achieve two-hole standard alignment at the HDPE backing ring level, two requirements that cannot be satisfied simultaneously with a fixed-flange HDPE connection. This rotatable backing ring configuration is critical for eccentric bore adapter installations because it allows the two independent alignment requirements to be satisfied simultaneously: the interface adapter 10 is oriented with the external lug 60 positioned to place the eccentric bore low point at the system invert—the lug serves as the visible field reference for correct adapter plate rotational orientation—while the HDPE stub end, which is concentric and carries no bore offset, and the backing ring are adjusted independently. The backing ring is rotated to the standard two-hole orientation required by industry convention for flanged valves and piping components. The two-hole standard positions two bolt holes straddling the vertical centerline of the flange such that neither the 12 o'clock nor the 6 o'clock position falls on a bolt hole, providing clearance for valve stem operators and maintaining standard component orientation in both horizontal and vertical piping. Without the rotatable backing ring, the rotational orientation of the adapter plate—set by the lug to achieve invert continuity—would fix the angular position of the first connection pattern bolt holes, making it impossible to achieve both correct eccentric bore orientation and two-hole standard alignment simultaneously using a standard bolt circle. The rotating lap joint backing ring eliminates this constraint: the adapter plate is oriented by the lug for correct eccentric bore alignment, and the backing ring is rotated independently to achieve two-hole standard compliance, with each adjustment made without disturbing the other. Field installation therefore requires only standard concentric stub ends and standard backing rings drilled to the nominal HDPE flange bolt circle—no custom fabrication at any installation point. The selection between a straight cylindrical bore and an offset bore configuration is governed by the bore differential between the high-density polyethylene pipe inside diameter and the inside diameter of the connected metallic fluid system component. Where the bore differential is approximately one-quarter inch or less, a straight cylindrical bore sized to the metallic component bore diameter is acceptable for invert continuity purposes, because the resulting step at the HDPE-side face of the adapter—equal to the bore differential—falls within the assembly tolerance of standard flanged piping connections and does not create a sediment accumulation ledge of hydraulic significance under normal service flow velocities. Standard flanged connections routinely exhibit bore steps of this magnitude resulting from bolt hole clearance, gasket compression variation, and flange face parallelism tolerance, and the one-quarter inch threshold is consistent with the one-eighth inch bolt hole clearance of ASME B16.5 and AWWA C207 flanged connections which permits lateral flange displacement of up to one-eighth inch per face, producing a combined potential bore step of up to one-quarter inch in assembled connections. Where the bore differential exceeds approximately one-quarter inch, the offset bore configuration is required to maintain invert continuity without creating a sediment accumulation ledge. In this configuration the bore centerline is offset from the plate body centerline by an amount equal to one-half the bore differential, positioning the bottom of the bore at the same elevation on both the HDPE-side face and the metallic component face of the adapter plate body. The crown side of the bore transitions from the larger HDPE bore diameter at the HDPE-side face to the smaller metallic component bore diameter at the steel-side face through a tapered transition machined on the upper portion of the bore, while the invert of the bore is flat and continuous across the full plate body thickness. The offset bore is produced on a CNC lathe by specifying a bore centerline offset from the plate body centerline, which is the same machining operation as a concentric bore with only the offset parameter changed—no additional tooling, setup, or machining time is required. Virtually all reducing adapter configurations connecting HDPE piping to existing steel components of a smaller nominal size will exhibit bore differentials substantially exceeding one-quarter inch, making the offset bore the standard configuration for reducing adapters in HDPE-to-steel retrofit service. For same-nominal-size adapter configurations where the HDPE pipe inside diameter closely approximates the metallic component bore—such as connections where the SDR rating produces a bore diameter within one-quarter inch of the connected valve or fitting bore—the straight cylindrical bore is acceptable and provides equivalent invert continuity within the assembly tolerance of the installed connection. In certain embodiments, the eccentric bore alignment 36 of the central bore 14 further includes a shaped crown transition profile selectable between a concave configuration and a convex configuration based on the direction of the bore transition and the type of connected metallic fluid system component. In the concave crown configuration, applicable to reducing transitions in which the adapter bore is smaller than the upstream pipe bore, the bore surface on the crown side of the eccentric bore curves inward toward the bore centerline at a continuous rate through the full plate body thickness from the first face to the second face of the plate body. This continuous concave crown profile creates a crescent-shaped region of plate body material between the bore perimeter and the plate outer edge on the crown side, a deflection surface that acts on fluid approaching from the larger upstream pipe. Fluid approaching from the upstream pipe cannot enter the plate body through the crescent region and is deflected downward and inward toward the bore opening. This lateral constriction accelerates the approaching flow through the eccentric bore opening, reducing local static pressure at the transition face. The pressure reduction at the transition face acts on air occupying the crown of the upstream larger pipe, buoyant air that accumulates at the crown during system startup, initial pressurization, and post-maintenance refilling, drawing it downward and into the accelerating flow stream, where it is entrained and carried through the bore and out through the downstream piping. This air evacuation function is a direct consequence of the eccentric bore offset and concave crown profile geometry and requires no separate air release valve or dedicated air management fitting at the transition point. The effectiveness of the air evacuation mechanism increases with the magnitude of the eccentric bore offset, as larger reducing transitions produce greater crescent geometry, greater lateral constriction, higher flow acceleration, and stronger pressure differentials at the transition face, providing more effective air evacuation for the larger bore differentials characteristic of large-diameter HDPE-to-steel reducing connections. The concave crown configuration further provides rotational sweep clearance for butterfly valve disc components when the interface adapter 10 is installed adjacent to a butterfly valve body. A butterfly valve disc is sized to the internal bore diameter of the valve body, which conforms to the steel pipe bore dimension, and rotates through a 90-degree arc from the closed position to the fully open position. When SDR 11 HDPE piping is connected to a butterfly valve through a concentric adapter, the HDPE pipe inside diameter is smaller than the valve bore and therefore smaller than the disc diameter, causing the disc perimeter to contact or approach the adapter bore wall through its rotation arc, preventing full opening or requiring bore enlargement that reintroduces the sediment accumulation condition at the valve face. The concave crown profile of the eccentric bore adapter 10 addresses this constraint by providing additional radial clearance at the crown of the bore through the full plate body thickness, with the continuously inward-curving crown surface accommodating the disc perimeter sweep path through its complete 90-degree rotation arc without requiring the full adapter bore to be enlarged to the valve bore diameter. This disc sweep clearance function is provided simultaneously with the invert continuity function of the eccentric bore offset and the air evacuation function of the concave crown geometry, all three functions arising from the same shaped bore profile. The valve stem, which passes through the butterfly valve body at the disc pivot point and may be oriented at the top of the valve body for post indicator valve configurations or at the side of the valve body for wafer and lug butterfly valve configurations, is accommodated by the crown clearance of the concave profile for top-mounted stem orientations and by the valve-bore-matched diameter at the adapter face for side-mounted stem orientations shown in FIG. 23(b). In certain butterfly valve installations, the interface adapter 10 is installed on both the upstream face and the downstream face of the butterfly valve body, a two-adapter assembly in which each adapter provides concave crown eccentric bore geometry at its respective valve face. This two-adapter configuration maintains invert continuity through the complete assembly comprising the upstream HDPE pipe, the upstream interface adapter, the butterfly valve body, the downstream interface adapter, and the downstream HDPE pipe, with disc sweep clearance and stem clearance provided at both valve faces simultaneously. The two adapters are oriented consistently such that the eccentric bore offset direction is the same at both valve faces shown in FIG. 32(b), maintaining continuous invert alignment through the valve body and eliminating sediment accumulation ledges at both the upstream and downstream valve faces. This two-adapter butterfly valve assembly is applicable to butterfly valve post indicator valve configurations, wafer butterfly valves, lug butterfly valves, and double-flanged butterfly valves in fire water, municipal water, industrial process, cooling water, mining, desalination, wastewater, and equivalent piping systems undergoing retrofit from steel piping to SDR 11 or other thick-wall HDPE piping. In the convex crown configuration, applicable to expanding transitions in which the adapter bore is larger than the upstream pipe bore, the bore surface on the crown side of the eccentric bore curves outward away from the bore centerline through the full plate body thickness. The continuously outward-curving crown surface guides expanding flow smoothly into the larger downstream bore, preventing flow separation and recirculation at the crown of the expansion face, and draws air from the crown of the larger downstream bore into the expanding flow stream through a low-pressure zone created at the expansion face. The convex crown configuration is applicable to connections to gate valves, flanged steel components, pump discharge flanges, pressure-reducing valve outlets, and flange set transitions where the downstream component bore exceeds the upstream pipe bore. Both the concave and convex crown configurations are selectable variants of the eccentric bore alignment 36, with the crown profile direction selected based on the bore transition direction and the connected component type, and both providing invert continuity, air evacuation, and component-specific clearance functions as simultaneous consequences of the eccentric bore geometry. In certain fire water distribution system applications, the interface adapter 10 configured with a concave crown eccentric bore serves as a dedicated flush branch adapter at a designed flush point in the system. In the predominant fire water installation geometry, a branch pipe runs from a side centerline takeoff on the main header, positioning the branch pipe centerline at the main header centerline elevation, to a flush valve and flush outlet. The concave crown eccentric bore adapter is positioned between the branch pipe and the flush valve with the eccentric bore oriented such that the bore bottom aligns with the flush branch pipe invert at the valve face, eliminating the upward bore step at the valve face that a conventional concentric adapter would create, so that sediment transported into the flush branch from the main header under flush flow conditions passes through the valve face without impediment. In certain embodiments, a full line size post indicator valve is installed between the flush branch pipe and the interface adapter 10, the post indicator valve providing slow controlled opening of the flush branch through its threaded rising-stem mechanism, limiting the pressure transient and thrust force generated at flush branch opening relative to a quarter-turn ball valve or other rapid-opening valve type, and providing above-grade visual indication of flush valve open and closed status. The interface adapter 10 is positioned downstream of the post indicator valve, connecting the post indicator valve outlet flange to the smaller flush outlet through the large-to-small reducing bore of the concave crown eccentric adapter. In certain embodiments, the flush branch assembly is positioned at the physical end of the main header pipe rather than as a side branch, such that the post indicator valve serves simultaneously as the header terminal isolation valve and as the flush flow control valve, and the interface adapter 10 serves simultaneously as the flush outlet size transition and as the header terminal connection point capable of accommodating future header extension by removing the flush discharge arrangement and extending the header pipe through the adapter connection point, with the post indicator valve retained as the isolation valve for the new extension segment. The end-of-header placement of the flush branch assembly provides a second and equally important function beyond routine sediment flushing: controlled air evacuation and fill rate management during return-to-service operations following maintenance isolation of a header section. When a header section has been isolated and depressurized for repair, the flush branch PIV at the header terminal end provides the primary controlled air release point for that section prior to refilling. The post indicator valve is opened slowly before the main isolation valve is cracked, providing a controlled flow path for air evacuation from the header crown through the flush branch and its outlet. The concave crown eccentric bore adapter actively draws residual crown air into the flow stream through the pressure differential created at the transition face, as described in the concave crown eccentric bore configuration above, operating during the fill sequence in the same manner as during post-flush pressurization. As air exits through the flush branch and water fills the header from below, the fill rate is controlled by the rate of PIV opening and maintained within the capacity of the system jockey pump, keeping header pressure above the automatic main pump start threshold throughout the fill sequence. When the header section is confirmed water-solid through the flush branch outlet, the flush branch PIV is closed and the main isolation valve is opened to restore full system pressure. This controlled fill sequence prevents the uncontrolled pressure event that occurs when main fire pumps start at full rated output into a partially filled header containing a compressed air column, eliminating the pressure spike mechanism that poses risk to deteriorated pipe sections during conventional return-to-service operations as described in the Background. The discharge geometry, flow dispersal, and outlet safety features of the complete flush branch assembly constitute a further aspect of the invention described in a related application claiming priority to the present application. In certain embodiments of the flush branch adapter configuration, the adapter plate body 12 includes a crown vent port positioned on the first face of the plate body at the crown position. The eccentric bore opening on the first face of the adapter plate is sized and positioned such that the uppermost extent of the bore opening is located approximately 2.5 to 3 inches below the top inside diameter of the connected upstream high-density polyethylene pipe bore, providing a crown shelf of solid plate body material between the top of the eccentric bore opening and the outer face of the plate body at the crown position. The crown vent port comprises a flanged or grooved connection boss machined into the crown shelf, configured to accept either a 2-inch nominal Class 150 bolted flange connection conforming to ASME B16.5 or a grooved mechanical coupling connection conforming to AWWA C606 or compatible Victaulic-style female mechanical joint connection, the flanged configuration providing a permanent bolted connection and the grooved configuration providing a removable coupling connection for maintenance access. The crown vent port is positioned such that the top inside diameter of the vent connection is coincident with the top inside diameter of the upstream high-density polyethylene pipe bore, providing a direct buoyancy-driven air escape path from the crown of the upstream pipe bore into the vent port without requiring downward displacement of accumulated crown air. The entry of the crown vent port into the crown shelf surface includes a radiused transition of approximately one-quarter inch to eliminate the re-entrant corner at the vent entry, reducing flow turbulence at the vent port opening and eliminating stress concentration at the entry. A vent isolation valve is installed on the crown vent port, configured to be opened prior to the controlled fill sequence and closed upon visual confirmation of water-solid conditions at the vent outlet, providing positive confirmation of complete air evacuation from the header section before the flush isolation valve is opened to restore system pressure. The nominal size and connection type of the crown vent port are selected based on the available crown shelf geometry of the specific adapter plate configuration, which varies with the adapter nominal size, eccentric bore offset magnitude, and first connection pattern bolt circle diameter. In all configurations the top inside diameter of the vent port is positioned coincident with the top inside diameter of the connected upstream pipe bore regardless of the vent port nominal size or connection type, the coincident elevation being the governing dimensional requirement that determines the vent port centerline elevation on the crown shelf. A one-quarter inch radiused entry transition is provided at the vent port entry into the crown shelf surface in all configurations. The vent port nominal size and connection type are selected based on the available crown shelf geometry of the specific adapter configuration, which varies with nominal adapter size, eccentric bore offset magnitude, and first connection pattern bolt circle diameter, with the governing criterion being hydraulic adequacy of the flush valve and geometric adequacy of the crown shelf to accommodate the vent port connection without encroaching on the first connection pattern bolt circle. The bolt hole orientation of the crown vent port flanged connection is fixed at the time of manufacture in the two-hole standard orientation, with two bolt holes of the vent flange straddling the vertical centerline of the vent port such that no bolt hole of the vent flange falls at the 12 o'clock or 6 o'clock position of the vent port face. The vent flange bolt hole orientation is further set to avoid angular coincidence with the bolt holes of the first connection pattern of the adapter plate body in the crown zone, the angular relationship between the vent flange bolt holes and the nearest bolt hole of the first connection pattern being established at the time of adapter plate machining based on the specific first connection pattern bolt circle geometry and bolt count of the adapter configuration. In most configurations the nearest bolt hole of the first connection pattern to the 12 o'clock position is displaced approximately one bolt spacing from vertical due to the two-hole standard orientation of the first connection pattern, and the vent flange orientation is set to avoid this bolt hole position, the resulting angular offset between the vent flange bolt holes and the nearest adapter plate bolt hole being not less than one-quarter of the bolt spacing of the first connection pattern. The crown vent port boss and the external lug 60 are both positioned at the crown of the adapter plate body, the lug 60 on the outer diameter of the plate body and the vent port boss on the first face of the plate body in the crown shelf region, the two features coexisting without interference and together identifying the crown of the adapter plate as the installation reference zone during field alignment. The crown shelf geometry that accommodates the crown vent port is a direct consequence of the eccentric bore offset—the bore centerline is offset downward from the plate body centerline to maintain invert continuity, and the resulting solid material at the crown provides the structural platform for the vent port without requiring additional plate thickness or any modification to the bore geometry below the crown shelf elevation. The interface adapter 10 is configured for connection to ductile iron piping systems and mechanical joint interfaces, which represent a primary legacy infrastructure type in municipal fire water and industrial water distribution systems. Ductile iron pipe conforming to AWWA C151 has an outside diameter fixed by standard and a wall thickness that varies by pressure class, with a standard cement-mortar interior lining conforming to AWWA C104 at a nominal lining thickness of approximately 3/32 inch per side for pipe in the 16-inch to 24-inch range. The finished inside diameter of cement-mortar-lined ductile iron pipe is therefore larger than the inside diameter of cement-mortar-lined steel pipe of equivalent nominal size, because the DI lining is substantially thinner than the C205 lining applied to steel pipe. Typical finished inside diameters of cement-mortar-lined ductile iron pipe in fire water service sizes include: 12-inch nominal DI, approximately 11.5 to 11.9 inches; 16-inch nominal DI, approximately 14.9 to 15.3 inches; 20-inch nominal DI, approximately 18.6 to 19.0 inches; and 24-inch nominal DI, approximately 22.2 to 22.8 inches. These ductile iron inside diameters are consistently larger than the inside diameter of SDR 11 HDPE pipe of the same nominal size, so the most common retrofit pairing is one nominal size larger HDPE to one nominal size smaller DI system: 16-inch DI systems are typically retrofitted with 20-inch SDR 11 HDPE pipe, 20-inch DI systems with 24-inch SDR 11 HDPE pipe, and 12-inch DI systems with 16-inch SDR 11 HDPE pipe. In these pairings, the inside diameter of the HDPE pipe is similar to or slightly larger than the inside diameter of the ductile iron pipe, and the interface adapter 10 provides a bore-matched or near-bore-matched transition between the two systems. The dominant field connection method in ductile iron piping systems is the mechanical joint (MJ)—a gland-and-gasket connection comprising a spigot end, a rubber gasket, and a gland tightened by bolts drawing the gland against the gasket seat—used at fittings, valves, hydrant branches, and transitions. The interface adapter 10 is configured in certain embodiments with a mechanical joint outlet on the steel-side face of the plate body, comprising a bell or spigot MJ configuration conforming to AWWA C111 (ANSI 21.11), providing direct connection to the ductile iron mechanical joint system without intermediate spool pieces or custom fabrications. This MJ adapter configuration provides a direct connection to the ductile iron mechanical joint system for the retrofit of HDPE pipe into legacy ductile iron distribution systems, because MJ connections are ubiquitous in buried ductile iron infrastructure and there is no standardized single-component adapter for connecting fused SDR 11 HDPE pipe directly to MJ ductile iron piping and fittings at the bore differentials characteristic of the retrofit pairing described herein. In addition to the MJ connection embodiments, the interface adapter 10 is configured for direct connection to flanged ductile iron system components—including flanged ductile iron gate valves, flanged ductile iron butterfly valves, flanged ductile iron check valves, flanged ductile iron tees and elbows, and flanged ductile iron fire hydrant branches conforming to AWWA C110, AWWA C153, or ASME B16.1 Class 125—on the second face of the plate body. Flanged ductile iron components are flat-faced per standard practice and require full-face sealing gaskets to prevent lever arm loading at the connection, as described in the gasket locating groove embodiments herein. The interface adapter 10 second face phonographic finish, full-face gasket locating groove 86, and flat-face compatible connection pattern geometry are configured for direct bolted connection to flanged ductile iron components without intermediate adapters, spacers, or raised-face-to-flat-face conversion hardware. The metallic fluid system component to which the interface adapter 10 connects therefore encompasses carbon steel, stainless steel, ductile iron, and cast iron flanged and mechanical joint components conforming to AWWA C207, AWWA C110, AWWA C153, ASME B16.1, ASME B16.5, DIN EN 1092, JIS B2220, and equivalent standards, across the full range of pipe sizes, pressure classes, and end connection types addressed by those standards. The thrust load characteristics of ductile iron mechanical joint systems are a significant design consideration for the interface adapter 10 at DI-to-HDPE transition points. Standard ductile iron push-on and mechanical joint connections are not inherently restrained—internal pressure thrust forces at elbows, tees, reducers, dead ends, and closed valves are resisted by concrete thrust blocks bearing against undisturbed soil, or by proprietary restrained joint systems that transfer thrust load into the surrounding soil envelope over a restrained length of pipe. By contrast, fused HDPE pipe is a continuous, self-restrained system in which axial thrust is distributed along the fused run and into the surrounding soil through pipe-soil interaction over the full run length. The interface adapter 10 at a DI-to-HDPE transition point is therefore the structural interface between two fundamentally different load philosophies: a segmented thrust-block-dependent system on the DI side and a continuous self-restrained system on the HDPE side. In certain configurations—where a concrete thrust block or an externally anchored fitting on the DI side resists the global axial thrust load and the adapter functions primarily as a pressure boundary and bore-transition element—the adapter is configured as a flow-transition adapter in which the primary structural design requirement is bolt preload, plate body integrity, and gasket seating. In other configurations —where the adapter sits in the axial thrust load path between a restrained DI joint system and a fused HDPE run, with no local thrust block taking the global load—the adapter functions as a structural transfer adapter in which the bolted joint, the plate body section, and the HDPE-side connection pattern must be designed to transmit the full axial thrust. At 125 psi operating pressure, representative pressure-thrust loads at DI-to-HDPE transition points include approximately 21,000 pounds at a 16-inch bore dead end or branch, approximately 34,000 pounds at a 20-inch bore dead end, and approximately 50,000 pounds at a 24-inch bore dead end, calculated from internal pressure acting on the effective bore area. These are pressure-thrust loads only and do not include surge allowance, safety factors, thermal effects, or soil loads. The interface adapter 10 is designed with a unitary plate body, two independent bolted connection patterns with stress field non-overlap, and minimum plate thickness governed by the larger fastener diameter criterion described herein, providing adequate structural margin for both flow-transition and structural-transfer configurations across the bore and pressure class range described in the claims. The structural attachment lugs 98, formed integrally with the plate body 12 at the lateral side positions, provide attachment and securement to reduce thrust and expansion movement of system components and to manage axial installation loads during thermoplastic pipe pull-up operations. The structural attachment lugs 98 may additionally serve as attachment points for support brackets to a concrete pedestal or thrust block. In certain embodiments, threaded spreader rods engaged through the structural attachment lugs 98 facilitate valve extraction by generating controlled separation force between the adapter plate body and the adjacent flange without flange spreader tools or pry bars at the joint face. In installations where the thermal expansion differential between the HDPE piping and the adjacent metallic components produces compressive or tensile loads at the valve connection sufficient to impair valve removal, the spreader rod arrangement provides controlled mechanical advantage for valve extraction and gasket installation. The interface adapter 10 is particularly suited for retrofit applications involving horizontal directional drilling (HDD) and other trenchless installation methods, which are increasingly used for large-diameter fire water and municipal water main replacement under roads, rail crossings, developed areas, and other locations where open-cut construction is impractical or prohibited. In HDD retrofit installations, long continuous fused HDPE runs are pulled into place through a drilled bore, with the fused HDPE string entering and exiting the drilled path at access pits located at discrete surface points. The trenchless HDPE run is the hydraulically and mechanically simple portion of the installation—fused joints are uniform and continuous, the pipe is flexible and self-restrained, and the interior bore is consistent. The technically challenging portion of HDD retrofits is the limited number of critical legacy interfaces at each end of the drilled run and at intermediate access points: connections back into the existing steel, ductile iron, or cement-mortar-lined steel piping system; connections to existing valves at each phase boundary; branch connections to hydrants, monitors, and other appurtenances; and connections to pump-house and above-grade piping at system termination points. Each of these interface points presents the material transition, bore mismatch, and structural connection challenges addressed by the interface adapter 10. In HDD retrofit scenarios each interface point requires excavation, exposure of the legacy component, and custom connection work, making the quality of the connection at each interface point especially significant to overall system performance. The interface adapter 10 provides a standardized single-component solution for these interface points, reducing custom field fabrication, improving bore continuity at the critical transition locations, and enabling the connection of fused HDPE runs to the legacy infrastructure at each HDD entry, exit, and branch point. The interface adapter 10, in its inline transition, valve interface, branch adapter, and flush branch configurations, addresses the complete set of interface types encountered in a typical HDD fire water retrofit project. High-density polyethylene piping is predominantly used in underground service in fire water and industrial water systems; transitions to above-grade metallic piping systems are made at or near grade in accordance with applicable fire protection standards and insurance requirements, including FM Global standards that generally restrict thermoplastic piping in exposed above-grade service due to fire exposure and thermal expansion considerations. The interface adapter 10 is configured for connection at the underground-to-above-grade transition point, where the buried HDPE run terminates and the above-grade metallic piping system begins. At this transition location, the interface adapter 10 provides the bore-matched bolted flange connection between the HDPE run and the first above-grade metallic component—typically a gate valve, post indicator valve, or riser spool—at or slightly below finished grade. In certain embodiments, the above-grade metallic component connected to the interface adapter 10 at the grade transition comprises a metallic transition spool providing a short metallic pipe section at the underground-to-above-grade interface. The transition spool may comprise carbon steel pipe with a high-grade industrial protective coating system, or stainless steel pipe providing material-intrinsic corrosion resistance without dependence on coating integrity at the grade transition zone. The grade transition zone—the region extending from approximately 18 to 24 inches below finished grade to approximately 12 to 24 inches above finished grade—is among the most corrosion-aggressive locations in a buried piping system, subject to wet-dry cycling, oxygen availability, soil-to-atmosphere transition, and mechanical disturbance from maintenance and surface activity. Carbon steel pipe at this location relies on the integrity of the applied protective coating system for corrosion resistance; coating damage, holidays, or disbondment at the grade transition allow corrosion initiation that may not be detectable without excavation. Stainless steel pipe at this location provides corrosion resistance through the inherent properties of the alloy, eliminating coating integrity as a failure mode at the grade transition zone. Stainless steel of Type 304L or Type 316L is suitable for most fire water and industrial water service environments, with Type 316L preferred for coastal, marine, or chemically aggressive environments. The transition spool may comprise Schedule 10S or Schedule 40S stainless steel pipe, with Schedule 40S preferred for structural margin at the transition node where flange loading, support loads, and handling forces are concentrated. The connection between a stainless steel transition spool and adjacent carbon steel components—including the above-grade steel piping system downstream of the transition spool —may include electrical isolation hardware comprising insulating gaskets, insulating sleeve bushings on the fasteners, and insulating washers under fastener heads and nuts, configured to break the electrical continuity between the dissimilar metals and mitigate galvanic corrosion at the stainless-to-carbon-steel interface in buried or splash-zone service. The transition spool is positioned with its underground end connected to the interface adapter 10 at approximately 18 to 24 inches below finished grade, keeping the HDPE-to-metal transition in the fully buried zone where the HDPE material is strongest and the transition point is protected from above-grade mechanical and thermal exposure. The above-grade portion of the transition spool connects to the first above-grade valve or flanged component through a flanged connection, which may include a flange-by-groove configuration where the above-grade piping system uses grooved mechanical coupling connections. In certain embodiments the transition spool further connects to a grooved mechanical coupling system through a flange-by-groove valve or flange-by-groove adapter, enabling connection of the fused HDPE underground system to the grooved above-grade piping that is prevalent in pump houses, equipment pads, and industrial fire water systems. The combination of the interface adapter 10 at the buried HDPE-to-metal transition, the stainless or coated steel transition spool through the grade zone, and the flanged or grooved connection to the above-grade system constitutes a complete underground-to-above-grade transition assembly for HDPE-based fire water and industrial water systems, with each element addressed to the specific corrosion, structural, and hydraulic requirements of its zone in the system.

### V. Advantages Over Conventional Adapters

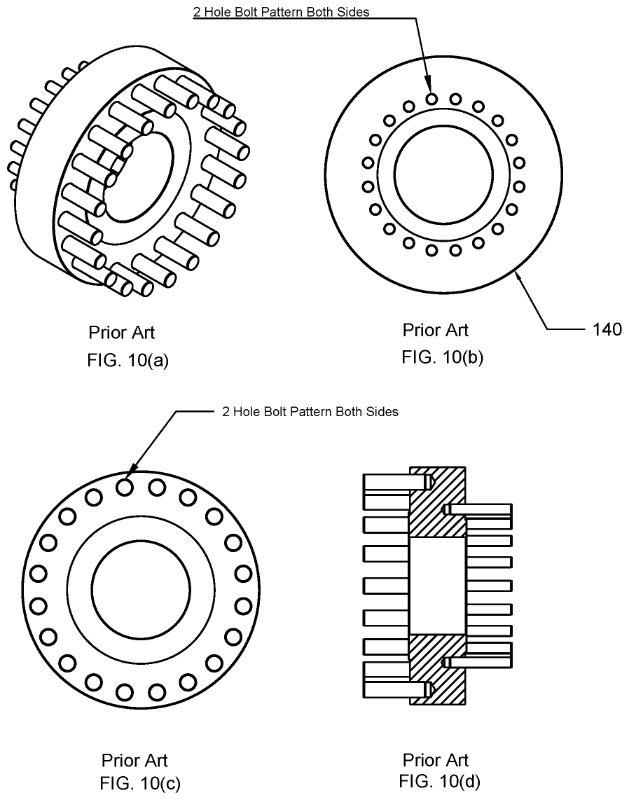

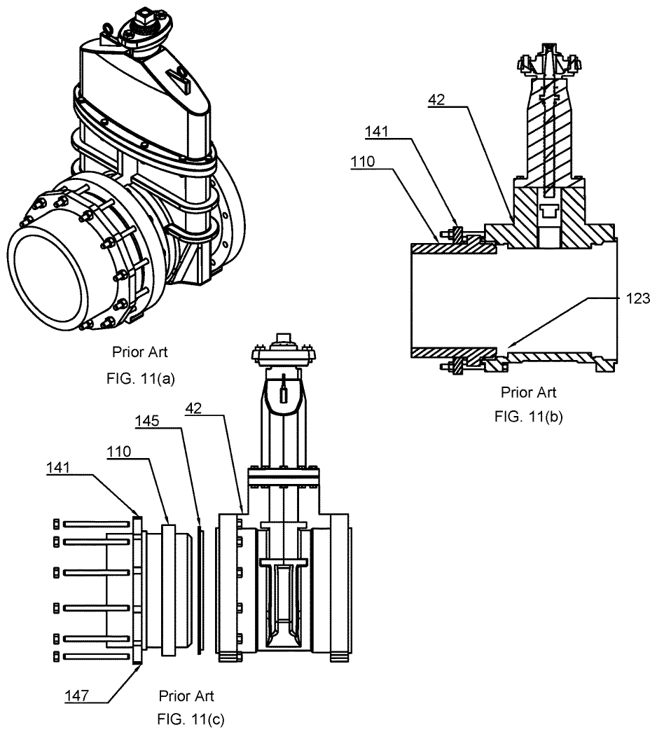

Referring to FIG. 10(a) through 10(d), conventional interface adapters 110 commonly include overlapping fastener patterns or closely spaced fastener openings 20 that result in overlapping stress fields within the adapter body. This type of adapter is limited to a two hole orientation standard in most cases to meet real world piping installations. In many configurations, such arrangements reduce or eliminate structural ligament regions, increasing localized stress concentrations under bolt preload. Conventional adapters also commonly include abrupt bore transitions that produce turbulent flow regions and associated erosion zones, particularly in systems involving velocity changes, particulate matter, multiphase flow, or directional flow changes. In contrast, the interface adapter 10 of the present invention purposefully preserves structural ligament regions 24 and independent structural load paths 28 while incorporating flow-conditioning geometry that promotes a smooth, unobstructed flow path through the interface. FIG. 10(a) through 10(d) show the overlapping bolt patterns and stress fields characteristic of conventional adapters. FIG. 2(b) and 9(a) show the non-overlapping stress fields 29 and preserved structural ligament regions 24 of the present invention. The combination of structural separation and hydraulic transition features may improve both mechanical load distribution and fluid flow behavior relative to conventional adapter configurations.

### VI. Transient Load Resistance

In certain fluid transport systems, transient pressure events may occur during system start-up, shutdown, pump trip, pump start, rapid valve actuation, surge events, or other upset conditions. Such events may generate pressure surges that impose axial and radial forces on connection interfaces within the piping system. The interface adapter 10, including the preservation of structural ligament regions 24 and independent structural load paths 28 within the plate body 12 as illustrated in FIG. 2(c) and FIG. 3, may provide improved resistance to such transient loading conditions relative to conventional adapter configurations. The ability of the plate body 12 to transmit loads through continuous material regions may reduce susceptibility to localized stress concentrations, separation forces, crack initiation, permanent deformation, or structural discontinuities during transient events.

### VII. Flow Development Length

In certain embodiments, the interface adapter 10 may include an extended adapter body providing a flow development length upstream or downstream of a valve, elbow, reducer, tee, meter, nozzle, fitting, or other process component. A standard-length adapter body provides a transition within the plate body thickness. An extended adapter body provides additional flow development length beyond the plate body thickness. A flow development length of at least five times the bore diameter may be provided upstream of a flow measurement device to improve measurement accuracy, while a flow development length of at least two times the bore diameter may be provided downstream of a valve to reduce velocity-induced erosion at the first downstream directional change.

### VIII. Downstream Flow Effects and Component Interfaces

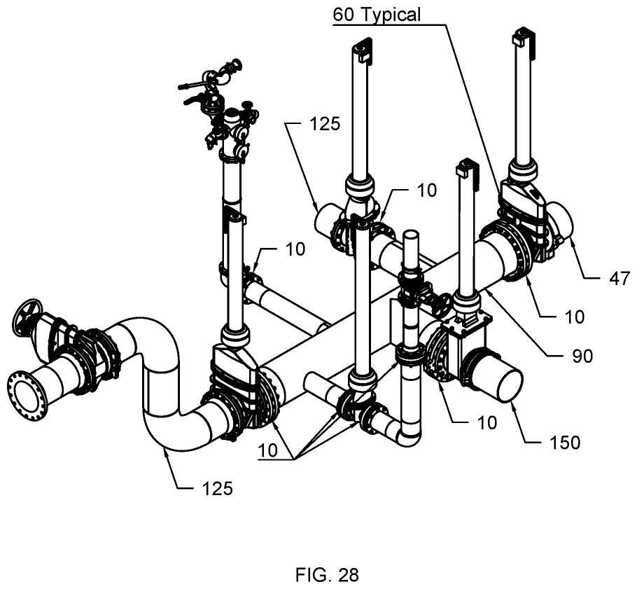

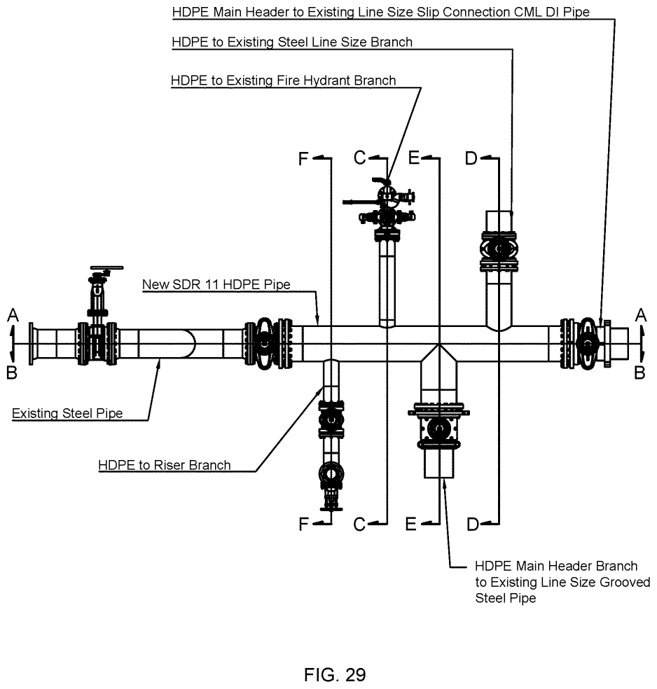

Referring to FIG. 5(a) through 5(c), the interface adapter 10 may be positioned adjacent to various downstream components. FIG. 5(a) illustrates a straight bore valve interface connection showing the adapter installed adjacent to a butterfly valve, globe valve, throttling valve, gate valve, check valve, or other flow-control component. In certain embodiments, the central bore 14 is sized to match the internal bore diameter of the valve 42 such that no annular step or recess exists at the upstream face of the valve body. This bore-matched configuration eliminates the sediment accumulation zone that forms when an adapter bore diameter exceeds the valve internal diameter, preventing the buildup of particulate matter, biological growth, or corrosion products that would otherwise accumulate in the annular recess upstream of the valve seat. In fire water systems, elimination of this sediment trap is particularly important because accumulated sediment may impair valve actuation under emergency demand conditions or accelerate internal valve wear. The bore geometry 14 may also condition the velocity profile entering the valve and provide clearance for valve internal components such as a butterfly disc. The eccentric bore configuration of FIG. 7(e) through 7(h) in some embodiments could be used for erosion mitigation at a downstream directional change by modifying the flow impact angle entering an elbow or directional fitting, reducing the high-velocity erosion region at the bend outer wall. FIG. 23(a) through 23(c) illustrates the adapter cross-section showing internal bore geometry providing clearance for valve internal components such as a butterfly disc or gate valve wedge. In complete fire water system retrofit applications, the interface adapter 10 is configured for installation at each of the following connection types within the fire water distribution system, as illustrated in FIGS. 28 and 29: gate valve connections at isolation and sectional valves; butterfly valve connections at flow control and sectional valves; post indicator valve connections at exterior above-grade isolation valves; fire hydrant branch connections at lateral takeoffs from the HDPE main; and check valve, swing check, and detector check assembly connections at pump discharge, branch isolation, and metered fire water service entry points. In industrial process piping applications, the interface adapter 10 is additionally configured for connection to process equipment including pumps, compressors, heat exchangers, pressure vessels, strainers, flow meters, and other flanged process components, the bore-matched central bore and dual-pattern plate body geometry applying equally to these process equipment applications as to water distribution valve connections. At each connection type, the interface adapter 10 maintains the original valve, fitting, or process equipment component at its installed location and nominal size while connecting the replacement HDPE or thermoplastic piping with a fully restrained bolted joint. The cathodic protection bonding conductor attached at lug 60 at each adapter bridges the non-conducting thermoplastic pipe segment to the next downstream adapter, maintaining cathodic protection grid continuity across all metallic components remaining in the converted system. In certain embodiments, the steel-side face of the interface adapter 10 is configured with a mechanical joint socket conforming to AWWA C111 or a grooved pipe end conforming to AWWA C606 rather than a flanged connection, providing direct connection to mechanical joint or grooved piping systems without intermediate spool pieces; these mechanical joint end and grooved end embodiments are further described in related applications claiming priority to the present application. The bore profile of the interface adapter 10 may be specifically configured to reduce cavitation at the inlet of downstream control valves, throttling valves, and pressure-reducing valves. Cavitation at valve inlets arises when a non-uniform or high-velocity flow profile entering the valve creates localized low-pressure zones at the valve seat or throttling element, causing vapor bubble formation and subsequent collapse that produces erosion, noise, vibration, and progressive mechanical damage to valve internals. A flow-conditioning bore profile configured to deliver a uniform, fully-developed velocity distribution to the valve inlet reduces the intensity of the local pressure minima that initiate cavitation, reducing or eliminating cavitation-driven valve damage without requiring changes to valve size, valve trim, or system operating pressure. The erosion of valve seats, discs, and bodies by cavitation and by high-velocity flow impingement represents a significant maintenance cost in systems where flow velocity and pressure differentials are high. The interface adapter 10 addresses this erosion mechanism at the source—by conditioning the velocity profile before it enters the valve—rather than by specifying more expensive erosion-resistant valve materials or more frequent valve replacement intervals. In throttling service and in pressure-reducing valve applications, a tapered or radiused bore inlet 30 providing a smooth velocity transition from the HDPE pipe interior to the valve internal bore may substantially reduce cavitation inception velocity, extending valve service life and reducing system maintenance cost. In certain embodiments, the flow-conditioning bore profile is specifically configured to address known erosion patterns observed in the installed system. For example, in systems where butterfly valves or gate valves are operated in partially open positions for extended periods, high-velocity flow is directed asymmetrically against the downstream pipe wall and valve body, producing characteristic fishmouth-shaped erosion profiles on the pipe interior and valve body surfaces at the impingement zone. The bore profile of the interface adapter 10 may be configured based on the specific valve type, valve position, and system flow velocity to reorient and redistribute the approaching flow vector, reducing the intensity of impingement at the known high-wear locations. This wear-pattern-based bore optimization is particularly valuable in pump discharge service and in partially throttled valve service where a small number of high-erosion locations concentrate the majority of system wear and maintenance cost. A significant system-level advantage of the interface adapter 10 is that it permits complete conversion of a piping system from steel or cement mortar-lined steel pipe to thick-wall HDPE pipe without requiring upsizing or replacement of any connected metallic component—including valves, pumps, strainers, pressure gauges, flow meters, instrument taps, check valves, control valves, pressure-reducing valves, and all other instrumentation and process equipment connected to the piping system. Because the larger outside diameter of HDPE pressure pipe combined with wall thickness governed by the pipe's SDR rating produces an inside diameter smaller than the nominal bore of steel pipe of the same nominal size than the equivalent nominal-size steel pipe, conventional connection methods require either a reduction in bore diameter at the transition—creating a flow constriction—or upsizing of the connected valve and equipment to a larger nominal size. The interface adapter 10 eliminates this constraint by providing a transition bore 14 that accommodates the diameter difference within the adapter body, allowing the HDPE pipe to connect directly to existing standard-size valves, pumps, pressure gauges, flow meters, and instruments at their existing locations without modification, upsizing, or reinstallation. This characteristic allows facility operators to convert piping systems segment by segment to HDPE—the preferred material for long-service buried piping—while retaining the full installed base of metallic valves, instrumentation, and process equipment at their original sizes and locations, without requiring upsizing of any connected component.

### IX. Materials, Coatings, and Linings

The plate body 12 may be manufactured from carbon steel, stainless steel, duplex stainless steel, nickel-based alloys, corrosion-resistant alloys, or other materials suitable for service conditions. In certain embodiments, the plate body 12 thickness and structural ligament dimensions are selected to provide a working pressure capacity at the adapter connection that equals or exceeds the rated working pressure of the connected HDPE piping, which for SDR 11 PE4710 pipe is approximately 160 psi at 73° F. per ASTM F714 and AWWA C906. The structural ligament geometry described herein—minimum material width of at least 1.5 times the fastener opening diameter plus 0.5 inches—provides the material continuity at the bolt holes necessary to carry bolt preload forces at this pressure class without yielding, ensuring the adapter connection is not the structural weak link in the assembled piping system. In certain embodiments, the plate body 12 includes a corrosion-resistant coating 48 such as a fusion bonded epoxy, a liquid epoxy coating, a polyurethane coating, a ceramic coating, a metallic coating, or another protective surface treatment, with a dry film thickness of between approximately 250 and 1000 micrometers selected based on service environment. In certain embodiments, the central bore 14 may include a fluoropolymer lining such as PTFE, PFA, FEP, or ETFE, or another chemically resistant lining applied to the bore interior surface. In certain embodiments, the fastener set 46 includes fasteners provided with a fluoropolymer-based coating, such as a Xylan coating, a PTFE-based dry film lubricant coating, or a similar corrosion-resistant and lubricating fastener treatment, applied to the fastener shank, threads, and bearing surfaces. Such coatings reduce galling during installation, provide corrosion protection on the fastener exterior, and facilitate achievement of consistent bolt preload at specified torque values. In certain embodiments, a chemical-resistant bore surface may be provided to protect the structural material of the central bore 14 in aggressive fluid service. The material selection, coating system, and dimensional design of the interface adapter 10 are intended to support an installed service life of fifty years or more, consistent with the corrosion resistance and design service life of the connected SDR 11 HDPE piping and with the service life requirements of fire water distribution, municipal water, and industrial process piping infrastructure.

### X. Electrical Isolation and Cathodic Protection

Referring to FIG. 4(a) and 9(a), in certain embodiments the interface adapter 10 includes a multifunctional external lug 60 positioned on the plate body exterior. The lug 60 is configured to serve simultaneously as: (1) a cathodic protection bonding conductor attachment point, providing an attachment location for a bonding conductor that bridges the non-conducting HDPE pipe segment between two adapter installations to maintain cathodic protection circuit continuity to downstream metallic system components; (2) a lifting attachment point rated to support the dead weight of the assembled adapter during installation handling in excavations and at elevated locations; and (3) a rotational orientation reference positioned at a defined angular relationship to the eccentric bore offset direction. In certain embodiments where the central bore 14 includes an eccentric bore alignment 36, the lug 60 is positioned at the crown of the plate body so that an installer who places the lug at the top of the installed adapter simultaneously positions the eccentric bore offset correctly for invert continuity without separate measurement or alignment equipment at the installation point. In certain embodiments where cathodic protection of connected steel components is desired, the interface adapter 10 includes the multifunctional lug 60 that permits attachment of a CP bonding conductor connecting the metallic second fluid system component to the metallic component at the opposite end of the thermoplastic pipe segment. The cathodic protection bonding conductor attached at lug 60 extends alongside the HDPE pipe segment to the corresponding lug 60 on the adapter at the opposite end, bridging each non-conducting pipe segment to maintain cathodic protection circuit continuity across the entire converted system without redesigning or interrupting the existing cathodic protection system. In embodiments where the central bore 14 includes an eccentric bore alignment 36 selected to maintain invert continuity, top-of-pipe continuity, or another selected geometric relationship between the connected components, the cathodic protection lug 60 is positioned on the plate body 12 at a defined angular relationship to the eccentric bore offset direction. This positioning causes the lug 60 to serve as a visual and physical orientation reference during installation—the installer orients the adapter by positioning the lug at the known reference angle corresponding to the desired bore offset direction before tightening the fastener set, eliminating the risk of installing the adapter in an incorrect rotational orientation that would defeat the invert alignment objective. The cathodic protection lug 60 therefore serves three distinct functions within a single feature: electrical connection point for cathodic protection or grounding systems, lifting attachment for installation handling, and rotational orientation reference for eccentric bore positioning. Conventional compression-type and plate-type HDPE-to-steel transition hardware does not provide any of these three functions in an integrated feature, and no prior art adapter known to the inventors integrates all three functions within a single external attachment point on a unitary adapter plate body. In piping systems undergoing phased conversion from steel or cement mortar-lined steel pipe to HDPE, the cathodic protection lug 60 provides a critical system-level function beyond the individual adapter: it maintains continuity of the existing cathodic protection grid at each HDPE-to-steel transition point, allowing the operator to preserve the electrical integrity and coverage of the cathodic protection system across the converted segments. As HDPE piping segments—which do not require and cannot conduct cathodic protection current—are introduced into a previously all-metallic system, the cathodic protection lug 60 at each interface adapter 10 provides the attachment point at which the cathodic protection system bonding conductor is connected to the metallic components on the steel side of the transition, maintaining the cathodic protection network coverage of all metallic valves, fittings, and pipe segments that remain in the system regardless of how many HDPE segments have been introduced. This capability allows facility operators to convert piping systems to HDPE incrementally without interrupting, abandoning, or redesigning the existing cathodic protection system—a significant operational and cost advantage in systems where cathodic protection monitoring and regulatory compliance requirements apply. In certain staged conversion applications, the interface adapter 10 serves as an end-of-line termination component where the second connection pattern mates with a steel blind flange or temporary test connection at the advancing end of a new HDPE piping segment, providing a fully restrained, pressure-testable termination during staged installation before the final connection to the downstream steel system component is completed. This end-of-line configuration allows each completed HDPE segment to be hydrostatically tested to full system working pressure at each stage of a phased conversion, with the interface adapter 10 providing the test head connection at the open end of the new segment without requiring temporary flanges or compression test caps that may not provide restrained connections suitable for high-pressure testing.

### XI. Retrofit Installation and Standards Compatibility

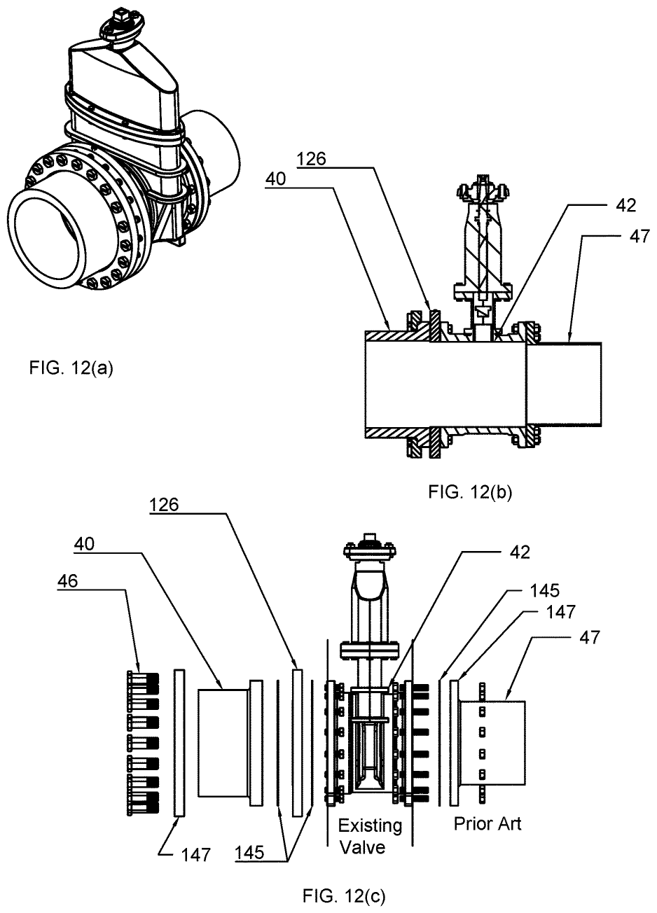

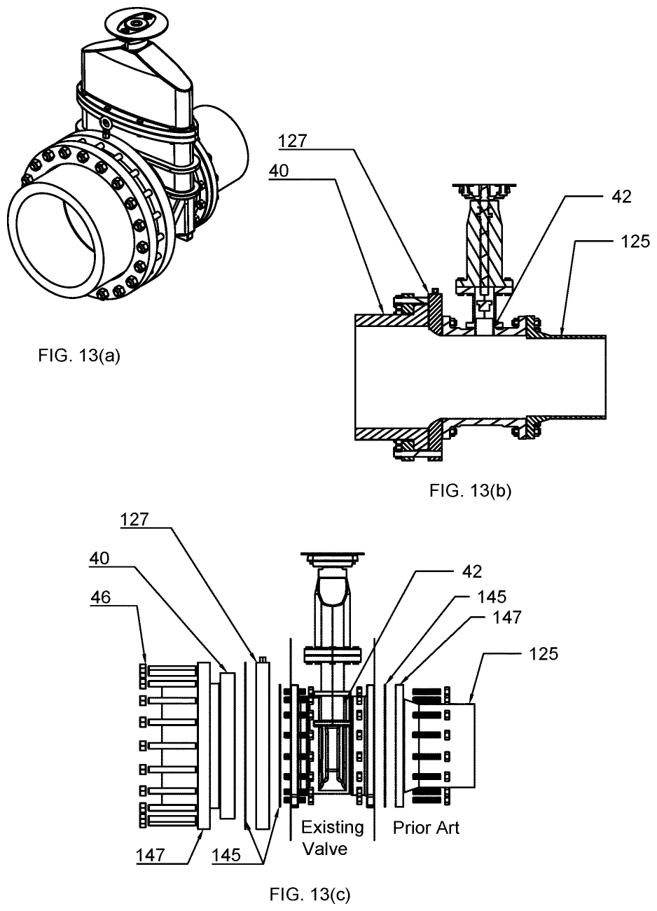

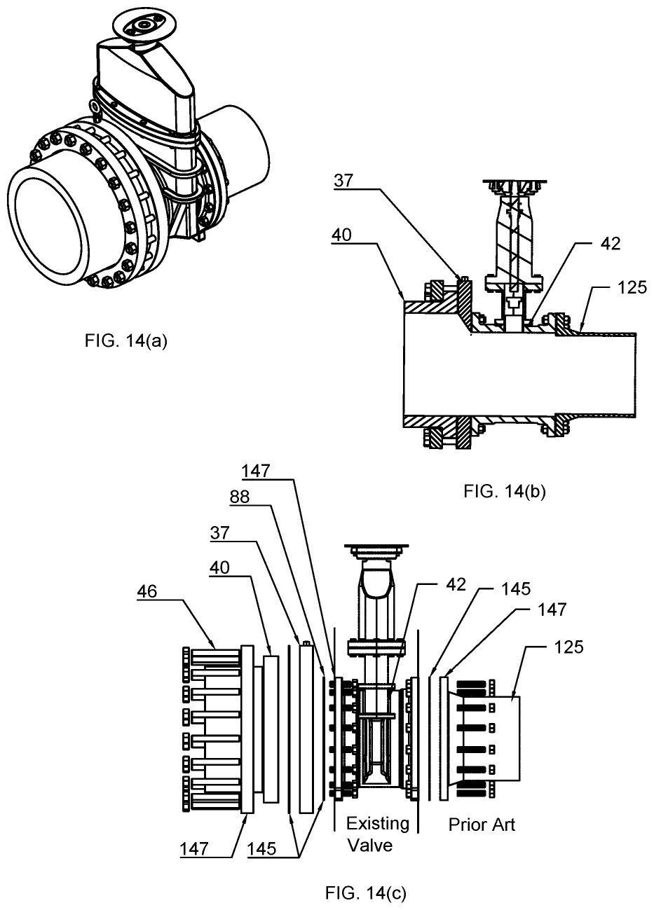

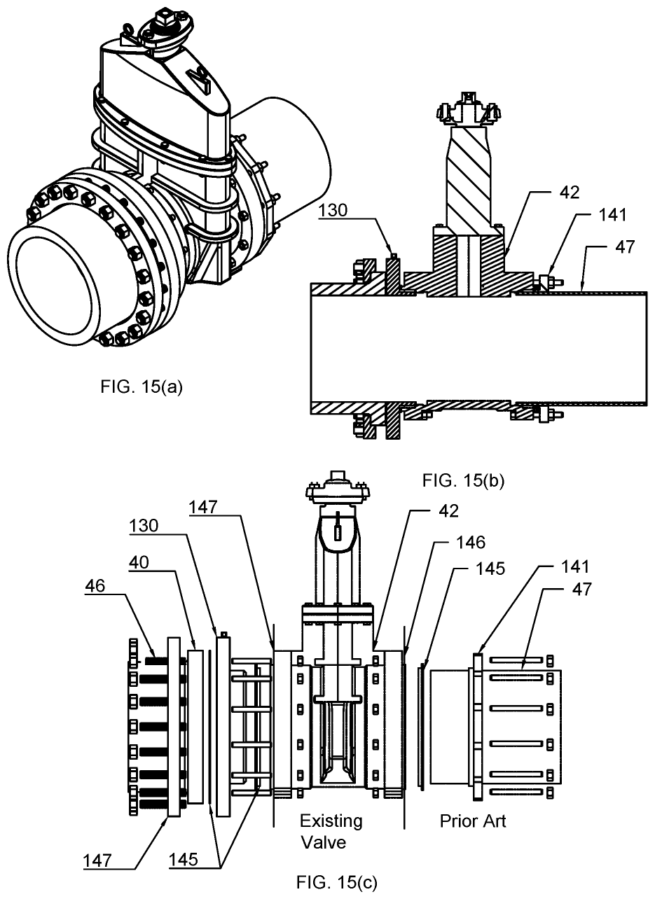

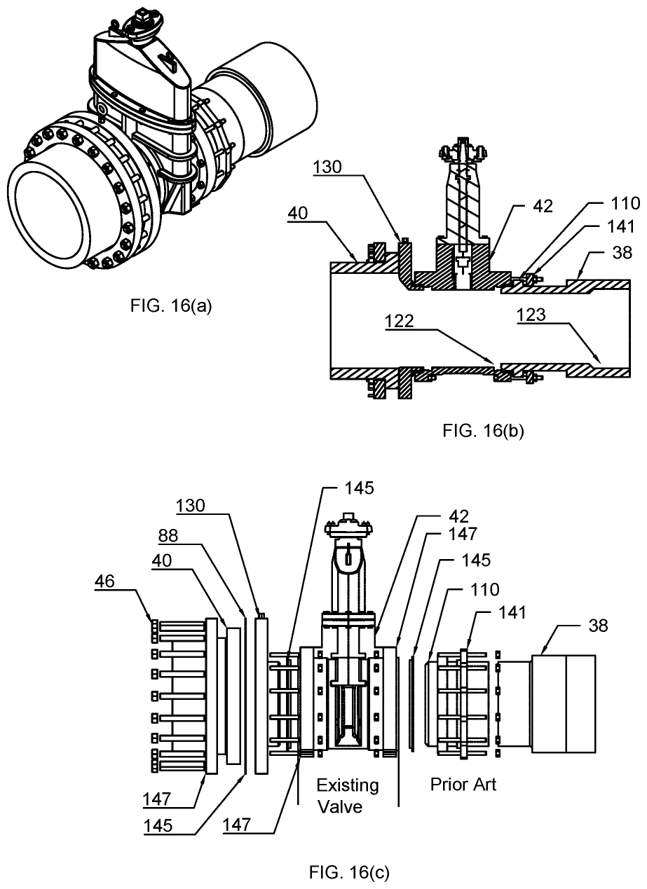

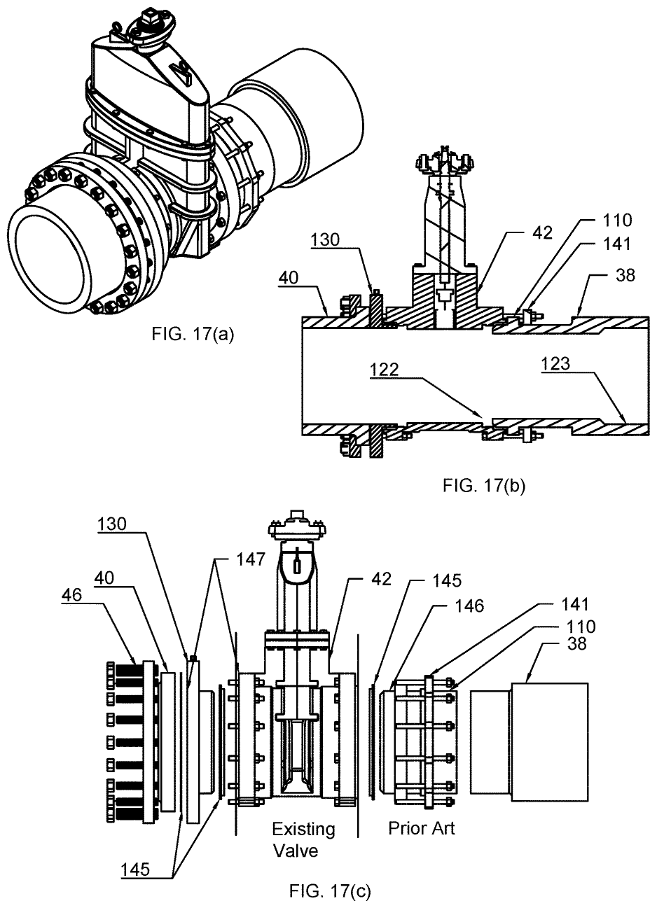

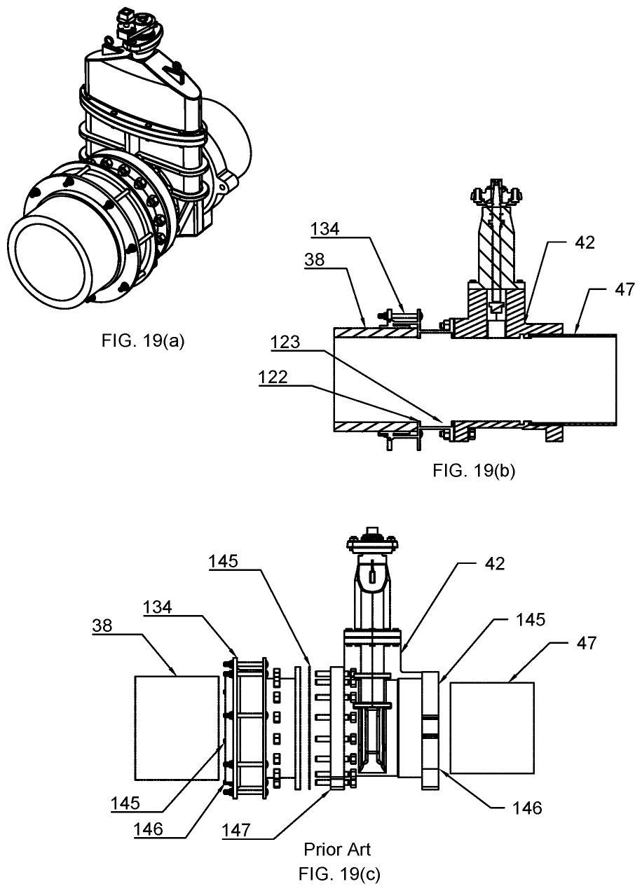

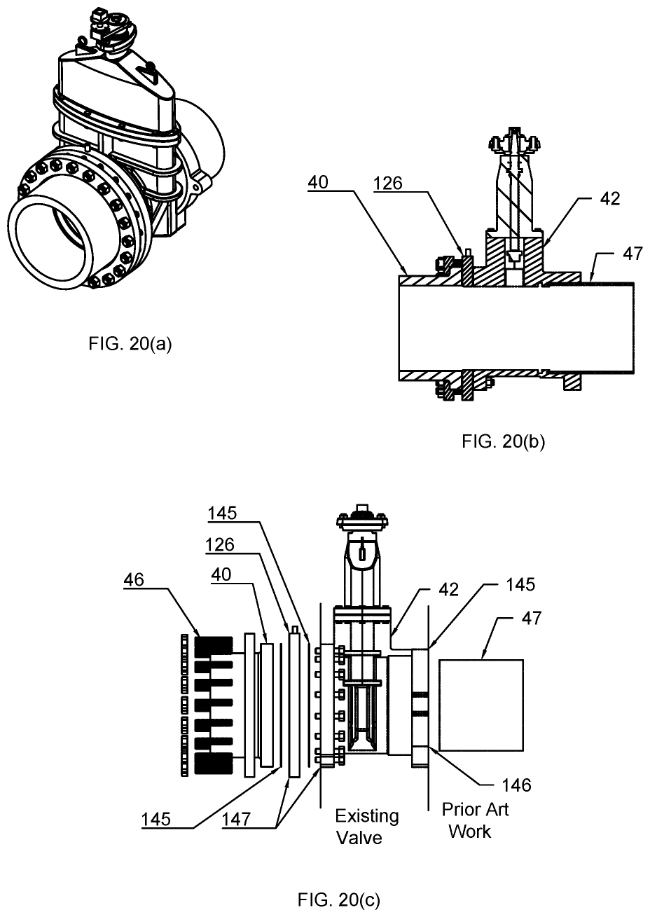

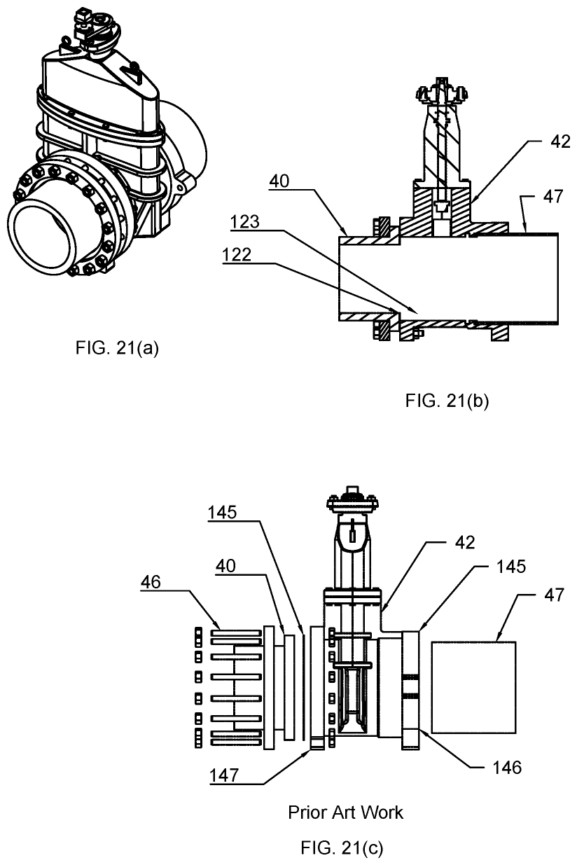

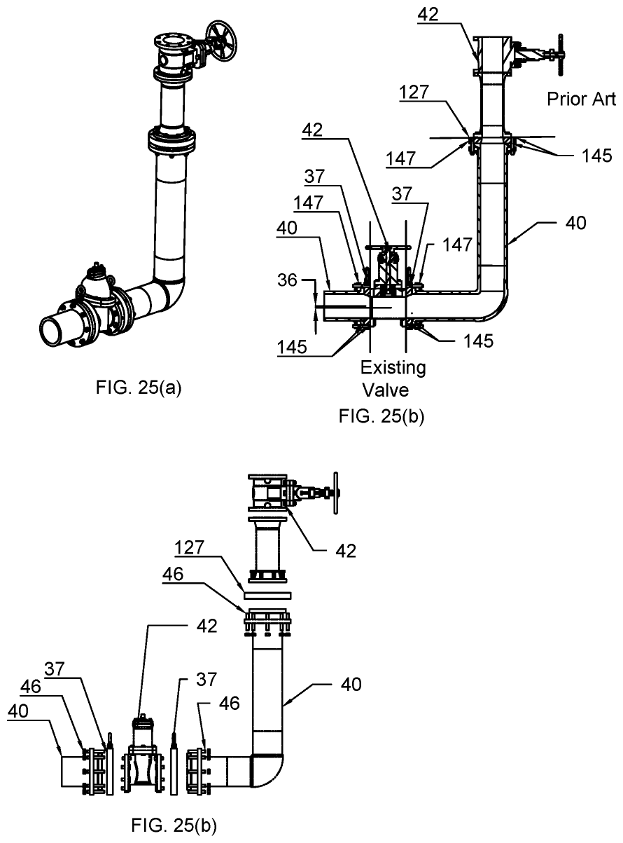

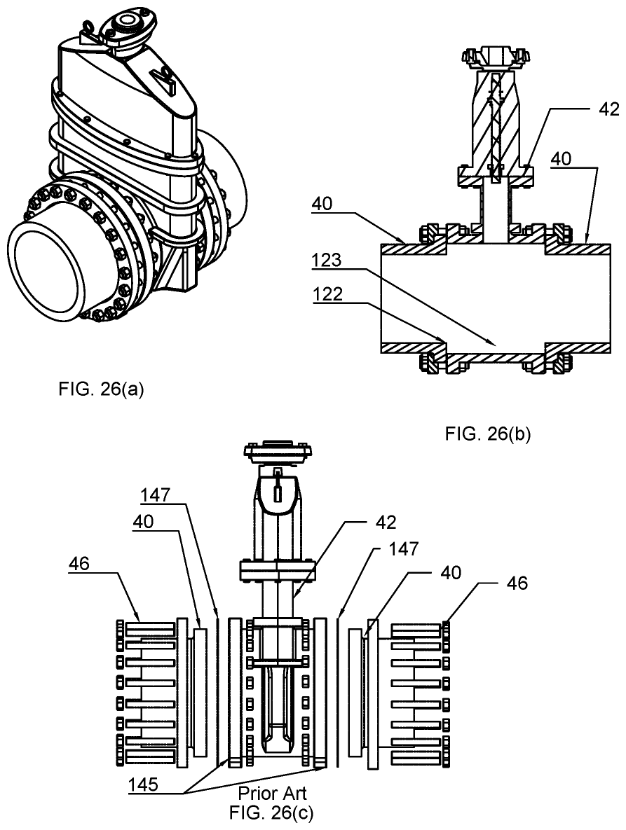

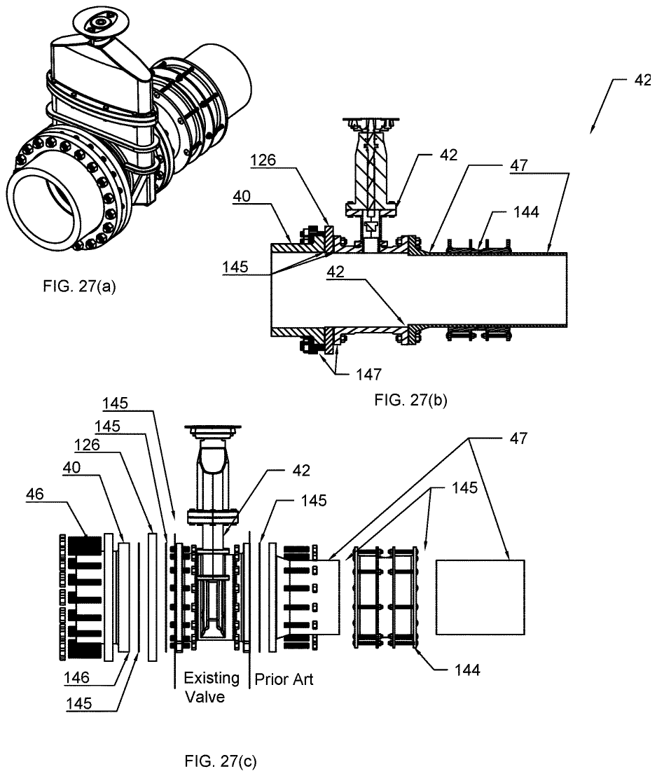

In certain retrofit applications the interface adapter 10 allows replacement of steel piping with HDPE piping 38 while maintaining existing valve sizes, flange configurations, and component locations without modification. This capability enables facility operators to upgrade fluid transport systems to high-density polyethylene piping in phases—replacing corroded or damaged steel piping sections with HDPE incrementally, one segment or one system zone at a time, while retaining all installed valves, pumps, strainers, and other metallic components at their original locations. Because the interface adapter 10 is configured to connect the larger outside diameter of thick-wall SDR 11 HDPE pipe to standard steel flanges without requiring upsizing of the connected metallic components, the transition from steel to HDPE piping requires no changes to existing valve bodies, pump nozzles, or equipment flanges—only the linear pipe sections are replaced. This phased upgrade capability allows facilities to achieve the corrosion resistance, service life, and flow efficiency advantages of HDPE piping without the operational disruption of a complete simultaneous system replacement. Individual sections of steel piping may be replaced with HDPE at maintenance intervals, during scheduled outages, or opportunistically during excavation for other purposes, with the interface adapter 10 providing the connection between the new HDPE segment and the retained steel components at each end. In certain fire water applications, the HDPE piping connected through the interface adapter 10 conforms to SDR 11 per AWWA C906 or ASTM F714, providing a pressure rating compatible with fire water system working pressures while delivering the long-term corrosion resistance advantages of HDPE over the service life of the system. The thick wall of SDR 11 pipe provides dimensional stability at the flanged connection and adequate hoop strength to support the bolt load transferred through the adapter into the HDPE pipe stub end or flange adapter, making SDR 11 the preferred pipe specification for fire water retrofit applications using the interface adapter 10. In certain applications, the interface adapter 10 also replaces compression-type fittings and mechanical couplings previously used at HDPE-to-steel transitions. Compression fittings on HDPE piping in buried or submerged service have demonstrated a failure risk under conditions of pressure surge, soil movement, water hammer, or improper installation, creating safety hazards particularly in excavation environments where personnel may be working in proximity to pressurized systems. In addition, the thin-wall metallic components of compression fittings corrode progressively in buried service, becoming structurally compromised within five years in aggressive soil conditions and creating a corrosion-driven reliability mismatch with the surrounding HDPE piping that is designed to resist corrosion throughout the intended service period of the system. The interface adapter 10 provides a fully flanged, bolted connection that eliminates the grip-based retention mechanism of compression fittings and provides a structurally integrated connection with defined and verifiable bolt preload, gasket compression, and load path integrity. FIG. 29 illustrates application in an underground fire water pipeline 90, showing the adapter installed at fire suppression branches and at main header connections. For work that has no existing flanged connection for the interface adapter 10 requires addition of a flange through welding or other means for installation of the adapter 10. The welded flange would be the first choice as it provides the positive mechanical connection between the existing steel pipe and the interface adapter plate body—the fillet weld transfers axial thrust load from the pipe into the flange face, and the bolted joint transmits that load through the adapter plate body, eliminating dependence on friction-grip connections for thrust restraint. On steel pipe with internal microbiologically influenced corrosion, a slip-on flange may be positioned at a tie-in location selected to avoid the worst internal pitting zones—the flange is slid onto the pipe and positioned axially along the pipe before welding, allowing the installer to move the tie-in point by several inches in either direction to locate the weld on a section of pipe wall with adequate thickness as confirmed by physical inspection of the cut face. Physical inspection of the pipe wall cross-section immediately following pipe cutting—direct visual examination of the cut face for wall thickness, pit depth, and pit distribution—is the required method for confirming pipe wall integrity at the tie-in location in pipe that has been in MIC-active service. Ultrasonic wall thickness measurement, while useful for general pipe condition assessment, has documented limitations at locations with significant internal deposits and should not be relied upon as the sole confirmation of wall integrity at the specific cut face location, as described in the Background. Where cut face inspection reveals inadequate wall thickness at the proposed tie-in location, the cut is extended along the pipe axis until a section of sound wall is confirmed. The interface adapter 10 is particularly well suited for locations where the underground HDPE piping system transitions to above-grade steel piping—such as at pump suction and discharge connections, at riser connections to above-grade distribution systems, and at system entry points where buried HDPE pipe meets above-grade metallic components. These above-grade transition locations are revisited for inspection, maintenance, and potential system modification throughout the service life of the installation, making a robust permanent bolted flange connection at that point the preferred long-term solution compared to sleeve-type mechanical couplings, which are appropriate for emergency repair applications but represent a longevity and restraint mismatch with the surrounding system infrastructure at planned permanent transition points. A further advantage of the interface adapter 10 over compression-style transition fittings is the provision of a smooth, continuous bore through the transition zone between the HDPE piping and the steel component. Conventional compression fittings typically present an abrupt internal geometry at the transition—including steps, ledges, or annular recesses created by the fitting body interior—that disrupts flow continuity, creates turbulence at the transition face, and produces sediment accumulation zones upstream of connected valves and equipment. The interface adapter 10, by contrast, provides a central bore 14 configured to transition smoothly between the HDPE pipe interior and the connected steel component interior, eliminating abrupt steps at the transition face and maintaining hydraulic continuity through the connection. Where the eccentric bore embodiment 36 is employed, the bottom of the central bore 14 may be aligned with the invert of the HDPE pipe on one side and the invert of the connected steel component on the other side, maintaining invert continuity through the transition. This bottom-of-pipe alignment 129 eliminates the internal ledge or step that would otherwise exist at a concentric bore transition between pipes of differing inside diameter, preventing sediment, particulate matter, or biological deposits from accumulating at the transition face and being carried intermittently into the downstream system. The combination of valve bore matching, smooth bore geometry, and eccentric invert alignment provides a comprehensive hydraulic continuity solution that is not achievable with conventional compression-style transition hardware. In certain applications, the interface adapter 10 provides a connection method for cement mortar-lined or internally coated steel pipe systems where welded connections are not feasible without damaging the protective lining. Cement mortar-lined steel pipe is widely used in water transmission and distribution systems, and the cement mortar lining provides both corrosion protection and hydraulic performance that is destroyed in the heat-affected zone of a welded connection. By providing a bolted flange connection that requires no welding at the transition point, the interface adapter 10 permits connection of HDPE replacement piping to cement mortar-lined steel pipe or other internally lined components without lining damage, lining repair, or modification of the existing protected system. This capability extends the application of the interface adapter 10 beyond standard carbon steel pipe to include the large installed base of lined steel pipe in municipal water and industrial service. Because the interface adapter 10 provides a fully restrained bolted connection along with structural lugs 98 for attachment to thrust blocks, strong backs or for support structure attachment, the unbalanced pressure thrust forces at the transition are absorbed within the bolted joint assembly rather than requiring external thrust blocking at the connection point, substantially reducing or eliminating the thrust block construction that would otherwise be required at each transition point when using compression-style couplings or compression reducers. This thrust restraint characteristic is particularly valuable in congested underground retrofits, in paved urban environments, and at valve pit locations where construction of conventional poured-concrete thrust blocks is impractical or cost-prohibitive. In certain municipal water rehabilitation and fire water service applications, the interface adapter 10 is used at transitions where existing steel distribution piping incorporates sleeve-type mechanical couplings per AWWA C219—including equivalent center-ring sleeve coupling configurations—by providing a flanged stub-end connection on the HDPE piping side and a flanged or grooved connection on the steel component at the sleeve coupling end fitting. In such configurations, the interface adapter 10 serves as the transition point between the new HDPE piping segment and the existing steel main at each valve, fitting, or appurtenance location where a sleeve coupling had previously provided the plain-end joint connection, allowing complete HDPE conversion without requiring modification of the existing steel components or their end connection geometry. Sleeve coupling transitions are particularly common in older municipal water distribution systems where ductile iron and cast iron mains were connected with sleeve-type couplings rather than flanged or mechanical joint connections, and in international water distribution systems where equivalent sleeve coupling systems are the dominant joint type for steel distribution mains. A further system-level advantage of replacing cement mortar-lined steel piping with HDPE piping connected through the interface adapter 10 is the elimination of the external corrosion protection measures required on buried cement mortar-lined steel pipe systems. Buried cement mortar-lined steel pipe and compression fittings used at transitions in such systems are commonly provided with external butyl rubber wrapping, polyethylene encasement, or other field-applied corrosion protection systems intended to protect the external steel surface from soil-side corrosion. These field-applied external wrapping systems require skilled installation, are subject to damage during backfill operations, and require inspection and maintenance over the system service life. In contrast, HDPE piping connected through the interface adapter 10 does not require external corrosion protection wrapping because HDPE is inherently resistant to soil-side corrosion, electrochemical attack, and the microbially influenced corrosion mechanisms that drive external steel pipe degradation. The replacement of cement mortar-lined steel pipe segments with HDPE therefore eliminates the cost and ongoing maintenance burden of external butyl rubber wrapping, polyethylene encasement, and the compression-style steel fittings that require such protection, providing a simpler and more durable buried piping system at each converted segment. In certain embodiments, the interface adapter 10 is configured to connect HDPE piping to fluid system components employing grooved-end mechanical coupling systems, including piping and components conforming to Victaulic, Gruvlok, or compatible groove standards. In such configurations, one face of the interface adapter 10 includes a connection pattern and peripheral geometry configured to accept a grooved mechanical coupling housing, providing a transition from a flanged HDPE piping system to a grooved-end piping network or equipment connection without requiring a separate flanged spool or grooved adapter. This capability enables the interface adapter 10 to serve as the termination point of the HDPE flanged system at the point where the system transitions to grooved piping, providing a single-component transition rather than a multi-piece assembly. Similarly, in certain embodiments the interface adapter 10 is configured to connect HDPE piping to fire hydrant branch connections, post indicator valves, and other fire water system components employing Mueller-style, American-style, or comparable proprietary connection patterns, providing compatibility with the installed base of fire water system components without requiring replacement of those components during conversion of the supply piping from steel to HDPE. In certain retrofit applications, the interface adapter 10 replaces the compression-style reducing coupling or mechanical reducer that has conventionally been used to transition from the larger outside diameter of SDR 11 HDPE piping to the smaller connection sizes of existing steel valves, hydrant branches, and system components. Conventional compression reducers used in this service are fabricated steel assemblies that grip the HDPE pipe exterior with a metallic sleeve or gripper ring on the large end and connect to the steel component with a mechanical coupling or flanged connection on the small end. Such reducers present multiple compression interfaces, no true mechanical joint, no cathodic protection provision, and must be supplemented with external thrust blocking at each location to resist the axial separation forces created by the diameter change. The interface adapter 10 replaces this multi-component assembly with a single unitary plate body that provides the diameter transition within the bore geometry, maintains the original steel component size, and delivers a fully restrained bolted connection without external thrust blocking or compression interfaces. Commercially significant reducing adapter configurations include large-diameter transmission main applications where the thick-wall SDR 11 HDPE bore is substantially larger than the bore of the connected steel component of nominally smaller size. In one configuration, a 20-inch IPS SDR 11 HDPE transmission main (inside diameter approximately 16.36 inches) connects through the interface adapter 10 to a 16-inch steel valve, fitting, or pipe component (internal bore approximately 15.25 inches), with the first connection pattern 18 conforming to the 20-inch HDPE stub end flange bolt circle, the second connection pattern 16 conforming to the 16-inch steel component flange bolt circle, and the central bore 14 incorporating a reducing profile transitioning from 16.36 inches to 15.25 inches with an eccentric offset of approximately 0.18 inches for invert continuity. In a second configuration, a 14-inch IPS SDR 11 HDPE main (inside diameter approximately 11.46 inches) connects to a 12-inch steel component (internal bore approximately 11.63 inches) with an eccentric offset of approximately 0.27 inches. In both configurations, the first connection pattern bolt circle and the second connection pattern bolt circle correspond to completely different nominal pipe sizes, creating bolt circle diameter differences of 4.5 inches and 2.0 inches respectively—differences far larger than those encountered in same-nominal-size configurations—making the structural ligament preservation achieved by the stress field non-overlap criterion of the present invention especially critical to long-term joint integrity. The stress field non-overlap criterion of the present invention applies equally to this reducing configuration—the first connection pattern bolt preload stress fields and the second connection pattern bolt preload stress fields, which correspond to different nominal pipe sizes and therefore different bolt circle diameters, are positioned such that their respective stress fields do not overlap, preserving structural ligament integrity in the plate body between the two patterns. In certain embodiments, the interface adapter 10 may be configured to interface with components manufactured according to ASME, DIN, ISO, EN, JIS, AWWA, or other dimensional or flange standards. Specific standard combinations in which the interface adapter 10 may be applied include, but are not limited to: ASME B16.5 Class 150 flanges to AWWA C207 Class D flanges; ASME B16.5 Class 150 flanges to DIN EN 1092-1 PN10 or PN16 flanges; ASME B16.5 Class 150 flanges to JIS B2220 10K or 16K flanges; AWWA C207 Class D flanges to ISO 7005 PN16 flanges; and ASME B16.47 Series A or Series B large-diameter flanges to AWWA C207 flanges. In certain embodiments, the first fastener pattern 18 conforms to a first standard and the second fastener pattern 16 conforms to a second, different standard from the foregoing list, as illustrated in FIGS. 12 through 27 which show various flange standard combinations in installation context. The interface adapter 10 may be used in fire protection systems, cooling water systems, municipal water systems, mining systems, desalination systems, industrial process piping systems, wastewater systems, slurry transport systems, chemical transfer systems, hydrocarbon service systems, utility systems, and other fluid transport systems. The interface adapter 10 is designed for compatibility with applicable water and fire protection system standards. In fire water distribution service, the interface adapter 10 is configured for compliance with NFPA 13, NFPA 14, NFPA 20, NFPA 24, and NFPA 25, and is compatible with FM Global-listed and UL-listed fire water system components. In municipal water distribution service, applicable standards include AWWA C110, C111, C200, C219, and C606, with materials in contact with the water stream selected for compliance with NSF/ANSI 61 and NSF/ANSI 372 for potable water service. In international applications, the interface adapter 10 is configured to mate with flanged components conforming to EN 1092-1, EN 545, AS 4087, JIS B2220, and equivalent national and regional flange standards, and is compatible with HDPE piping conforming to EN 12201 for the applicable SDR and pressure class. The interface adapter 10 may be applied in any fluid transport system requiring a flanged thermoplastic-to-metallic transition conforming to the applicable pressure class, flange standard, and material requirements of the service environment. In certain embodiments, following installation of the interface adapter 10, the assembled connection may be pressure tested to verify structural integrity and gasket sealing performance. A hydrostatic pressure test at a multiple of the system working pressure, consistent with applicable piping codes including NFPA 13, AWWA standards, or ASME B31 piping codes as applicable to the service, provides verification of bolt preload distribution, structural ligament integrity, and sealing performance at the adapter interfaces prior to system commissioning. In certain embodiments, the interface adapter 10 may be dimensioned, configured, or optimized using analytical methods, finite element analysis, computational fluid dynamics, empirical testing, field observations, or combinations thereof. However, the invention is not limited to embodiments produced by any particular design method. Referring to FIG. 5(a) through 5(c), the bore-matched central bore 14 eliminates the sediment accumulation zone at the valve inlet face by matching the adapter bore to the connected valve internal bore diameter. FIG. 5(d) and 5(e) show the prior art bore mismatch configurations for comparison, illustrating the sediment accumulation zone 123 and legacy bore step 122 at the valve-to-pipe interface that the present invention eliminates. Referring to FIG. 1(b) and 9(c), the exploded and isometric assembly views illustrate the complete component set for an eccentric bore reducing adapter installation. The concentric stub end is heat-fused to the HDPE pipe end and carries no bore offset. The loose backing ring slips over the pipe outside diameter and rotates freely around the pipe circumference. The backing ring carries the first connection pattern 18 bolt holes. The interface adapter plate body 12 carries the eccentric central bore 14, the second connection pattern 16 blind tapped holes on the steel-side face in the fixed two-hole standard orientation, and the external lug 60. The steel-side second connection pattern 16 is fixed at manufacture in the two-hole standard orientation of the connected metallic component and does not change in the field. The two-hole standard installation orientation positions the interface adapter 10 with the external lug 60 at the crown (12 o'clock position), orienting the eccentric bore low point at the invert (6 o'clock position) for invert continuity. The backing ring is rotated independently to the two-hole standard position, in which two bolt holes of the first connection pattern straddle the vertical centerline such that neither the 12 o'clock nor the 6 o'clock position falls on a bolt hole, providing valve stem clearance and standard installation orientation. The rotational independence of the backing ring from the adapter plate orientation allows both requirements—stress field non-overlap at the plate and two-hole standard at the HDPE flange—to be satisfied simultaneously without custom fabrication. FIG. 4(f) shows the eccentric adapter bore profile through the plate body thickness. Referring to FIG. 9(c), the bore breakthrough prevention geometry is shown for the eccentric bore reducing adapter. The first connection pattern 18 bolt circle and the second connection pattern 16 bolt circle are angularly displaced from one another such that substantially no bolt preload stress field of the first pattern overlaps any stress field of the second pattern, satisfying the stress field non-overlap criterion of the present invention and simultaneously preventing any bolt hole from either pattern from falling at the minimum wall thickness angular position of the eccentric bore. The external lug 60 is positioned at the plate crown as the field orientation reference. FIG. 9(c) shows the critical cross-section at the invert position, with the eccentric bore alignment 36 dimension of approximately 1.25 inches, the 0.5 inch minimum wall dimension, and the bore breakthrough phantom position callout showing where the bolt hole would intersect the bore wall if positioned at the invert without angular displacement—the physical breakthrough condition prevented by the present invention. The bolt holes are projected into the section plane for clarity as noted in the figure. Referring to FIG. 2(b), the split comparison of same-nominal bolt circle proximity demonstrates that without angular displacement bolt circles for 20 and 16-inch nominal pipe would not meet the ASME PCC-1 guidelines for stress field radius —causing stress field overlap in the conventional concentric arrangement. While specific embodiments of the interface adapter 10 have been described, it will be understood by those skilled in the art that various modifications, alternative configurations, and equivalent arrangements may be employed without departing from the scope of the invention as defined by the appended claims. For example, the number, size, and arrangement of fastener openings may be varied to accommodate different piping standards, pressure classes, or installation requirements. The degree of radial separation and the resulting angular displacement between the connection patterns may be adjusted to satisfy the stress field non-overlap criterion for different fastener sizes and bolt circle geometries. The internal geometry of the bore may be modified to suit particular flow conditions, valve types, or erosion mitigation requirements. The adapter may be manufactured by casting, forging, machining, or combinations thereof, and material selection, coating systems, and surface treatments may be adapted based on the corrosion environment, chemical service, and pressure class of the specific installation. The terminology used herein is for the purpose of describing particular embodiments and is not intended to be limiting. The scope of the invention is defined by the appended claims and equivalents thereof.

### XII. Complete Fire Water HDPE Retrofit System Solution

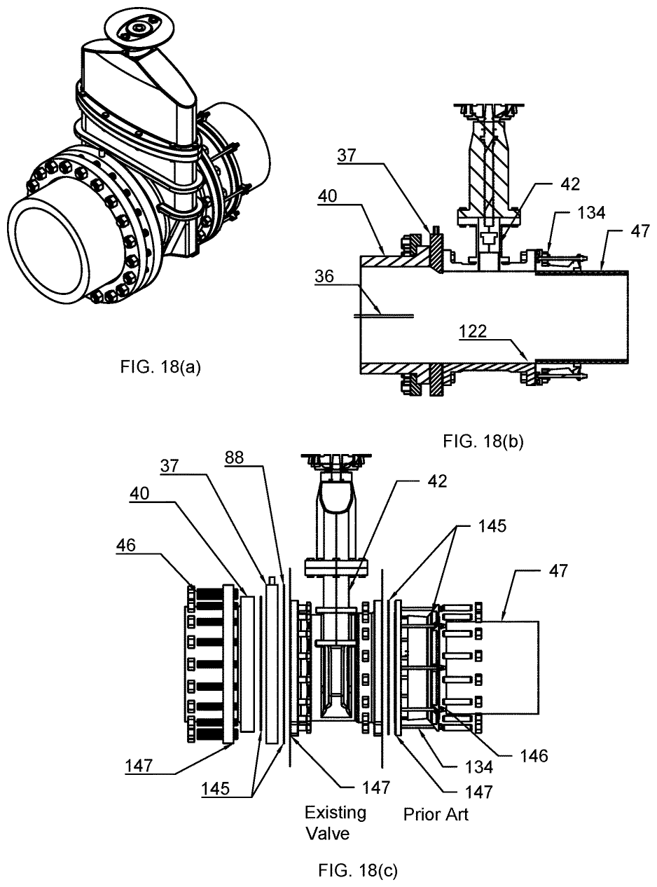

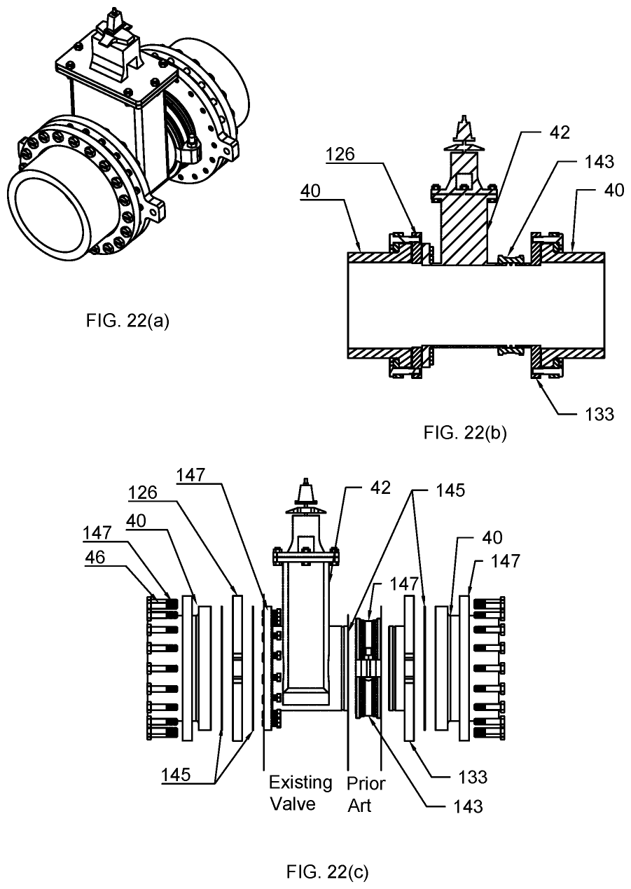

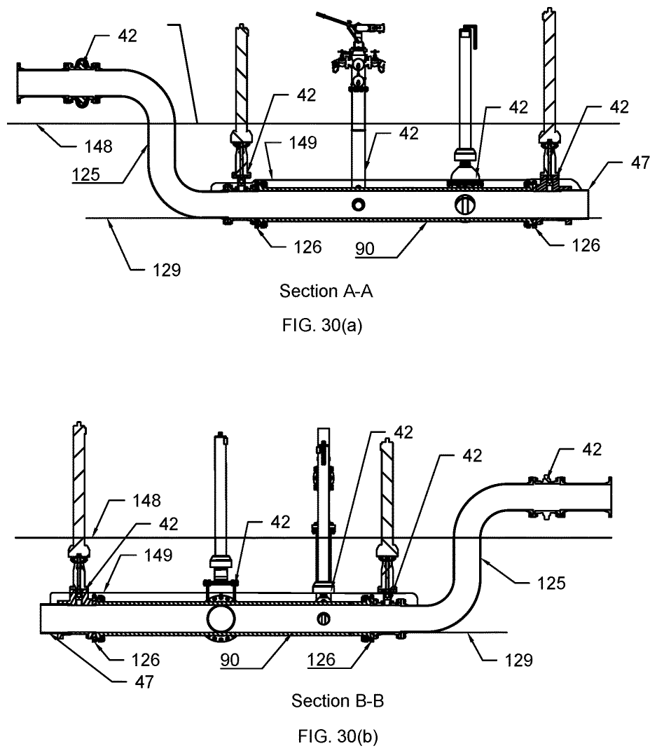

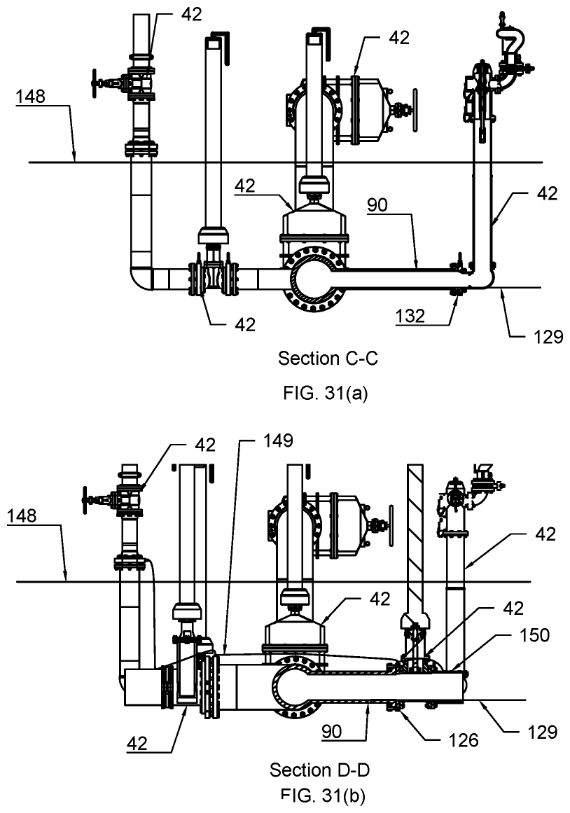

The interface adapter 10, together with the fastener set 46 and matched sealing gasket set, constitutes a complete system solution specifically engineered for the long-term retrofit of fire water distribution systems from steel piping to SDR 11 high-density polyethylene piping or other SDR variations as required. No component of this system solution has been previously available as an integrated assembly for this application. The fire water HDPE retrofit system solution addresses every failure mode associated with conventional HDPE-to-steel transition hardware in a single, specified, verifiable assembly. Referring to FIGS. 12 through 27, each bolted flange connection in the retrofit installation presents two potential leak interfaces 145—one at each gasketed face of the interface adapter plate body 12. The single unitary plate body construction limits the total number of potential leak interfaces to two per adapter, compared to four or more interfaces in multi-component compression-style or spool-type transition assemblies. Conventional prior art connections in the retrofit installation—including compression couplings, sleeve couplings, and mechanical joint connections shown in the prior art portions of FIGS. 18, 19, and 27—incorporate axial movement permitted zones 146 where the connection permits axial displacement under thrust, thermal, or ground movement loads, introducing the risk of joint separation under surge or differential settlement conditions. The bolted flange connections of the interface adapter 10 constitute rigid fixed joints 147 that permit no axial movement at the transition point—the bolt preload of the fully engaged fastener set 46 resists all axial separation forces within the joint assembly without reliance on gripping elements, friction, or external thrust blocking. Referring to FIGS. 30 through 32, the grade plane reference line 148 establishes the surface grade datum for all buried depth and cover calculations at each adapter installation point. The cathodic protection grid 149 shown in FIG. 30 connects the cathodic protection bonding conductors attached to the multifunctional external lug 60 at each adapter, bridging the non-conducting HDPE pipe segments to maintain cathodic protection circuit continuity to all downstream metallic components. Existing grooved steel pipe 150 at the grooved branch connection shown in FIGS. 22 and 29 is distinguished from flanged steel pipe 125 by its grooved end configuration—the groove profile conforming to AWWA C606—which accepts the grooved adapter 133 at the steel side of the transition.

### XIII. Kit Assembly Engineering—Fastener Length and Gasket Geometry

A critical and non-obvious aspect of the interface adapter system is that the fastener length and gasket geometry required for a safe, long-life installation are not interchangeable across adapter configurations and cannot be determined from standard piping tables alone. Both the fastener set 46 and the sealing gasket must be specifically dimensioned for the particular adapter plate body 12, the HDPE flange adapter 40, and the connected metallic component 42, constituting a matched kit assembly uniquely determined by the adapter configuration. For the fastener set 46, the required fastener length L is determined by the sum of the following stack components: the nominal plate body thickness T_adapter; the HDPE stub end flange thickness T_HDPE; the metallic component flange thickness T_steel; the compressed gasket thickness at both faces (T_gasket1+T_gasket2); and the minimum thread engagement length T_engage, which per ASME B18.2.1 and ASME B16.5 practice shall be not less than one times the nominal fastener diameter for steel nuts conforming to ASTM A194 and not less than 1.5 times the nominal fastener diameter for reduced-strength nut materials. Fastener studs and bolts conforming to ASTM A193 Grade B7 or equivalent, and heavy hex nuts conforming to ASTM A194 Grade 2H or equivalent, are the standard fastener materials for flanged piping systems in fire water and industrial process service and constitute the reference fastener specification for the stack-up calculation described herein. Accordingly, the minimum fastener length is: L_min=T_adapter+T_HDPE+T_steel+T_gasket1+T_gasket2+T_engage. A fastener that is shorter than L_min produces inadequate thread engagement in one or both nuts, resulting in progressive thread stripping under cyclic pressure loading, thermal cycling, and the preload relaxation characteristic of HDPE flange connections over the fifty-year service life of the installed system. A fastener that is excessively long may contact the bore of the plate body 12 or interfere with adjacent hardware. Accordingly, the fastener set 46 supplied with the interface adapter 10 as a matched kit is pre-selected to the correct length for the specific adapter configuration, flange thicknesses, and gasket selection, and is not interchangeable with standard flange fastener sets for the nominal pipe size without verification against the stack-up calculation described herein. For the sealing gasket, the gasket geometry is uniquely determined by the adapter configuration in a manner that is not captured by standard pipe flange gasket tables. Nonmetallic flat gaskets conform to ASME B16.21 (Nonmetallic Flat Gaskets for Pipe Flanges) for material selection, thickness, and dimensional requirements; ring-type metallic gaskets, where used, conform to ASME B16.20 (Metallic Gaskets for Pipe Flanges). On the HDPE stub end flange face, which is typically a full-face flat flange per AWWA C207 or ASME B16.1 Class 125 practice, a full-face gasket conforming to ASME B16.21 is required—the gasket outer diameter equals the flange outer diameter and the bolt holes in the gasket must be punched to match the first connection pattern 18 of the interface adapter 10. On the metallic component flange face, which may be a raised-face flange per ASME B16.5 or a flat-face flange per AWWA C207, the gasket is a ring gasket with inner diameter equal to the bore diameter of the metallic component and outer diameter equal to the raised face outer diameter. In an eccentric bore adapter configuration, the gasket inner diameter on the HDPE side must be sized to clear the eccentric bore profile 36 without restricting flow—the gasket center is offset from the plate body center by the same eccentricity as the bore, producing a gasket geometry that is unique to the specific eccentric bore adapter and cannot be substituted with a standard concentric ring gasket without creating a flow restriction or an unbalanced sealing surface. In adapter configurations incorporating a tapered bore inlet 32 or a radiused bore transition 30, the gasket inner diameter on the HDPE side must be sized to clear the widest point of the bore profile at the face, which may be larger than the nominal valve bore diameter, requiring a gasket with a specifically determined inner diameter larger than a standard ring gasket for the same nominal pipe size. The pre-matched gasket set supplied with the interface adapter 10 as a kit component is dimensioned for the specific bore profile and connection pattern geometry of that adapter, and is not interchangeable with standard flange gaskets for the nominal pipe size without verification against the bore profile and connection pattern geometry described herein.

### XIV. Gasket Alignment and Locating Groove System

The alignment of the sealing gasket at each face of the interface adapter 10 is a critical and non-obvious installation requirement for adapter configurations incorporating an offset central bore. In an offset bore configuration, the central bore 14 is not concentric with the plate body 12 —the bore centerline is offset from the plate body centerline to achieve invert continuity between the connected pipe components. The sealing gasket at each face of the adapter must therefore have its inner bore offset by the same amount and in the same direction as the central bore 14, so that the gasket inner bore is aligned with the adapter bore and does not obstruct the bore opening at either face. A standard concentric ring gasket installed on an offset bore adapter will partially overlap the bore opening on the side where the bore is closest to the plate edge, recreating the annular obstruction and sediment accumulation ledge at the bore face that the offset bore was designed to eliminate. Standard bolt hole clearance of 0.0325 inch per ASME B16.5 and AWWA C207 is insufficient to control gasket rotational position—bolt hole tolerance permits the entire flange assembly to shift radially and rotationally in ways that cannot be corrected by field inspection after the joint is closed. To address this critical alignment requirement, the interface adapter 10 in certain embodiments includes a gasket locating groove 84 on the first face of the plate body and a gasket locating groove 84 on the second face of the plate body. Each gasket locating groove comprises a shallow recess machined into the respective face of the plate body, having an inner diameter slightly larger than the outer diameter of the sealing gasket configured for that face. The groove on each face is machined in the same setup as the central bore 14 and the external lug 60, establishing the groove position relative to the bore to machining tolerance rather than to bolt hole clearance tolerance. Because the gasket inner bore is offset from the gasket outer diameter centerline to match the eccentricity of the central bore, the offset gasket seats in the locating groove in only one correct rotational orientation—the orientation in which the gasket inner bore is concentric with the adapter bore at that face. Any incorrect rotational position of the gasket produces a visible gap between the gasket OD and the groove wall on one side, providing an unambiguous visual indicator of misalignment that the installer can detect and correct before the joint is closed. This positive location and visual verification feature is not present in any conventional flanged adapter for HDPE-to-steel piping transitions. In certain embodiments, each face of the plate body 12 further includes a second gasket locating groove 86 having a diameter corresponding to the outer diameter of a full-face sealing gasket for the respective connection pattern. Full-face sealing gaskets are required at connections to flat-faced flanged components—including ductile iron valve bodies, cast iron fire hydrant inlet flanges, and steel flanges conforming to AWWA C207 flat-face practice—to prevent lever arm loading that occurs when a ring gasket is used on a flat-faced flange. In the lever arm condition, bolt preload compresses only the inner ring gasket area while the outer flange face area is unloaded; under internal pressure the flange face rotates about the gasket outer edge, reducing gasket compression at the bore face and increasing leak risk at the inner sealing surface. The full-face gasket distributed across the full flange face area prevents this rotation. The second gasket locating groove 86 ensures the full-face gasket is correctly positioned—centered on the plate face for concentric bore adapters, or eccentrically positioned to clear the eccentric bore opening on offset bore adapters—and provides pre-assembly visual confirmation that the correct full-face gasket has been selected and correctly placed at that face of the adapter. The gasket locating groove 84 completes a four-feature installation orientation system for the offset bore interface adapter 10. The external lug 60 at the crown of the plate body establishes the rotational position of the adapter plate relative to the pipe, confirming that the bore low point is aligned with the pipe invert. The two-hole standard backing ring orientation positions the HDPE-side bolt holes to straddle the bore centerline axis without placing any bolt hole on the axis itself. The gasket locating groove 84 on the HDPE face locates the HDPE-side offset ring gasket 88 in its single correct rotational position relative to the adapter bore at the HDPE face. The gasket locating groove 84 on the steel component face locates the steel-side sealing gasket in its single correct rotational position relative to the adapter bore at the steel face. Together these four features provide positive mechanical and visual confirmation of correct alignment at every critical interface in the assembly, without requiring measurement tools, without depending on bolt hole clearance tolerance, and without leaving any critical alignment to installer judgment. The matched kit assembly supplied with the interface adapter 10 includes offset sealing gaskets specifically configured to seat in the locating grooves, ensuring that the installed assembly achieves the full bore-matching and invert-continuity performance of the interface adapter 10 without gasket obstruction at either face.

### XV. Sealing Face Finish—Phonographic Surface and Ring Gasket Boundary Groove

Each face of the plate body 12 is machined with a 125 microinch RMS phonographic spiral groove surface finish extending across the entire face from the bore edge to the plate body outer diameter or as required for the specific application, conforming to ASME B16.5 requirements for flat and raised-face flange seating surfaces. The phonographic finish provides mechanical interlock between the sealing gasket and the adapter face under bolt preload, resisting gasket blowout under pressure surge, gasket creep under sustained load, and gasket rotation under thermal cycling—particularly significant for HDPE stub end flange connections in which HDPE material undergoes gradual preload relaxation over the service life of the installation. The phonographic finish is applied uniformly across both faces and is compatible with both ring-type and full-face sealing gaskets. On the first face of the plate body—the face mating with the high-density polyethylene piping flange—the outer diameter of the plate body 12 coincides with the outer diameter of the HDPE lap joint flange, so that a full-face gasket covers the entire first face to the plate edge without requiring a separate outer locating feature. A single boundary groove 84 is machined into the first face at the outer diameter of the ring gasket seating zone, at a depth of approximately 0.0325 inch with a radiused profile, serving as both the ring gasket boundary marker and the rotational registration feature for offset ring gaskets on eccentric bore adapters. On the second face of the plate body—the face mating with the metallic fluid system component—the plate body outer diameter is larger than the gasket seating zone for connections to raised-face or flat-faced steel flanges of smaller nominal size. The second face therefore includes the boundary groove 84 at the ring gasket outer diameter for ring gasket registration, and additionally includes a second locating groove 86 at the outer diameter of the full-face gasket for that connection pattern, at a depth of approximately 0.0325 inch, configured to receive and positively locate a full-face sealing gasket for connections to flat-faced cast iron, ductile iron, or AWWA flat-face steel flanged components, preventing eccentric gasket seating and lever arm loading on those connections. The valve bore matched central bore 14 eliminates the sediment accumulation zone at the upstream face of the existing steel valve 42, preserving valve actuation reliability under fire demand conditions. The structural ligament geometry of the plate body 12, with minimum material width 25, provides resistance to the transient pressure surge forces generated by fire pump startup, system pressurization, and rapid valve actuation. The corrosion-resistant coating mitigates the external corrosion mechanism that causes conventional compression fitting hardware to fail in aggressive buried service conditions. The installation documentation specifying torque sequence and final torque values provides verified bolt preload at every connection, replacing the unverifiable grip of compression fittings with a defined and inspectable mechanical joint. The result is a fire water retrofit connection at existing valve locations that uses a bore-matched valve of the appropriate nominal size for the SDR 11 HDPE piping—typically one nominal pipe size smaller than the HDPE main, whose inside diameter approximates the bore of that smaller valve—while delivering a service life consistent with the surrounding SDR 11 HDPE piping—without the hydraulic penalty of an oversized valve, without the structural vulnerability of compression fittings, and without the galvanic corrosion risk of unprotected dissimilar metal contact. The interface adapter 10 constitutes a comprehensive single-component solution for the conversion of metallic piping systems to high-density polyethylene, addressing the full range of connection requirements encountered in a complete system retrofit: bolted connections to standard steel flanges conforming to ASME B16.5, AWWA C207, and related standards; connections to grooved-end piping systems through grooved coupling compatibility; connections to fire hydrant branch assemblies, post indicator valves, and Mueller-style fire water components; connections to cement mortar-lined and internally coated steel mains without weld heat damage; and replacement of compression-style reducing couplings at diameter transitions. By providing a fully restrained bolted flange connection, the system eliminates the external thrust blocking required at compression-style transitions at each retrofit point. The phased retrofit capability of this system allows segment-by-segment conversion of steel piping to HDPE while retaining all existing metallic components and connection points. This system solution represents the primary embodiment of the present invention and the specific combination that the kit claim is designed to protect. The kit assembly supplied with the interface adapter 10 as a matched engineered system is not a collection of standard hardware assembled to nominal pipe size specifications. Each component of the kit—the interface adapter plate body, the fastener set, and the matched gasket set—is specifically dimensioned and configured for the particular adapter plate body geometry, connection pattern bolt circle diameters, bore profile eccentricity, and flange stack-up of the specific installation. The fastener length is calculated from the actual stack-up of that adapter with those flanges and that gasket selection—not from a standard table for the nominal pipe size. The gasket inner bore is offset to match the eccentricity of that adapter's bore—not a standard concentric ring gasket. The installation documentation specifies the torque sequence and final torque value calculated for that specific stack-up and target bolt preload—not a generic torque value from a standard flange assembly table. The consequence of this matched configuration is installation certainty: an installer who follows the kit documentation with the kit components achieves the specified bolt preload distribution, gasket seating, and bore alignment at every connection point. An installer who substitutes any kit component with standard off-the-shelf hardware for the nominal pipe size loses the engineering basis for those specifications—the torque value is no longer calibrated to the actual stack-up, the gasket may obstruct the bore or seat incorrectly, the fastener may bottom out before achieving specified preload or provide insufficient thread engagement. The matched kit assembly is therefore not merely a convenience of packaging —it is the mechanism by which installation certainty is transferred from the engineering of the adapter to the field installation, and it constitutes a complete engineered system solution that is not replicable from standard catalog components for the nominal pipe size. The phased retrofit capability of the interface adapter 10 system enables segment-by-segment conversion of existing steel piping infrastructure to HDPE pressure pipe while all existing metallic system components remain at their installed locations without modification, upsizing, or replacement, with each HDPE segment connected to the existing metallic components through fully restrained bolted flanged joints at each end. The straight bore configuration of the central bore 14 provides bore continuity at the valve face while the upstream step at the HDPE-to-adapter face is self-clearing in flowing service. The eccentric bore embodiment additionally eliminates the upstream invert step by offsetting the bore centerline to maintain full invert continuity through the transition, providing superior drainage and solids handling in buried service. In certain embodiments, the central bore 14 includes a chamfered or radiused entry transition at each face of the plate body 12. A chamfer or radius of approximately one-quarter inch applied to the bore edge at the first face and at the second face of the plate body reduces flow turbulence at bore entry and exit, reduces leading-edge erosion under high-velocity or cyclic flow conditions, and provides a finished transition consistent with standard machining practice for flanged bore components. This chamfered or radiused entry is applicable to straight cylindrical, tapered, diffuser, and eccentric bore configurations equally and does not alter the bore-matching or invert-continuity function of the central bore 14. The one-quarter inch chamfer or radius is consistent with the entry geometry of steel valve bodies, pump flanges, and other metallic fluid system components to which the interface adapter 10 connects, providing a smooth hydraulic transition at each face of the assembled connection. In certain embodiments, the interface adapter 10 includes one or more structural attachment lugs 98 formed integrally with and as part of the unitary plate body 12, positioned on the plate body exterior at locations selected based on the specific installation geometry, thrust direction, anchor configuration, and maintenance access requirements of the individual installation. The structural attachment lugs 98 are distinct from the multifunctional external lug 60 and are configured for through-hole fastener engagement—each structural attachment lug 98 includes one or more through-holes or elongated slots of sufficient cross-sectional area and fastener bearing length to accept a tie rod, anchor bolt, spreader rod, or bracket attachment fastener under the full design load without yielding of the lug body or pullout of the fastener engagement. In certain embodiments the through-hole is a circular opening sized for a specific fastener diameter. In certain embodiments the through-hole is an elongated slot oriented in a selected direction—typically vertical—permitting positional adjustment of the anchor fastener within the slot range before final tightening, absorbing as-built dimensional variation between the adapter installation elevation and the fixed anchor structure elevation without requiring shimming or custom fabrication. The structural attachment lugs 98 serve four distinct functions in buried and above-grade piping installations. The number of structural attachment lugs 98 incorporated in a given adapter configuration is not limited to two, and may be increased to three, four, or more based on the axial load magnitude, adapter diameter, valve or fitting body size, available anchoring geometry, and installation access conditions of the specific installation—larger diameter adapters and higher pressure class installations may require additional lugs at intermediate circumferential positions to distribute restraint loads and provide additional all-thread engagement points. First, in thrust restraint applications where the downstream connection is a non-restrained joint type—including sleeve-type mechanical couplings conforming to AWWA C219, mechanical joint connections, or other connection types that rely on soil bearing or external thrust blocks to resist unbalanced pressure forces—tie rods or anchor bolts engaged through the structural attachment lugs 98 connect the adapter plate body 12 to a concrete thrust block, soil anchor, anchor collar, structural strongback, or other fixed structure, transmitting the unbalanced pressure force from the adapter plate body directly to the external restraint structure without loading the non-restrained downstream joint. Second, in valve extraction and maintenance applications, threaded spreader rods engaged through the structural attachment lugs 98 bear against the face of the adjacent downstream flange, generating a controlled separation force between the adapter plate body 12 and the downstream component without the use of flange spreader tools, hydraulic jacks, or pry bars at the joint face. This maintenance function is particularly significant for buried valve installations where confined excavation geometry limits tool access to the joint. Third, the structural attachment lugs 98 provide attachment points for supplemental pipe restraint harnesses, external tie-rod assemblies, or concrete encasement anchors for pipe movement control independent of the joint bolt preload. Fourth, in installations where thermoplastic pipe thermal contraction creates a gap at the adapter face requiring axial pull-up force to seat the gasket and complete the bolted joint, all-thread rod or tie-rod assemblies engaged through the structural attachment lugs 98 on opposing interface adapters 10 flanking an intermediate valve or fitting body provide a temporary external axial load path that bypasses the interior of the intermediate component. Tensioning the all-thread assembly between opposing structural attachment lugs 98 on the two adapter plate bodies generates the axial compressive force required to close the thermal contraction gap and seat the gasket without transmitting the installation pull-up load through the body of the intermediate valve or fitting. This external load bypass function is particularly important when the intermediate valve or fitting body is not independently anchored against axial movement, as transmitting large thermal contraction forces through an unanchored valve body may impose axial tensile loads outside the valve design basis. The temporary all-thread assembly is removed after the bolted joint is fully torqued to specification and the installation load is transferred to the permanent bolted connection. The number of all-thread rods and corresponding structural attachment lugs 98 engaged for thermal pull-up operations is selected based on the calculated thermal contraction force, the adapter nominal diameter, and the structural capacity of each lug—for large diameter adapters or installations with significant temperature differentials between pipe fusion and installation, four or more lugs distributed around the adapter circumference may be required to develop the necessary pull-up force without overloading individual lugs. As a non-limiting example, a 65-foot run of 20-inch IPS SDR 11 HDPE pipe experiencing a 30-degree Fahrenheit temperature drop between fusion and installation will thermally contract approximately 2.5 inches, imposing an axial tensile force of approximately 219,000 pounds on the adapter connection when the joint is pulled up to seat the gasket—a load condition for which the structural attachment lugs 98 engaged with temporary all-thread rod provide a controlled external load path protecting the intermediate valve or fitting body from this installation-induced force. In certain embodiments, the interface adapter 10 is configured for attachment to a fixed base structure—including a concrete pad beneath the valve assembly, a vault floor, a thrust block face, or a structural support frame—through a separate mounting bracket assembly that engages the structural attachment lugs 98 on one side and attaches to the fixed base structure on the other side. The mounting bracket assembly is a separate structural component from the adapter plate body 12 and is configurable for different base geometries, installation heights, and pipe elevations. In certain embodiments the mounting bracket assembly includes a height adjustment feature permitting vertical positioning of the adapter plate body 12 relative to the base structure to accommodate pipe grade variations, existing valve flange elevation differences from standard bracket heights, settlement compensation, and as-built tolerance absorption during installation without requiring custom bracket fabrication for each installation elevation. The height adjustment feature may comprise one or more of: slotted bolt holes in the bracket leg or foot permitting vertical positioning within a defined range before final tightening; a threaded rod element with jam nuts or lock nuts between the bracket foot and a base plate permitting continuous height adjustment within the rod thread range; a turnbuckle or threaded coupling in the bracket body permitting length adjustment after bracket installation; or a telescoping bracket leg with pinned height positions at defined increments. In certain embodiments the mounting bracket assembly provides adjustment in more than one direction, permitting three-dimensional positioning of the adapter plate body 12 relative to the fixed base structure before final tightening to accommodate both vertical elevation variation and horizontal lateral variation from nominal installation geometry. The structural attachment lugs 98, the mounting bracket assembly, the height adjustment feature, and their restraint, extraction, anchoring, and support functions are further described and claimed in applications related to the present application. In certain embodiments, the interface adapter 10 is provided as a two-part assembly comprising a first structural member and a second structural member joined at a machined interface. The first structural member comprises the plate body 12 with the first connection pattern 18 on the first face configured for the thermoplastic piping connection, the bore geometry providing the bore-matching and flow-conditioning functions described herein, and the second connection pattern 16 on the second face providing the structural joint interface to the second structural member. The second structural member provides the downstream end connection geometry specific to the installed application—including a mechanical joint socket conforming to AWWA C111 for connection to ductile iron mechanical joint systems, a sleeve-type collar for connection to plain-end steel or ductile iron pipe through a sleeve-type mechanical coupling conforming to AWWA C219, a grooved pipe end for connection to grooved mechanical coupling systems, or other downstream end geometries as required by the specific installation. The second structural member carries a straight bore of substantially constant diameter, as the bore-matching and flow-conditioning geometry is fully provided by the first structural member. The first and second structural members are joined at their mating faces by welding, by mechanical fasteners engaging threaded connections in both members, or by integral machining from a common billet where the geometry of both members is produced in a single manufacturing operation from one piece of material. For flanged steel-side connections, the interface adapter 10 is preferably configured as a unitary one-piece plate body providing all connection pattern and bore geometry functions in a single structural member. The drawings presented in this application illustrate representative embodiments of the interface adapter 10 across selected bore profiles, downstream end connection types, pipe sizes, and system configurations. The drawings are not intended to enumerate every possible combination of bore profile, pipe size, eccentric offset magnitude, downstream end type, coating system, or installation configuration within the scope of the claims. A complete illustration of all possible combinations would constitute a product catalog rather than a patent disclosure. The methods, geometric principles, structural criteria, and functional relationships established in the illustrated embodiments apply to all combinations within the scope of the claims by operation of those principles, without requiring separate illustration of each combination. In particular, the stress field non-overlap criterion, the bore-matching geometry, the eccentric offset direction selectability, the three-function lug, and the lap joint backing ring rotational independence described herein apply across the full range of pipe sizes, pressure classes, flange standards, bore profiles, and downstream end connection types within the scope of the claims, whether or not a drawing specifically illustrating that combination is included in this application. Although several embodiments and applications have been described, the invention is not limited to the precise arrangements disclosed. Variations in geometry, dimensions, materials, opening patterns, body thickness, bore profiles, coatings, linings, cathodic protection features, standards compatibility, manufacturing processes, and installation environments may be made without departing from the scope of the invention as defined by the claims.

### XVI. Adapter Configuration Types and Bore Configuration Types

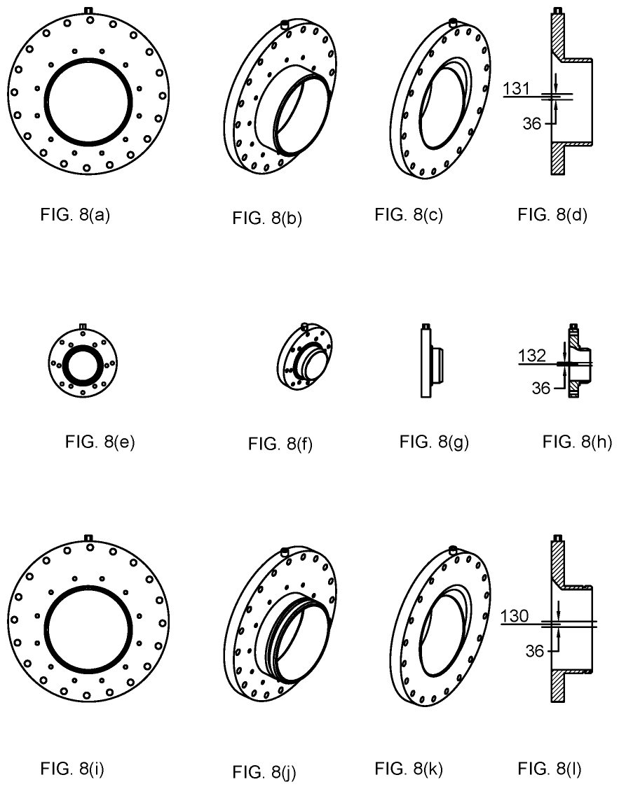

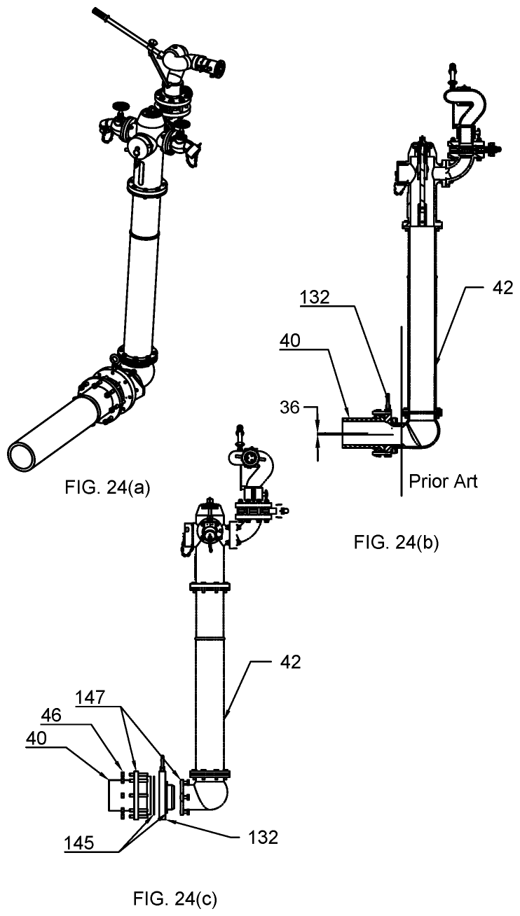

The interface adapter 10 is produced in five adapter configuration types distinguished by the end connection geometry on the steel-side face of the plate body 12. The flanged adapter is the primary configuration and comprises a flat face flanged connection on the steel-side face, compatible with AWWA C207, ASME B16.5, ASME B16.1, and equivalent flat-face and raised-face flange standards on the metallic fluid system component side. The flanged adapter is used in all flanged valve, flanged fitting, and flanged steel pipe connection configurations and constitutes the configuration shown in FIGS. 12 through 14, 18, 20 through 23, and 25 through 27. The mechanical joint adapter 130 comprises a mechanical joint bell socket or mechanical joint follower gland geometry on the steel-side face conforming to AWWA C111, providing direct connection to ductile iron and steel mechanical joint systems without intermediate spool pieces or custom fabrications. The mechanical joint adapter 130 is used in all connections to mechanical joint valves, mechanical joint ductile iron pipe, and mechanical joint HDPE fittings, and constitutes the configuration shown in FIG. 8(i) through 8(l) and FIGS. 15 through 17. The slip joint adapter 131 comprises a plain cylindrical spigot end on the steel-side face machined to the outside diameter required for the applicable sleeve coupling conforming to AWWA C219, providing a plain-end connection for sleeve-type mechanical coupling systems. The slip joint adapter 131 is shown in FIG. 8(a) through 8(d). The hydrant adapter 132 is a mechanical joint bell configuration specifically dimensioned for connection to fire hydrant inlet flanges and mechanical joint hydrant connections, providing direct HDPE-to-hydrant connection at each fire hydrant branch point in the fire water distribution system. The hydrant adapter 132 is shown in FIG. 8(e) through 8(h) and FIG. 24. The grooved adapter 133 comprises a grooved pipe end on the steel-side face machined to the groove profile conforming to AWWA C606 or compatible groove standards, providing direct connection to grooved mechanical coupling systems without requiring a separate grooved spool piece. The grooved adapter 133 is shown in FIG. 22(a) through 22(c) and constitutes the downstream adapter in the flanged-by-grooved valve configuration illustrated therein. Each adapter configuration type 130 through 133 may be combined with any of the bore configuration types described herein—straight bore 126, concave bore 127, convex bore 128, or eccentric bore alignment 36—producing a matrix of configurations addressing the full range of bore differential, invert continuity, and end connection requirements encountered in HDPE-to-metallic-system retrofit and new construction applications. The bore configuration type is selected based on the bore differential between the HDPE pipe inside diameter and the connected metallic component inside diameter, the invert continuity requirement of the installation, and the type of connected downstream component. The straight bore configuration 126 is selected when the bore differential is approximately one-quarter inch or less, providing a concentric straight cylindrical bore through the full plate body thickness at a diameter matched to the connected metallic component bore. The concave bore configuration 127 is selected when the installation requires both eccentric invert continuity and rotational sweep clearance for a butterfly valve disc or active air evacuation from the upstream pipe crown, the concave crown profile providing continuous inward curvature on the crown side of the eccentric bore through the full plate body thickness. The convex bore configuration 128 is selected when the adapter connects to a downstream component with a larger bore—such as a gate valve or expanding transition—and the expanding flow must be guided smoothly into the larger downstream bore, the convex crown profile providing continuous outward curvature on the crown side of the eccentric bore through the full plate body thickness. The eccentric bore alignment 36 is the governing parameter for all reducing adapter configurations where the bore differential exceeds approximately one-quarter inch and invert continuity is required, positioning the bore centerline above the plate body centerline by one-half the bore differential to align the bore bottom with the invert of both connected components. The bore configuration types 126, 127, and 128 are illustrated in the bore profile four-view sets of FIGS. 6 through 9 of the drawing package and in the installation context figures of FIGS. 12 through 27, where each figure group identifies the applicable bore configuration type by reference number.

What is claimed is:

1. An interface adapter configured to connect thick-wall high-density polyethylene piping to a metallic fluid system component, comprising: a unitary plate body having a central bore extending through the plate body from a first face to a second face; a first connection pattern formed in the plate body at the first face, the first connection pattern comprising a plurality of fastener openings arranged on a first bolt circle and configured to mate with a high-density polyethylene piping connection as an independent structural connection; and a second connection pattern formed in the plate body at the second face, the second connection pattern comprising a plurality of fastener openings arranged on a second bolt circle and configured to mate with the metallic fluid system component as an independent structural connection; wherein the first connection pattern and the second connection pattern are positioned relative to one another such that substantially no bolt preload stress field associated with any fastener opening of the first connection pattern overlaps any bolt preload stress field associated with any fastener opening of the second connection pattern, each bolt preload stress field being defined as a circular zone centered on the respective fastener opening centerpoint having a radius of approximately 1.5 to 2 times the nominal diameter of the fastener received by that opening, consistent with the bolt preload influence zone defined in ASME PCC-1 Guidelines for Pressure Boundary Bolted Flange Joint Assembly, the non-overlap condition requiring that the center-to-center distance between any opening of the first connection pattern and the nearest opening of the second connection pattern be at least three times the nominal fastener diameter, and when the radial separation between the first bolt circle and the second bolt circle is less than the stress field radius, the non-overlap condition further requiring angular displacement of the two connection patterns relative to one another, thereby preserving structural ligament regions of continuous plate body material between the two connection patterns capable of transmitting independent structural loads from each connection pattern through the plate body without interference from the stress field of the other connection pattern; and wherein the first connection pattern fasteners impose axial tensile load on the plate body toward the first face and the second connection pattern fasteners impose opposing axial tensile load on the plate body toward the second face simultaneously during service, the plate body structural ligament regions between the two connection patterns transmitting these opposing axial loads independently without mechanical interference between the two independent bolt load systems; and wherein the central bore has a profile specifically selected to eliminate formation of a bore discontinuity ledge or annular sediment accumulation zone at the upstream inlet face of the connected metallic fluid system component, bore discontinuity prevention being the primary design criterion governing selection of the central bore diameter, the bore profile configured to match or smoothly transition to the internal bore diameter of the connected metallic fluid system component, the bore profile selected from one or more of: a straight cylindrical bore sized to substantially equal the internal bore diameter of the connected metallic fluid system component; a reducing bore profile transitioning from the internal bore diameter of the high-density polyethylene piping at the first face to a smaller internal bore diameter of the connected metallic fluid system component at the second face; a tapered bore section having a half-angle of between 5 and 20 degrees; a radiused bore inlet transition; an eccentric bore alignment in which the bore centerline is offset from the plate body centerline to maintain invert continuity between the connected components; or combinations thereof.

2. The interface adapter of claim 1, wherein the angular displacement between the first connection pattern and the second connection pattern is a consequence of optimizing the positions of all fastener openings to satisfy the stress field non-overlap condition across both connection patterns simultaneously, the angular displacement not being an independent design parameter but arising from the geometric requirement that no bolt preload stress field of either pattern overlaps any bolt preload stress field of the other pattern, and wherein in configurations in which the central bore is positioned eccentrically relative to the plate body centerline, the angular displacement required by the non-overlap condition further prevents bore-wall breakthrough at the minimum wall thickness section of the plate body by maintaining a minimum clearance between the bore wall and the nearest fastener opening of either connection pattern of not less than 1.5 times the nominal diameter of the largest fastener received by either connection pattern.

3. The interface adapter of claim 1, wherein the plate body has a thickness of not less than 1.5 times the nominal diameter of the largest fastener received by either connection pattern plus 0.25 inches, the thickness being an absolute geometric lower bound required to maintain minimum material continuity between the bore wall and the nearest fastener opening in eccentric bore configurations, and wherein where engineering analysis of the through-thickness stress condition under the opposing bolt load systems of the two connection patterns—conducted by finite element analysis, pressure cone methodology consistent with ASME PCC-1, or equivalent analytical methods—requires a thickness greater than this geometric minimum, the analytically determined thickness governs.

4. The interface adapter of claim 1, wherein the fastener openings of both the first connection pattern and the second connection pattern comprise tapped holes formed in the plate body from their respective faces engaging the plate body threads directly without external nuts bearing on either face of the plate body, each tapped hole having a thread engagement depth of not less than 1.5 times the nominal diameter of the fastener received by that opening, the tapped holes of the first connection pattern and the tapped holes of the second connection pattern terminating within the plate body thickness or extending completely through the plate body thickness without intersecting each other, the angular displacement of the two connection patterns required by the stress field non-overlap condition preventing any tapped hole of either connection pattern from being positioned at the same angular location as any tapped hole of the other connection pattern, and the plate body having a thickness sufficient to provide not less ½ inch of plate body material between the bottom of any blind tapped hole and the opposite face of the plate body.

5. The interface adapter of claim 4, wherein the central bore is sized to match the internal bore diameter of the existing installed metallic system component such that no annular sediment accumulation zone is formed at the upstream face of the existing installed metallic system component, and wherein the high-density polyethylene piping is of a first nominal size whose internal bore diameter substantially approximates the internal bore diameter of a metallic system component of a second nominal size smaller than the first nominal size, the central bore being sized to the internal bore diameter of the metallic system component of the second nominal size such that the high-density polyethylene piping of the first nominal size connects through the interface adapter to the metallic system component of the second nominal size while achieving bore continuity at the inlet face of the metallic system component.

6. The interface adapter of claim 1, wherein the central bore includes an eccentric bore alignment in which the bore centerline is offset from the plate body centerline by an amount equal to one-half the difference between the internal bore diameter of the high-density polyethylene piping and the internal bore diameter of the connected metallic fluid system component, positioning the bottom of the central bore at the same invert elevation at both the first face and the second face of the plate body and eliminating the internal ledge that would otherwise form at a concentric bore transition between components of differing inside diameter.

7. The interface adapter of claim 6, wherein the eccentric bore alignment includes a shaped crown transition profile selectable between a concave crown configuration in which the bore surface on the crown side curves inward toward the bore centerline through the full plate body thickness providing rotational sweep clearance for a valve disc and active air evacuation from the upstream pipe crown by lateral constriction of approaching flow, and a convex crown configuration in which the bore surface on the crown side curves outward away from the bore centerline through the full plate body thickness providing smooth flow expansion into a larger downstream bore and air evacuation from the downstream pipe crown through a pressure differential created at the expansion face.

8. The interface adapter of claim 1, comprising a multifunctional external lug positioned on the plate body and configured to serve simultaneously as a cathodic protection bonding conductor attachment point for maintaining cathodic protection continuity at the transition between high-density polyethylene piping and metallic components, a lifting attachment point for handling and installation of the interface adapter, and a rotational orientation reference for positioning the plate body at a defined angular orientation relative to the connected components during installation, wherein in embodiments including an eccentric bore alignment the lug is positioned at a defined angular relationship to the eccentric bore offset direction to indicate correct rotational orientation of the adapter during installation.

9. The interface adapter of claim 1, wherein each face of the plate body includes a phonographic spiral groove surface finish of approximately 125 microinch RMS extending across the entire face from the bore edge to the plate body outer diameter, wherein the first face includes a boundary groove at the outer diameter of the ring-type sealing gasket seating zone machined to a depth of approximately 0.0325 inch with a radiused profile serving as both a ring gasket boundary marker and a rotational registration feature, and wherein the second face includes the boundary groove at the ring gasket outer diameter for ring gasket registration and additionally includes a second locating groove at the outer diameter of a full-face sealing gasket configured to positively locate the full-face sealing gasket and prevent lever arm loading at connections to flat-faced metallic components, each boundary groove being eccentrically positioned in eccentric bore configurations to match the eccentricity of the central bore such that the respective sealing gasket seats in the groove in a single correct rotational orientation providing positive visual and mechanical confirmation that the gasket inner bore is aligned with the eccentric central bore prior to joint assembly.

10. The interface adapter of claim 1, wherein the bore-matched central bore inherently reduces turbulence, recirculation, and sediment accumulation at the upstream face of the connected metallic fluid system component by eliminating bore discontinuity at the transition face, and wherein the central bore further includes one or more optional flow-conditioning enhancements selected from: a radiused bore inlet transition configured to reduce inlet flow separation; a tapered bore section having a half-angle of between 5 and 20 degrees configured to redistribute velocity non-uniformity through the transition length; a computationally optimized contoured bore surface configured to minimize turbulence for a specific service velocity and fluid type; or combinations thereof.

11. The interface adapter of claim 1, wherein the central bore includes a corrosion-resistant lining comprising a fluoropolymer selected from the group consisting of polytetrafluoroethylene, perfluoroalkoxy alkane, fluorinated ethylene propylene, and ethylene tetrafluoroethylene.

12. The interface adapter of claim 1, comprising a corrosion-resistant coating applied to at least the external surfaces of the plate body, the corrosion-resistant coating comprising a fusion bonded epoxy coating or a liquid epoxy coating having a dry film thickness of between approximately 250 micrometers and 1000 micrometers.

13. The interface adapter of claim 1, wherein the first connection pattern conforms to a first dimensional flange standard and the second connection pattern conforms to a second, different dimensional flange standard, the first and second standards selected from the group consisting of ASME B16.5, ASME B16.47, AWWA C207, DIN EN 1092, ISO 7005, JIS B2220, and combinations thereof.

14. The interface adapter of claim 1, wherein the structural ligament regions preserved between the first connection pattern and the second connection pattern provide resistance to separation forces generated by transient pressure events including pump startup, pump trip, rapid valve actuation, and pressure surge events, the resistance arising from load transmission through continuous plate body material in the structural ligament regions between the fastener patterns without interference from the opposing bolt load system of the other connection pattern.

15. The interface adapter of claim 1, wherein the thick-wall thermoplastic pressure pipe connected through the first connection pattern comprises a pipe selected from the group consisting of: high-density polyethylene pipe conforming to AWWA C906 or ASTM F714; polyvinyl chloride pressure pipe conforming to AWWA C900 or AWWA C905; oriented polyvinyl chloride pipe conforming to AWWA C909; polyethylene of raised temperature resistance pipe conforming to applicable ASTM standards; and chlorinated polyvinyl chloride pipe; and wherein the first connection pattern is configured to mate with a stub end and lap joint backing ring assembly compatible with the selected thermoplastic pipe material, the bore-matched central bore and stress field non-overlap condition applying equally to any of the foregoing thermoplastic pipe materials whose inside bore diameter differs from the internal bore diameter of the connected metallic fluid system component.

16. The interface adapter of claim 1, wherein the first connection pattern fasteners bear against the plate body in the direction of the first fluid system component and the second connection pattern fasteners bear against the plate body in the direction of the second fluid system component, imposing opposing axial tensile demands on the plate body simultaneously, and wherein the structural ligament regions preserved by the stress field non-overlap condition transmit each opposing axial bolt load system independently without the stress cone of either connection pattern intersecting the stress cone of the other connection pattern within the plate body thickness, the stress cones propagating through the plate body thickness from the respective bearing surfaces at a half-angle consistent with the Rotscher pressure cone model as defined in Section 4 of ASME PCC-1 Guidelines for Pressure Boundary Bolted Flange Joint Assembly.

17. The interface adapter of claim 1, configured for use in one or more of a fire water distribution system complying with NFPA 13, NFPA 14, NFPA 20, or NFPA 24, a municipal water distribution system, a cooling water system, or an industrial process piping system, wherein the interface adapter is compatible with FM Global-listed and UL-listed fire water system components and wherein the first connection pattern and the second connection pattern are dimensioned to conform to applicable flange standards for the respective connected components in the specified service.

18. The interface adapter of claim 6, wherein the angular displacement of the second connection pattern required by the stress field non-overlap condition maintains a minimum clearance between the bore wall of the eccentric central bore and the nearest fastener opening of the second connection pattern of not less than 1.5 times the nominal diameter of the largest fastener received by either connection pattern at the angular position of minimum wall thickness of the plate body, preventing bore-wall breakthrough at the invert section of the plate body that would otherwise occur if any fastener opening of the second connection pattern were positioned at the angular location of minimum wall thickness, the minimum clearance requirement being a direct physical consequence of the stress field non-overlap condition applied to an eccentric bore adapter plate and not an independently specified geometric constraint.

19. A fluid system assembly comprising: a first fluid system component comprising thick-wall high-density polyethylene piping; a second fluid system component comprising a metallic valve, fitting, pump, or piping component; and an interface adapter positioned between and mechanically connecting the first fluid system component and the second fluid system component, the interface adapter comprising: a unitary plate body having a central bore extending through the plate body; a first connection pattern comprising a plurality of fastener openings arranged on a first bolt circle and configured to mate with the first fluid system component as an independent structural connection; and a second connection pattern comprising a plurality of fastener openings arranged on a second bolt circle and configured to mate with the second fluid system component as an independent structural connection; wherein substantially no bolt preload stress field associated with any fastener opening of the first connection pattern overlaps any bolt preload stress field associated with any fastener opening of the second connection pattern, each bolt preload stress field being defined as a circular zone centered on the respective fastener opening centerpoint having a radius of approximately 1.5 to 2 times the nominal diameter of the fastener received by that opening, thereby preserving structural ligament regions of continuous plate body material between the two connection patterns capable of transmitting independent structural loads from each connection pattern through the plate body; and wherein the central bore is sized to match or smoothly transition to the internal bore diameter of the second fluid system component to maintain hydraulic continuity through the interface adapter and prevent formation of an annular sediment accumulation zone or bore discontinuity ledge at the inlet face of the second fluid system component, including reducing transitions from a larger bore diameter of the first fluid system component to a smaller internal bore diameter of the second fluid system component, with eccentric bore alignment where required to maintain invert continuity through the transition; and
wherein the interface adapter is configured for installation between the first fluid system component and the second fluid system component without modification to the existing flange bolt pattern, nominal size, or installed location of the second fluid system component; and wherein the first connection pattern fasteners and second connection pattern fasteners impose opposing axial tensile loads on the plate body toward their respective faces simultaneously during service, the plate body structural ligament regions transmitting these opposing loads independently.

20. The fluid system assembly of claim 19, wherein the second fluid system component is an existing installed metallic component, and the interface adapter connects replacement high-density polyethylene piping to the existing installed metallic component while maintaining the original flange bolt pattern, nominal size, and installed location of the existing installed metallic component without modification.

21. The fluid system assembly of claim 19, wherein the central bore of the interface adapter comprises an eccentric bore alignment in which the bore centerline is offset from the plate body centerline to position the bore bottom at the invert elevation of both the first fluid system component and the second fluid system component, eliminating the internal ledge at the transition face that would otherwise form between components of differing inside diameter, and wherein the interface adapter includes a multifunctional external lug positioned at a defined angular relationship to the eccentric bore offset direction to serve as a rotational orientation reference during installation confirming that the bore low point is positioned at the system invert.

22. The fluid system assembly of claim 19, wherein the interface adapter comprises a multifunctional external lug positioned on the plate body exterior and configured to serve simultaneously as: a cathodic protection bonding conductor attachment point, providing an attachment location for a bonding conductor connecting the metallic second fluid system component to the metallic component at the opposite end of the thermoplastic pipe segment to maintain cathodic protection circuit continuity across the non-conducting thermoplastic pipe segment; a lifting attachment point rated to support the dead weight of the assembled adapter during installation handling in excavations and elevated locations; and a rotational orientation reference positioned at a defined angular relationship to the eccentric bore offset direction such that positioning the lug at the crown of the plate body during installation confirms that the bore low point is at the system invert.

23. The fluid system assembly of claim 19, wherein the fluid system assembly is a fire water distribution system assembly in which the first fluid system component comprises thick-wall high-density polyethylene fire water piping conforming to SDR 17 or lower per AWWA C906 or ASTM F714, the second fluid system component comprises an existing installed steel valve, fitting, or pump conforming to applicable fire water system standards including NFPA 13, NFPA 20, or NFPA 24, and the interface adapter provides a fully restrained bolted flange connection between the replacement high-density polyethylene piping and the existing installed metallic fire water system component at its original installed location and nominal size.

24. A fluid system interface kit comprising: an interface adapter configured to connect thick-wall high-density polyethylene piping to an existing installed metallic fluid system component without modification to the existing flange bolt pattern, nominal size, or installed location of the existing installed metallic fluid system component, the interface adapter comprising a unitary plate body having a central bore extending through the plate body, the central bore sized to match the internal bore diameter of the existing installed metallic fluid system component such that no annular sediment accumulation zone or bore discontinuity ledge is formed at the upstream face of the existing installed metallic fluid system component, bore discontinuity prevention being the primary design criterion governing selection of the central bore diameter, a first connection pattern comprising a plurality of fastener openings on a first bolt circle conforming to a flange standard for the high-density polyethylene piping, and a second connection pattern comprising a plurality of fastener openings on a second bolt circle conforming to a flange standard for the existing installed metallic fluid system component, wherein substantially no bolt preload stress field of approximately 1.5 to 2 times the nominal fastener diameter centered on any fastener opening of the first connection pattern overlaps any bolt preload stress field of the same radius centered on any fastener opening of the second connection pattern, thereby preserving structural ligament regions of continuous plate body material between the connection patterns; a fastener set specifically dimensioned for the interface adapter, comprising fasteners of a length determined by the sum of the adapter plate body thickness, the high-density polyethylene piping flange thickness, the metallic component flange thickness, the compressed thicknesses of both sealing gaskets, and a minimum thread engagement length of not less than one times the nominal fastener diameter in each nut, the fastener set being uniquely determined by the specific adapter configuration and not interchangeable with standard flange fastener sets for the nominal pipe size without verification against the stack-up of the specific adapter configuration; a matched gasket set comprising a first sealing gasket sized and configured for the first connection pattern face and a second sealing gasket sized and configured for the second connection pattern face, each sealing gasket having an inner bore configured to align with the central bore at the respective adapter face without restricting flow, and in adapter configurations with an eccentric bore alignment each sealing gasket having an inner bore offset from the gasket body centerline to match the eccentricity of the central bore at the respective face, the matched gasket set being uniquely dimensioned for the specific bore profile and connection pattern geometry of the interface adapter; and wherein the interface adapter, fastener set, and matched gasket set together constitute a complete engineered system solution specifically configured for the particular adapter plate body, connection pattern geometry, bore profile, and flange stack-up of the installation, such that substitution of any component of the kit with standard hardware not specifically dimensioned for the adapter configuration removes the engineering basis for the specified torque values, thread engagement lengths, and gasket seating positions of the assembled joint.

25. The fluid system interface kit of claim 24, wherein the interface adapter further comprises a corrosion-resistant coating on external surfaces and a corrosion-resistant lining on the central bore configured for long-term buried service, and wherein the bolted flange connection of the interface adapter provides thrust restraint at the transition point by absorbing unbalanced pressure forces within the bolted joint assembly, reducing or eliminating external thrust blocking required at the transition point relative to compression-style coupling connections at the same location.

26. The fluid system interface kit of claim 24, wherein the interface adapter is configured for use in fire water distribution systems complying with NFPA 13, NFPA 14, NFPA 20, or NFPA 24, and is compatible with FM Global-listed and UL-listed fire water system components, and wherein the first connection pattern conforms to a flange standard for thick-wall high-density polyethylene fire water piping conforming to SDR 17 or lower including SDR 11 per AWWA C906 or ASTM F714, and the second connection pattern conforms to a flange standard for the existing installed metallic fire water system component.

27. The fluid system interface kit of claim 24, wherein the matched gasket set comprises a first sealing gasket for the first face of the plate body having an inner bore offset from the gasket outer diameter centerline to match the eccentricity of the central bore of the interface adapter, and a second sealing gasket for the second face of the plate body having an inner bore offset to match the eccentricity of the central bore at the second face, each sealing gasket configured to seat in the respective gasket locating groove of the plate body in a single correct rotational orientation such that the inner bore of each gasket is aligned with the central bore and does not obstruct the bore opening at either face of the plate body.

28. A method of upgrading a fluid transport system from metallic piping to thick-wall high-density polyethylene piping without replacing existing metallic system components, comprising: identifying an existing installed metallic system component having a flange connection, the metallic system component comprising a valve, pump, strainer, instrument, fitting, or other process component; selecting an interface adapter comprising a unitary plate body having a central bore sized to match the internal bore diameter of the existing metallic system component, a first connection pattern comprising a plurality of fastener openings on a first bolt circle configured to mate with a thick-wall high-density polyethylene pipe connection as an independent structural connection, and a second connection pattern comprising a plurality of fastener openings on a second bolt circle configured to mate with the existing metallic system component as an independent structural connection, wherein substantially no bolt preload stress field of approximately 1.5 to 2 times the nominal fastener diameter centered on any fastener opening of the first connection pattern overlaps any bolt preload stress field of the same radius centered on any fastener opening of the second connection pattern, and wherein the first connection pattern fasteners and second connection pattern fasteners impose opposing axial tensile loads on the plate body toward their respective faces simultaneously during service, the plate body structural ligament regions transmitting these opposing loads independently; connecting thick-wall high-density polyethylene replacement piping to the interface adapter at the first connection pattern;
and securing the interface adapter to the existing metallic system component at the second connection pattern using fasteners, while maintaining the existing metallic system component at its installed location, original nominal size, and existing flange configuration without modification or upsizing.

29. The method of claim 28, wherein the fluid transport system is a fire water system, a municipal water system, a cooling water system, or an industrial process piping system, and wherein the method further comprises attaching a cathodic protection bonding conductor to a multifunctional external lug on the plate body and extending the bonding conductor alongside the thermoplastic pipe segment to a corresponding lug on the interface adapter at the opposite end of the thermoplastic segment, thereby bridging the non-conducting thermoplastic segment to maintain cathodic protection circuit continuity to downstream metallic system components without redesigning or interrupting the existing cathodic protection system.

30. The method of claim 28, wherein the interface adapter includes an eccentric bore alignment and a multifunctional external lug positioned at a defined angular relationship to the eccentric bore offset direction, and wherein the method further comprises orienting the interface adapter by positioning the external lug at a crown reference position to place the bore low point at the system invert before securing the fastener set, and independently rotating a lap joint backing ring on the high-density polyethylene pipe stub end to the two-hole standard orientation such that two bolt holes of the first connection pattern straddle the vertical centerline without falling on the 12 o'clock or 6 o'clock position, thereby simultaneously achieving correct eccentric bore invert alignment and two-hole standard compliance without custom fabrication at the installation point.
